(19) United States
(12) Patent Application Publication
(10) Pub. No.: US 2025/0189769 A1
(43) Pub. Date: Jun. 12, 2025

(54) IMAGING OPTICAL SYSTEM

(71) Applicants: Keiji IKEMORI, Yokohama-shi, Kanagawa (JP); NALUX CO., LTD., Osaka (JP)

(72) Inventors: Keiji IKEMORI, Yokohama-shi, Kanagawa (JP); Shih-Yuan CHANG, Zhubei City, Hsinchu County (TW); Tetsuya ZENKO, Osaka (JP); Kenta ISHII, Osaka (JP); Daisuke SEKI, Osaka (JP)

(73) Assignees: Keiji IKEMORI, Yokohama-shi, Kanagawa (JP); NALUX CO., LTD., Osaka (JP)

(21) Appl. No.: 19/060,416

(22) Filed: Feb. 21, 2025

Related U.S. Application Data
(63) Continuation of application No. PCT/JP2023/034440, filed on Sep. 22, 2023.

(30) Foreign Application Priority Data
Sep. 28, 2022 (JP) 2022-154641

(51) Int. Cl. G02B 13/18; G02B 13/06

(52) U.S. Cl. CPC G02B 13/18; G02B 13/06

(57) ABSTRACT

An imaging optical system wherein the number of lenses is three or four, an aperture stop is located between the lens closest to the object and the lens closest to the image, a single aspheric lens in which radius of curvature of each surface is infinity in the paraxial region and which has a power of the third-order aberration region in the peripheral area is provided at a position not adjacent to the aperture stop, the lens closest to the object is a negative lens or the aspheric lens, at least one positive lens is located closer to the image than the aperture stop,

$$0.18 < ( {\sum }_{i = 1}^{i = n} \vert \frac{1}{{f}_{i}} \vert ) \cdot \frac{f}{n} < 0.9$$

is satisfied, a bundle of rays reaching the maximum image height and a bundle of rays having the principal ray parallel to the optical axis do not intersect with each other within the first lens from the object side, and

$$40 ° < HFOV < 80 °$$

is satisfied.

### CROSS REFERENCE TO RELATED APPLICATION

This is a Continuation of International Patent Application No. PCT/JP2023/034440 filed Sep. 22, 2023, which designates the U.S., and which claims priority from Japanese Patent Application No. 2022-154641, dated Sep. 28, 2022. The contents of these applications are hereby incorporated by reference.

### TECHNICAL FIELD

The subject disclosure relates to an imaging optical system, particular to a wide-angle imaging optical system.

### BACKGROUND ART

In a wide-angle imaging optical system using spherical lenses, lenses each of which has a great power in the paraxial region are used to reduce aberrations. Similarly in a wide-angle imaging optical system using aspheric lenses, many lenses each of which has a great power in the paraxial region are used.

The use of lenses each of which has a great power in the paraxial region makes the manufacturing process relatively difficult because of a required higher accuracy of assembling and further makes a size and a weight of the wide-angle imaging optical system greater.

Imaging optical systems each of which includes an aspheric lens in which radius of curvature of each of both surfaces is infinity in the paraxial region have been developed (for example patent documents 1 to 4). However, a compact wide-angle imaging optical system with sufficiently small aberrations has not been realized.
Patent document 1: JP2020-201382A
Patent document 2: JP2021-001938A
Patent document 3: JP2021-018291A
Patent document 4: JP2021-021900A

### SUMMARY

An imaging optical system wherein the number of lenses is four, an aperture stop is located closer to the image than the lens closest to the object and closer to the object than the lens closest to the image, a single aspheric lens in which radius of curvature of each of both surfaces is infinity in the paraxial region and which has a power of the third-order aberration region in the peripheral area is provided at a position that is not adjacent to the aperture stop, the lens closest to the object is a negative lens or the aspheric lens in which radius of curvature of each of both surfaces is infinity in the paraxial region and which has a power of the third-order aberration region in the peripheral area, at least one positive lens is located closer to the image than the aperture stop, the relationship

$$0.18 < ( {\sum }_{i = 1}^{i = n} \vert \frac{1}{{f}_{i}} \vert ) \cdot \frac{f}{n} < 0.9$$

is satisfied where i represents a natural number, fi represents focal length of the i-th lens from the object side, f represents focal length of the whole system and n represents the number of the lenses, a bundle of rays that enters the imaging optical system and reaches the maximum image height and a bundle of rays that enters the imaging optical system and has the principal ray parallel to the optical axis do not intersect with each other within the lens closest to the object, and the relationship

$$40 ° < HFOV < 80 °$$

is satisfied where HFOV represents angle that the principal ray of bundle of rays that enters the imaging optical system and reaches the maximum image height forms with the optical axis.

### BRIEF DESCRIPTION OF DRAWINGS

FIG. 1 shows a layout of an imaging optical system of Example 1;

FIG. 2 shows spherical aberrations;

FIG. 3 shows astigmatism of the ray of wavelength of 0.580 micrometers;

FIG. 4 shows distortion of the ray of wavelength of 0.580 micrometers;

FIG. 5 shows a layout of an imaging optical system of Example 2;

FIG. 6 shows spherical aberrations;

FIG. 7 shows astigmatism of the ray of wavelength of 0.580 micrometers;

FIG. 8 shows distortion of the ray of wavelength of 0.580 micrometers;

FIG. 9 shows a layout of an imaging optical system of Example 3;

FIG. 10 shows spherical aberrations;

FIG. 11 shows astigmatism of the ray of wavelength of 0.580 micrometers;

FIG. 12 shows distortion of the ray of wavelength of 0.580 micrometers;

FIG. 13 shows a layout of an imaging optical system of Example 4;

FIG. 14 shows spherical aberrations;

FIG. 15 shows astigmatism of the ray of wavelength of 0.580 micrometers;

FIG. 16 shows distortion of the ray of wavelength of 0.580 micrometers;

FIG. 17 shows a layout of an imaging optical system of Example 5;

FIG. 18 shows spherical aberrations;

FIG. 19 shows astigmatism of the ray of wavelength of 0.580 micrometers;

FIG. 20 shows distortion of the ray of wavelength of 0.580 micrometers;

FIG. 21 shows a layout of an imaging optical system of Example 6;

FIG. 22 shows spherical aberrations;

FIG. 23 shows astigmatism of the ray of wavelength of 587.5618 nanometers;

FIG. 24 shows distortion of the ray of wavelength of 587.5618 nanometers;

FIG. 25 shows a layout of an imaging optical system of Example 7;

FIG. 26 shows spherical aberrations;

FIG. 27 shows astigmatism of the ray of wavelength of 587.5618 nanometers;

FIG. 28 shows distortion of the ray of wavelength of 587.5618 nanometers;

FIG. 29 shows a layout of an imaging optical system of Example 8;

FIG. 30 shows spherical aberrations;

FIG. 31 shows astigmatism of the ray of wavelength of 0.580 micrometers;

FIG. 32 shows distortion of the ray of wavelength of 0.580 micrometers;

FIG. 33 shows a layout of an imaging optical system of Example 9;

FIG. 34 shows spherical aberrations;

FIG. 35 shows astigmatism of the ray of wavelength of 0.580 micrometers;

FIG. 36 shows distortion of the ray of wavelength of 0.580 micrometers;

FIG. 37 shows a layout of an imaging optical system of Example 10;

FIG. 38 shows spherical aberrations,

FIG. 39 shows astigmatism of the ray of wavelength of 587.5618 nanometers;

FIG. 40 shows distortion of the ray of wavelength of 587.5618 nanometers;

FIG. 41 shows a layout of an imaging optical system of Example 11;

FIG. 42 shows spherical aberrations;

FIG. 43 shows astigmatism of the ray of wavelength of 0.580 micrometers,

FIG. 44 shows distortion of the ray of wavelength of 0.580 micrometers;

FIG. 45 shows a layout of an imaging optical system of Example 12;

FIG. 46 shows spherical aberrations;

FIG. 47 shows astigmatism of the ray of wavelength of 0.580 micrometers;

FIG. 48 shows distortion of the ray of wavelength of 0.580 micrometers;

FIG. 49 shows a layout of an imaging optical system of Reference Example

1;

FIG. 50 shows spherical aberrations;

FIG. 51 shows astigmatism of the ray of wavelength of 0.580 micrometers;

FIG. 52 shows distortion of the ray of wavelength of 0.580 micrometers;

FIG. 53 shows a layout of an imaging optical system of Example 14;

FIG. 54 shows spherical aberrations;

FIG. 55 shows astigmatism of the ray of wavelength of 0.580 micrometers;

FIG. 56 shows distortion of the ray of wavelength of 0.580 micrometers;

FIG. 57 shows a layout of an imaging optical system of Example 15;

FIG. 58 shows spherical aberrations;

FIG. 59 shows astigmatism of the ray of wavelength of 587.5618 nanometers;

FIG. 60 shows distortion of the ray of wavelength of 587.5618 nanometers;

FIG. 61 shows a layout of an imaging optical system of Example 16;

FIG. 62 shows spherical aberrations;

FIG. 63 shows astigmatism of the ray of wavelength of 587.5618 nanometers;

FIG. 64 shows distortion of the ray of wavelength of 587.5618 nanometers;

FIG. 65 shows a layout of an imaging optical system of Example 17;

FIG. 66 shows spherical aberrations;

FIG. 67 shows astigmatism of the ray of wavelength of 587.5618 nanometers;

FIG. 68 shows distortion of the ray of wavelength of 587.5618 nanometers;

FIG. 69 shows a layout of an imaging optical system of Example 18;

FIG. 70 shows spherical aberrations;

FIG. 71 shows astigmatism of the ray of wavelength of 587.5618 nanometers;

FIG. 72 shows distortion of the ray of wavelength of 587.5618 nanometers;

FIG. 73 shows a layout of an imaging optical system of Example 19;

FIG. 74 shows spherical aberrations;

FIG. 75 shows astigmatism of the ray of wavelength of 587.5618 nanometers;

FIG. 76 shows distortion of the ray of wavelength of 587.5618 nanometers;

FIG. 77 shows a layout of an imaging optical system of Example 20;

FIG. 78 shows spherical aberrations;

FIG. 79 shows astigmatism of the ray of wavelength of 587.5618 nanometers;

FIG. 80 shows distortion of the ray of wavelength of 587.5618 nanometers;

FIG. 81 shows a layout of an imaging optical system of Example 21;

FIG. 82 shows spherical aberrations;

FIG. 83 shows astigmatism of the ray of wavelength of 0.580 micrometers;

FIG. 84 shows distortion of the ray of wavelength of 0.580 micrometers;

FIG. 85 shows a layout of an imaging optical system of Example 22;

FIG. 86 shows spherical aberrations;

FIG. 87 shows astigmatism of the ray of wavelength of 0.580 micrometers;

FIG. 88 shows distortion of the ray of wavelength of 0.580 micrometers;

FIG. 89 shows a layout of an imaging optical system of Example 23;

FIG. 90 shows spherical aberrations;

FIG. 91 shows astigmatism of the ray of wavelength of 0.580 micrometers;

FIG. 92 shows distortion of the ray of wavelength of 0.580 micrometers;

FIG. 93 shows a layout of an imaging optical system of Example 24;

FIG. 94 shows spherical aberrations;

FIG. 95 shows astigmatism of the ray of wavelength of 0.580 micrometers;

FIG. 96 shows distortion of the ray of wavelength of 0.580 micrometers;

FIG. 97 shows a layout of an imaging optical system of Example 25;

FIG. 98 shows spherical aberrations;

FIG. 99 shows astigmatism of the ray of wavelength of 587.5618 nanometers;

FIG. 100 shows distortion of the ray of wavelength of 587.5618 nanometers;

FIG. 101 shows a layout of an imaging optical system of Example 26;

FIG. 102 shows spherical aberrations;

FIG. 103 shows astigmatism of the ray of wavelength of 587.5618 nanometers;

FIG. 104 shows distortion of the ray of wavelength of 587.5618 nanometers;

FIG. 105 shows a layout of an imaging optical system of Example 27;

FIG. 106 shows spherical aberrations;

FIG. 107 shows astigmatism of the ray of wavelength of 587.5618 nanometers;

FIG. 108 shows distortion of the ray of wavelength of 587.5618 nanometers;

FIG. 109 shows a layout of an imaging optical system of Example 28;

FIG. 110 shows spherical aberrations;

FIG. 111 shows astigmatism of the ray of wavelength of 587.5618 nanometers;

FIG. 112 shows distortion of the ray of wavelength of 587.5618 nanometers;

FIG. 113 shows a layout of an imaging optical system of Example 29;

FIG. 114 shows spherical aberrations,

FIG. 115 shows astigmatism of the ray of wavelength of 587.5618 nanometers;

FIG. 116 shows distortion of the ray of wavelength of 587.5618 nanometers;

FIG. 117 shows a layout of an imaging optical system of Example 30;

FIG. 118 shows spherical aberrations;

FIG. 119 shows astigmatism of the ray of wavelength of 587.5618 nanometers;

FIG. 120 shows distortion of the ray of wavelength of 587.5618 nanometers;

FIG. 121 shows a layout of an imaging optical system of Example 32;

FIG. 122 shows spherical aberrations,

FIG. 123 shows astigmatism of the ray of wavelength of 0.580 micrometers;

FIG. 124 shows distortion of the ray of wavelength of 0.580 micrometers;

FIG. 125 shows a layout of an imaging optical system of Example 34;

FIG. 126 shows spherical aberrations;

FIG. 127 shows astigmatism of the ray of wavelength of 0.580 micrometers;

FIG. 128 shows distortion of the ray of wavelength of 0.580 micrometers;

FIG. 129 shows a layout of an imaging optical system of Example 35;

FIG. 130 shows spherical aberrations;

FIG. 131 shows astigmatism of the ray of wavelength of 0.580 micrometers;

FIG. 132 shows distortion of the ray of wavelength of 0.580 micrometers;

FIG. 133 shows a layout of an imaging optical system of Example 36;

FIG. 134 shows spherical aberrations;

FIG. 135 shows astigmatism of the ray of wavelength of 0.580 micrometers;

FIG. 136 shows distortion of the ray of wavelength of 0.580 micrometers;

FIG. 137 shows a layout of an imaging optical system of Example 37;

FIG. 138 shows spherical aberrations;

FIG. 139 shows astigmatism of the ray of wavelength of 0.580 micrometers;

FIG. 140 shows distortion of the ray of wavelength of 0.580 micrometers;

FIG. 141 shows a layout of an imaging optical system of Example 39;

FIG. 142 shows spherical aberrations;

FIG. 143 shows astigmatism of the ray of wavelength of 0.580 micrometers;

FIG. 144 shows distortion of the ray of wavelength of 0.580 micrometers;

FIG. 145 shows a layout of an imaging optical system of Example 40;

FIG. 146 shows spherical aberrations;

FIG. 147 shows astigmatism of the ray of wavelength of 0.580 micrometers;

FIG. 148 shows distortion of the ray of wavelength of 0.580 micrometers;

FIG. 149 shows a layout of an imaging optical system of Example 41;

FIG. 150 shows spherical aberrations;

FIG. 151 shows astigmatism of the ray of wavelength of 0.580 micrometers;

FIG. 152 shows distortion of the ray of wavelength of 0.580 micrometers;

FIG. 153 shows a layout of an imaging optical system of Example 43;

FIG. 154 shows spherical aberrations,

FIG. 155 shows astigmatism of the ray of wavelength of 0.580 micrometers;

FIG. 156 shows distortion of the ray of wavelength of 0.580 micrometers;

FIG. 157 shows a layout of an imaging optical system of Example 44;

FIG. 158 shows spherical aberrations;

FIG. 159 shows astigmatism of the ray of wavelength of 0.580 micrometers;

FIG. 160 shows distortion of the ray of wavelength of 0.580 micrometers;

FIG. 161 shows a layout of an imaging optical system of Example 45;

FIG. 162 shows spherical aberrations;

FIG. 163 shows astigmatism of the ray of wavelength of 0.580 micrometers;

FIG. 164 shows distortion of the ray of wavelength of 0.580 micrometers;

FIG. 165 shows a layout of an imaging optical system of Example 46;

FIG. 166 shows spherical aberrations;

FIG. 167 shows astigmatism of the ray of wavelength of 0.580 micrometers;

FIG. 168 shows distortion of the ray of wavelength of 0.580 micrometers;

FIG. 169 shows a layout of an imaging optical system of Example 47;

FIG. 170 shows spherical aberrations;

FIG. 171 shows astigmatism of the ray of wavelength of 0.580 micrometers;

FIG. 172 shows distortion of the ray of wavelength of 0.580 micrometers;

FIG. 173 shows a layout of an imaging optical system of Example 48;

FIG. 174 shows spherical aberrations;

FIG. 175 shows astigmatism of the ray of wavelength of 0.580 micrometers;

FIG. 176 shows distortion of the ray of wavelength of 0.580 micrometers;

FIG. 177 shows a layout of an imaging optical system of Example 49;

FIG. 178 shows spherical aberrations,

FIG. 179 shows astigmatism of the ray of wavelength of 0.580 micrometers;

FIG. 180 shows distortion of the ray of wavelength of 0.580 micrometers;

FIG. 181 shows a layout of an imaging optical system of Example 50;

FIG. 182 shows spherical aberrations,

FIG. 183 shows astigmatism of the ray of wavelength of 0.580 micrometers;

FIG. 184 shows distortion of the ray of wavelength of 0.580 micrometers;

FIG. 185 shows a layout of an imaging optical system of Example 51;

FIG. 186 shows spherical aberrations,

FIG. 187 shows astigmatism of the ray of wavelength of 0.580 micrometers;

FIG. 188 shows distortion of the ray of wavelength of 0.580 micrometers;

FIG. 189 shows a layout of an imaging optical system of Example 52;

FIG. 190 shows spherical aberrations;

FIG. 191 shows astigmatism of the ray of wavelength of 0.580 micrometers;

FIG. 192 shows distortion of the ray of wavelength of 0.580 micrometers;

FIG. 193 shows a layout of an imaging optical system of Example 53;

FIG. 194 shows spherical aberrations;

FIG. 195 shows astigmatism of the ray of wavelength of 0.580 micrometers; and

FIG. 196 shows distortion of the ray of wavelength of 0.580 micrometers.

### DESCRIPTION OF EMBODIMENTS

In the text of specification and the claims, a positive lens refers to a lens having a positive power in the paraxial region, and a negative lens refers to a lens having a negative power in the paraxial region. An optical axis means the straight line connecting the centers of radius of curvature of all the surfaces of the lenses. In an imaging optical system, the lens closest to the object is referred to as a first lens, and the m-th lens from the object side is referred to as a m-th lens where m represents a natural number. Image height means a value of distance of an image position from the optical axis on an evaluating surface of the optical system. Distortion is a ratio of a displacement of an actual image height to an ideal image height. In the text of specification, “an aspheric lens in which radius of curvature of each of both surfaces is infinity in the paraxial region and which has a power of the third order aberration region in the peripheral area” is also referred to as “an aspheric lens in which radius of curvature of each of both surfaces is infinity in the paraxial region and which has a power in the peripheral area”. The both surfaces mean the object-side surface and the image-side surface of a lens.

Examples will be described below. The features of the examples will be described after the examples have been described. Each surface of each lens of the examples can be expressed by the following expression.

$$( 1 )$$

$$z = \frac{\frac{{r}^{2}}{R}}{1 + \sqrt{1 - ( k + 1 ) \frac{{r}^{2}}{{R}^{2}}}} + {A}_{4} {r}^{4} + {A}_{6} {r}^{6} + {A}_{8} {r}^{8} + {A}_{10} {r}^{10} + {A}_{12} {r}^{12} + {A}_{14} {r}^{14}$$

z represents coordinate in the direction of the optical axis with respect to the point of intersection of each surface and the optical axis. The coordinate system is determined such that coordinates of points on the image side are positive. r represents distance from the optical axis. R represents radius of curvature at the center of a surface. k represents a conic constant. A₄-A₁₄ represent aspheric coefficients. The sign of R is positive when a surface is convex toward the object in the paraxial region and negative when a surface is convex toward the image in the paraxial region. In the text of specification, the unit of length is millimeter unless otherwise specified.

In the following tables, “radius of curvature” represents radius of curvature R at the center of each surface. “∞” in the column of “radius of curvature” represents that the radius of curvature at the center of each surface is infinity. “Thickness or distance” represents object distance, thickness of an optical element, distance between optical elements or distance between an optical element and an image plane. “∞” in the column of “Thickness or distance” represents distance is infinity. “Material,”, “Refractive index” and “Abbe's number” respectively represent material, refractive index and Abbe's number of a lens or another optical element. “Focal length” represents focal length of each lens. “∞” in the column of “Focal length” represents that the focal length is infinity.

In the description given below, “HOFV” represents a half value of angle of view (a half angle of view). Angle of view is twice as great as the angle that the principal ray travelling before entering the system forms with the optical axis when the principal ray finally reaches the maximum image height.

### Example 1

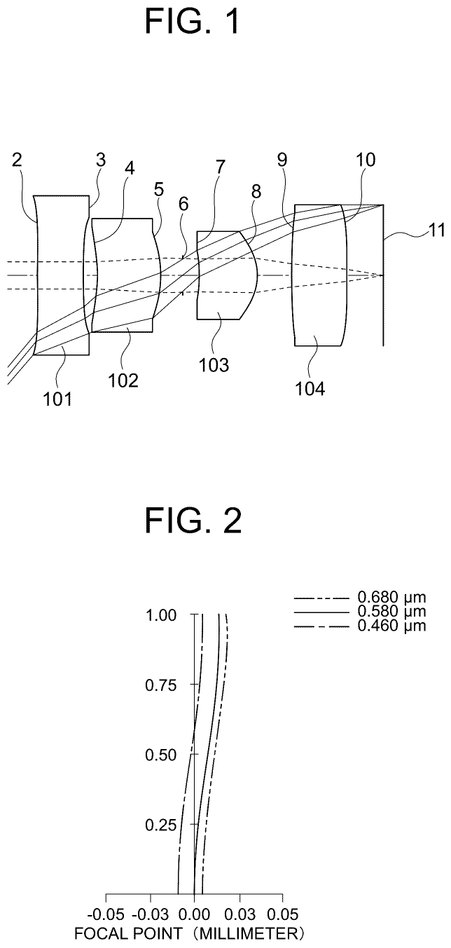

FIG. 1 shows a layout of an imaging optical system of Example 1. The imaging optical system includes four lenses arranged from the object side to the image side. Each of the first lens 101 and the fourth lens 104 is an aspheric lens in which radius of curvature of each of both surfaces is infinity in the paraxial region and which has a power in the peripheral area. Each of the second lens 102 and the third lens 103 is a positive meniscus lens which is convex toward the image. The aperture stop 6 is located between the second lens 102 and the third lens 103.

Table 1 shows positions of the optical elements and properties and values of focal length of the lenses of the imaging optical system of Example 1. The focal length f of the whole imaging optical system is given by f=0.2808. The F-number Fno is given by Fno=3.348. HFOV representing a half value of angle of view is given by HFOV=50 (degrees). In Table 1, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 1

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.144 | Plastic | 1.5311 | 55.634 | ∞ |
| 3 | | ∞ | 0.046 | | | | |
| 4 | Lens 2 | −0.33579 | 0.203 | Plastic | 1.6349 | 23.945 | 1.040 |
| 5 | | −0.28002 | 0.070 | | | | |
| 6 | Ape. | Plano | 0.053 | | | | |
| | Stop | | | | | | |
| 7 | Lens 3 | −0.49457 | 0.185 | Plastic | 1.5311 | 55.634 | 0.376 |
| 8 | | −0.16093 | 0.111 | | | | |
| 9 | Lens 4 | ∞ | 0.176 | Plastic | 1.5311 | 55.634 | ∞ |
| 10 | | ∞ | 0.116 | | | | |
| 11 | Image | Plano | | | | | |

Table 2 shows conic constants and aspheric coefficients of each surface of each lens of Example 1.

TABLE 2

| Surface | K | A4 | A6 | A8 | A10 | A12 | A14 |
|---|---|---|---|---|---|---|---|
| 2 | 0.0000 | −2.43674E+00 | −2.13003E+01 | −2.48685E+00 | 3.86041E+01 | 2.76661E+03 | −7.06615E+03 |
| 3 | 0.0000 | 1.84834E+01 | −1.97477E+01 | −3.70357E+02 | −1.39695E+04 | −6.27055E+05 | −1.08268E+07 |
| 4 | −16.2586 | 1.53447E+01 | −8.58627E+01 | −3.06982E+02 | 2.26629E+03 | 1.24907E+05 | −2.62890E+07 |
| 5 | −13.5509 | −1.02304E+01 | 9.39372E+01 | −2.00689E+03 | −1.61422E+05 | −4.69604E+05 | 3.56687E+08 |
| 7 | 3.8564 | −1.45168E+01 | 1.13766E+03 | 2.71982E+05 | 4.18620E+07 | 1.93196E+09 | −7.84278E+11 |
| 8 | −1.2098 | −1.20784E+00 | −1.80294E+02 | 1.13552E+04 | 3.01146E+05 | 9.84373E+06 | 6.57357E+08 |
| 9 | 0.0000 | 7.77500E+00 | −5.02889E+01 | −2.59485E+02 | 6.21297E+03 | −3.13298E+04 | −3.69696E+05 |
| 10 | 0.0000 | −3.93886E+00 | −9.16322E+01 | −1.60468E+01 | 4.91985E+03 | 7.24647E+04 | −1.16865E+06 |

FIG. 2 shows spherical aberrations. The horizontal axis of FIG. 2 represents a position at which a ray that travels parallel to the optical axis and enters the imaging optical system intersects with the optical axis. The vertical axis of FIG. 2 represents distance of the above-described ray from the optical axis. The value of distance is normalized by the radius of the aperture. In other words, the value 1 on the vertical axis represents the radius of the aperture. In FIG. 2, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

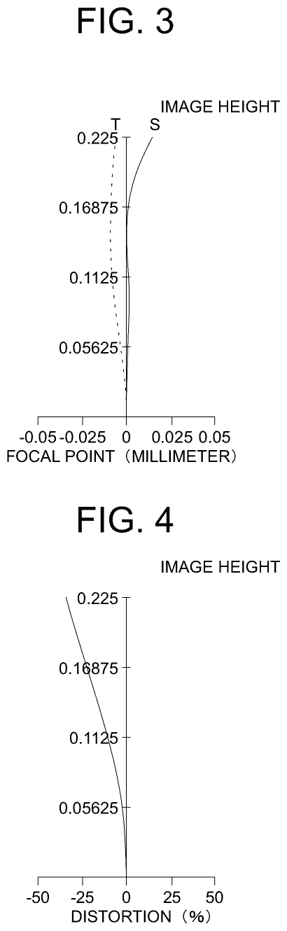

FIG. 3 shows astigmatism of the ray of wavelength of 0.580 micrometers. The horizontal axis of FIG. 3 represents a position in the optical axis direction of the focal point. The vertical axis of FIG. 3 represents image height. The solid line in FIG. 3 represents the graph of the sagittal plane, and the broken line in FIG. 3 represents the graph of the tangential plane.

FIG. 4 shows distortion of the ray of wavelength of 0.580 micrometers. The horizontal axis of FIG. 4 represents distortion. The unit is percent. The vertical axis of FIG. 4 represents image height.

### Example 2

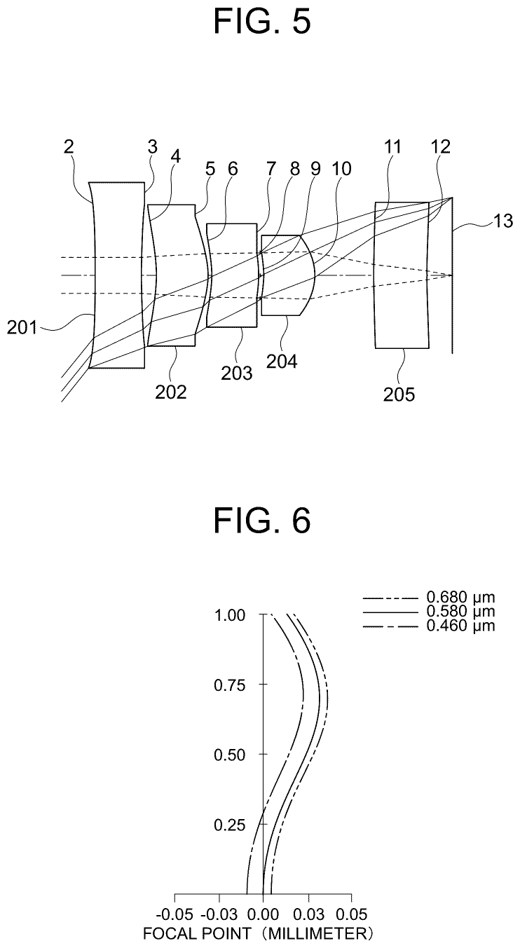

FIG. 5 shows a layout of an imaging optical system of Example 2. The imaging optical system includes five lenses arranged from the object side to the image side. Each of the first lens 201 and the fifth lens 205 is an aspheric lens in which radius of curvature of each of both surfaces is infinity in the paraxial region and which has a power in the peripheral area. Each of the second lens 202 and the fourth lens 204 is a positive meniscus lens which is convex toward the image. The third lens 203 is a negative meniscus lens which is convex toward the image. The aperture stop 8 is located between the third lens 203 and the fourth lens 204.

Table 3 shows positions of the optical elements and properties and values of focal length of the lenses of the imaging optical system of Example 2. The focal length f of the whole imaging optical system is given by f=0.264. The F-number Fno is given by Fno=2.563. HFOV representing a half value of angle of view is given by HFOV=50 (degrees). In Table 3, each of the five lenses is represented respectively by lens 1 to lens 5 from the object side.

In the present example, the object distance from the object to the first lens is 5.242(=5.142+0.100) millimeters. Surface 1 does not correspond to a physical object.

TABLE 3

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.133 | Plastic | 1.5311 | 55.634 | ∞ |
| 3 | | ∞ | 0.042 | | | | |
| 4 | Lens 2 | −0.36348 | 0.145 | Plastic | 1.6611 | 20.345 | 0.586 |
| 5 | | −0.21762 | 0.010 | | | | |
| 6 | Lens 3 | −0.34322 | 0.132 | Plastic | 1.5311 | 55.634 | −19.968 |
| 7 | | −0.40213 | 0.008 | | | | |
| 8 | Ape. | Plano | 0.007 | | | | |
| | Stop | | | | | | |
| 9 | Lens 4 | −0.36953 | 0.143 | Plastic | 1.5311 | 55.634 | 0.401 |
| 10 | | −0.15338 | 0.168 | | | | |
| 11 | Lens 5 | ∞ | 0.150 | Plastic | 1.6349 | 23.945 | ∞ |
| 12 | | ∞ | 0.075 | | | | |
| 13 | Image | Plano | 0.000 | | | | |

Table 4 shows conic constants and aspheric coefficients of each surface of each lens of Example 2.

TABLE 4

| Surface | K | A4 | A6 | A8 | A10 | A12 | A14 |
|---|---|---|---|---|---|---|---|
| 2 | 0.0000 | −2.48625E+00 | −1.61898E+01 | −5.28562E−01 | −2.58118E+01 | −7.01444E+02 | −2.22102E+04 |
| 3 | 0.0000 | 9.72235E+00 | −1.43670E+02 | −3.71674E+01 | −7.94067E+02 | 1.98862E+04 | 4.45518E+06 |
| 4 | −18.9467 | 3.04819E+00 | 1.10826E+01 | 7.06025E+01 | 4.16271E+03 | 6.42811E+04 | −6.42767E+06 |
| 5 | −9.1593 | −5.09734E+00 | 2.09622E+02 | −8.34782E+01 | −4.18328E+04 | −9.19975E+05 | 9.95135E+07 |
| 6 | −14.8131 | −1.15629E+00 | 5.41799E+02 | 1.05968E+03 | 4.00113E+05 | 2.41626E+07 | −2.47386E+06 |
| 7 | −20.0001 | −1.74824E+01 | 9.76638E+03 | −4.50886E+04 | 2.92259E+07 | 1.06499E+10 | 2.73318E+12 |
| 9 | 19.3006 | −7.87671E+01 | 3.26574E+04 | 4.48948E+05 | 5.36148E+07 | 4.06847E+09 | −1.08009E+11 |
| 10 | −0.9639 | 3.17651E+00 | −8.17271E+02 | −1.78120E+04 | −3.34517E+05 | 1.38921E+08 | 1.83222E+10 |
| 11 | 0.0000 | 3.35479E+00 | −1.94424E+01 | 4.37366E+01 | 2.84821E+03 | 1.61086E+05 | 8.39285E+06 |
| 12 | 0.0000 | 1.02364E+01 | −1.84203E+02 | 8.84081E+00 | 1.78818E+02 | 2.27298E+03 | −2.72024E+04 |

FIG. 6 shows spherical aberrations. The horizontal axis of FIG. 6 represents a position at which a ray that travels parallel to the optical axis and enters the imaging optical system intersects with the optical axis. The vertical axis of FIG. 6 represents distance of the above-described ray from the optical axis. The value of distance is normalized by the radius of the aperture. In other words, the value 1 on the vertical axis represents the radius of the aperture. In FIG. 6, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

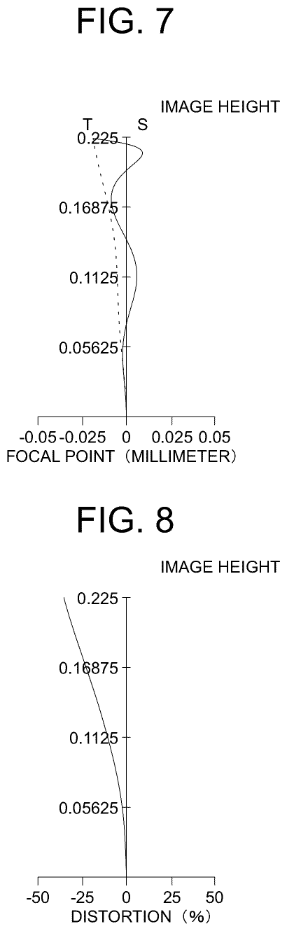

FIG. 7 shows astigmatism of the ray of wavelength of 0.580 micrometers. The horizontal axis of FIG. 7 represents a position in the optical axis direction of the focal point. The vertical axis of FIG. 7 represents image height. The solid line in FIG. 7 represents the graph of the sagittal plane, and the broken line in FIG. 7 represents the graph of the tangential plane.

FIG. 8 shows distortion of the ray of wavelength of 0.580 micrometers. The horizontal axis of FIG. 8 represents distortion. The unit is percent. The vertical axis of FIG. 8 represents image height.

### Example 3

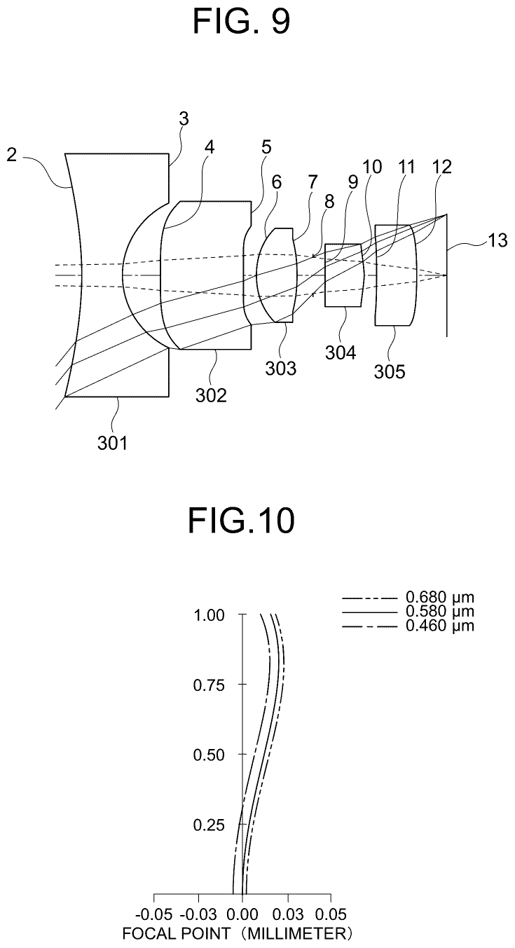

FIG. 9 shows a layout of an imaging optical system of Example 3. The imaging optical system includes five lenses arranged from the object side to the image side. Each of the second 302 and the fifth lens 305 is an aspheric lens in which radius of curvature of each of both surfaces is infinity in the paraxial region and which has a power in the peripheral area. The first lens 301 is a biconcave lens. The third lens 303 is a biconvex lens. The fourth lens 304 is a positive meniscus lens which is convex toward the image. The aperture stop 8 is located between the third lens 303 and the fourth lens 304.

Table 5 shows positions of the optical elements and properties and values of focal length of the lenses of the imaging optical system of Example 3. The focal length f of the whole imaging optical system is given by f=0.206. The F-number Fno is given by Fno=2.5814. HFOV representing a half value of angle of view is given by HFOV=50 (degrees). In Table 5, each of the five lenses is represented respectively by lens 1 to lens 5 from the object side.

In the present example, the object distance from the object to the first lens is 5.242(=5.142+0.100) millimeters. Surface 1 does not correspond to a physical object.

TABLE 5

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −1.30771 | 0.149 | Plastic | 1.5311 | 55.634 | −0.458 |
| 3 | | 0.31113 | 0.136 | | | | |
| 4 | Lens 2 | ∞ | 0.302 | Plastic | 1.6611 | 20.345 | ∞ |
| 5 | | ∞ | 0.048 | | | | |
| 6 | Lens 3 | 0.28005 | 0.149 | Plastic | 1.5311 | 55.634 | 0.358 |
| 7 | | −0.48565 | 0.056 | | | | |
| 8 | Ape. | Plano | 0.045 | | | | |
| | Stop | | | | | | |
| 9 | Lens 4 | −3.28093 | 0.142 | Plastic | 1.5311 | 55.634 | 0.638 |
| 10 | | −0.31214 | 0.046 | | | | |
| 11 | Lens 5 | ∞ | 0.145 | Plastic | 1.5311 | 55.634 | ∞ |
| 12 | | ∞ | 0.110 | | | | |
| 13 | Image | Plano | 0.000 | | | | |

Table 6 shows conic constants and aspheric coefficients of each surface of each lens of Example 3.

TABLE 6

| Surface | K | A4 | A6 | A8 | A10 | A12 | A14 |
|---|---|---|---|---|---|---|---|
| 2 | 0.2358 | 8.97055E−02 | 2.05945E+00 | 2.28013E+00 | −5.92569E+00 | −7.88691E+00 | −1.20083E+02 |
| 3 | −0.2904 | 2.92021E+00 | 4.89258E+01 | 7.09962E+01 | −3.69790E+02 | −3.93137E+03 | −5.30014E+04 |
| 4 | 0.0000 | 1.35282E+01 | 6.41788E+00 | 3.82500E+01 | −3.91264E+02 | −3.44150E+03 | −6.51800E+04 |
| 5 | 0.0000 | 1.71478E+01 | 1.57780E+02 | 1.31788E+03 | 8.67973E+04 | −2.82118E+05 | −1.33039E+07 |
| 6 | 0.9663 | −6.15991E+00 | 9.69170E+00 | −6.66520E+02 | 1.56915E+04 | 2.13249E+06 | 8.92628E+07 |
| 7 | −7.3671 | −3.92952E+00 | 2.96576E+02 | −5.63422E+02 | 4.77411E+04 | −6.84236E+06 | 6.54762E+08 |
| 9 | 20.0000 | −4.62589E+01 | 9.27979E+03 | 4.27717E+05 | −5.88393E+07 | −4.25630E+09 | 4.39014E+11 |
| 10 | −20.0001 | −9.39582E+00 | 1.31135E+03 | 5.60221E+04 | 4.20679E+06 | 7.23435E+07 | −8.35774E+08 |
| 11 | 0.0000 | −1.11370E+01 | 1.83148E+02 | −2.03333E+04 | −9.48800E+05 | 3.07399E+07 | 2.02091E+09 |
| 12 | 0.0000 | −1.11004E+01 | −4.60382E+02 | 2.43743E+03 | 1.16359E+04 | 1.72735E+06 | 2.57523E+07 |

FIG. 10 shows spherical aberrations. The horizontal axis of FIG. 10 represents a position at which a ray that travels parallel to the optical axis and enters the imaging optical system intersects with the optical axis. The vertical axis of FIG. 10 represents distance of the above-described ray from the optical axis. The value of distance is normalized by the radius of the aperture. In other words, the value 1 on the vertical axis represents the radius of the aperture. In FIG. 10, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

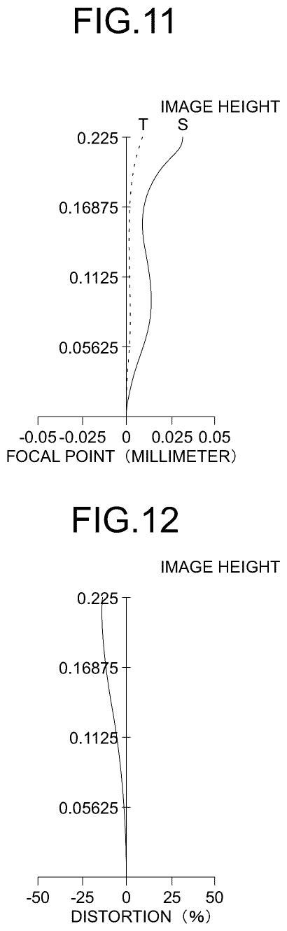

FIG. 11 shows astigmatism of the ray of wavelength of 0.580 micrometers. The horizontal axis of FIG. 11 represents a position in the optical axis direction of the focal point. The vertical axis of FIG. 11 represents image height. The solid line in FIG. 11 represents the graph of the sagittal plane, and the broken line in FIG. 11 represents the graph of the tangential plane.

FIG. 12 shows distortion of the ray of wavelength of 0.580 micrometers. The horizontal axis of FIG. 12 represents distortion. The unit is percent. The vertical axis of FIG. 12 represents image height.

### Example 4

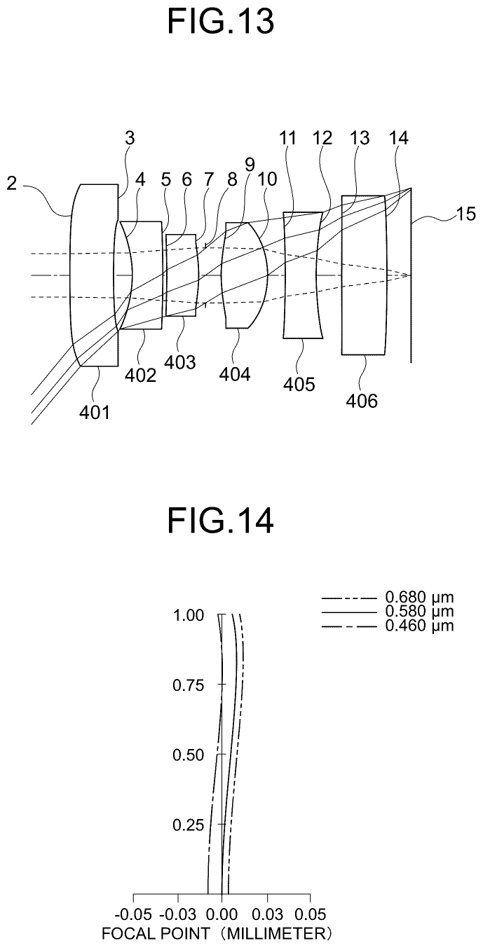

FIG. 13 shows a layout of an imaging optical system of Example 4. The imaging optical system includes six lenses arranged from the object side to the image side. Each of the first lens 401 and the sixth lens 406 is an aspheric lens in which radius of curvature of each of both surfaces is infinity in the paraxial region and which has a power in the peripheral area. The second lens 402 is a negative meniscus lens which is convex toward the image. The third lens 403 is a positive meniscus lens which is convex toward the image. The fourth lens 404 is a biconvex lens. The fifth lens 405 is a biconcave lens. The aperture stop 8 is located between the third lens 403 and the fourth lens 404.

Table 7 shows positions of the optical elements and properties and values of focal length of the lenses of the imaging optical system of Example 4. The focal length f of the whole imaging optical system is given by f=0.275. The F-number Fno is given by Fno=2.544. HFOV representing a half value of angle of view is given by HFOV=50 (degrees). In Table 7, each of the six lenses is represented respectively by lens 1 to lens 6 from the object side.

In the present example, the object distance from the object to the first lens is 5.242(=5.142+0.100) millimeters. Surface 1 does not correspond to a physical object.

TABLE 7

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.112 | Plastic | 1.5311 | 55.634 | ∞ |
| 3 | | ∞ | 0.047 | | | | |
| 4 | Lens 2 | −0.29643 | 0.077 | Plastic | 1.5311 | 55.634 | −0.644 |
| 5 | | −2.40671 | 0.010 | | | | |
| 6 | Lens 3 | −2.75290 | 0.081 | Plastic | 1.6611 | 20.345 | 0.780 |
| 7 | | −0.44004 | 0.018 | | | | |
| 8 | Ape. | Plano | 0.040 | | | | |
| | Stop | | | | | | |
| 9 | Lens 4 | 0.40704 | 0.116 | Plastic | 1.5311 | 55.634 | 0.273 |
| 10 | | −0.20387 | 0.045 | | | | |
| 11 | Lens 5 | −10.22819 | 0.078 | Plastic | 1.6611 | 20.345 | −0.962 |
| 12 | | 0.68133 | 0.066 | | | | |
| 13 | Lens 6 | ∞ | 0.114 | Plastic | 1.5311 | 55.634 | ∞ |
| 14 | | ∞ | 0.061 | | | | |
| 15 | Image | Plano | 0.000 | | | | |

Table 8 shows conic constants and aspheric coefficients of each surface of each lens of Example 4.

TABLE 8

| Surface | K | A4 | A6 | A8 | A10 | A12 | A14 |
|---|---|---|---|---|---|---|---|
| 2 | 0.0000 | 5.26870E+00 | 7.94316E+01 | −1.86390E+01 | −1.76274E+02 | 5.04110E+01 | 1.91128E+03 |
| 3 | 0.0000 | 1.55903E+01 | 5.23558E+02 | 9.10010E+02 | 5.07800E+04 | 2.99562E+03 | −2.12961E+05 |
| 4 | 0.0097 | 3.20211E+00 | 6.14040E+01 | −6.30737E+02 | −2.98238E+04 | 5.62184E+04 | 2.52284E+06 |
| 5 | 19.9985 | −8.24434E+00 | 5.49172E+02 | −5.43859E+03 | 7.12278E+05 | −7.57177E+05 | −8.11571E+07 |
| 6 | −19.9977 | −3.91846E−03 | 1.02732E+02 | 9.45055E+03 | −1.65321E+06 | 7.41081E+05 | 9.54264E+07 |
| 7 | −0.0901 | 1.51403E+01 | −8.75027E+02 | 3.62818E+04 | −6.99495E+05 | −1.15353E+07 | −2.54107E+09 |
| 9 | −0.1889 | −3.27748E+01 | 6.36777E+02 | 2.26284E+03 | −7.32953E+05 | −6.98261E+05 | −5.07637E+07 |
| 10 | −0.0202 | 1.09900E+01 | −4.65013E+02 | −3.71961E+03 | −3.68685E+05 | 1.89958E+06 | 4.04369E+06 |
| 11 | −19.3048 | −1.25764E+00 | −1.95064E+02 | −7.63774E+02 | −5.75577E+04 | 1.67282E+04 | 1.05260E+06 |
| 12 | −0.1231 | −1.81716E+00 | 9.73124E+00 | 3.18416E+01 | −1.25492E+04 | −7.66376E+03 | −5.71097E+05 |
| 13 | 0.0000 | −6.57616E+00 | 2.01815E+02 | 6.14193E+00 | −1.10002E+03 | 2.34908E+02 | 2.22437E+04 |
| 14 | 0.0000 | −3.68517E+00 | −4.64187E+00 | −1.99922E+02 | 6.62494E+03 | 1.78419E+03 | 1.90864E+04 |

FIG. 14 shows spherical aberrations. The horizontal axis of FIG. 14 represents a position at which a ray that travels parallel to the optical axis and enters the imaging optical system intersects with the optical axis. The vertical axis of FIG. 14 represents distance of the above-described ray from the optical axis. The value of distance is normalized by the radius of the aperture. In other words, the value 1 on the vertical axis represents the radius of the aperture. In FIG. 14, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

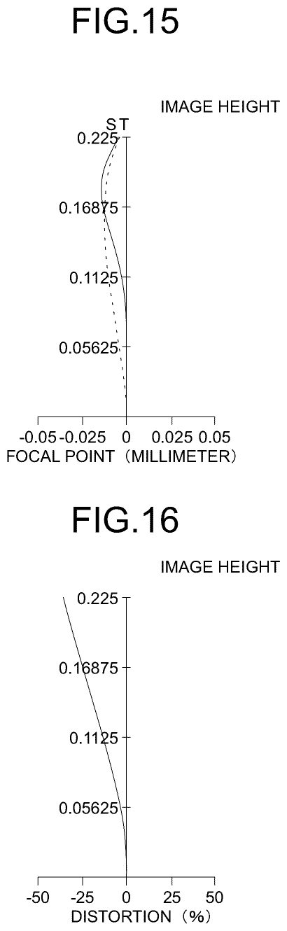

FIG. 15 shows astigmatism of the ray of wavelength of 0.580 micrometers. The horizontal axis of FIG. 15 represents a position in the optical axis direction of the focal point. The vertical axis of FIG. 15 represents image height. The solid line in FIG. 15 represents the graph of the sagittal plane, and the broken line in FIG. 15 represents the graph of the tangential plane.

FIG. 16 shows distortion of the ray of wavelength of 0.580 micrometers. The horizontal axis of FIG. 16 represents distortion. The unit is percent. The vertical axis of FIG. 16 represents image height.

### Example 5

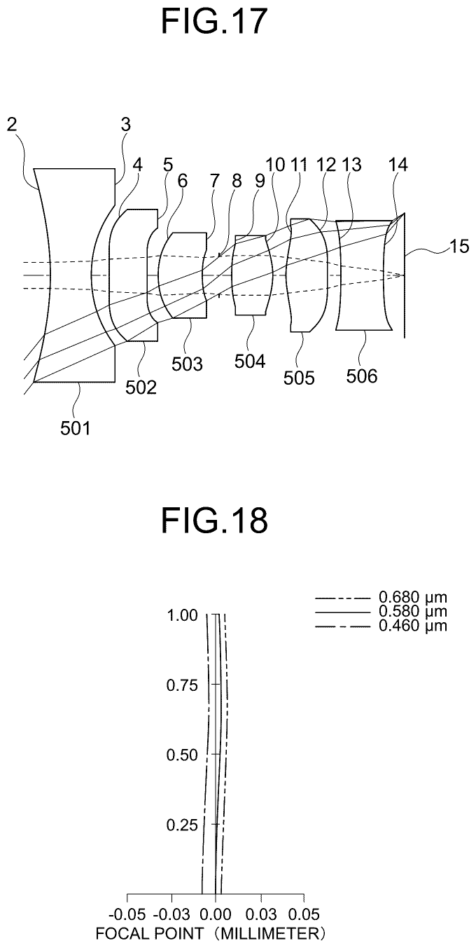

FIG. 17 shows a layout of an imaging optical system of Example 5. The imaging optical system includes six lenses arranged from the object side to the image side. Each of the second lens 502 and the sixth lens 506 is an aspheric lens in which radius of curvature of each of both surfaces is infinity in the paraxial region and which has a power in the peripheral area. The first lens 501 is a biconcave lens. The third lens 503 is a positive meniscus lens which is convex toward the object. The fourth lens 504 is a biconvex lens. The fifth lens 505 is a positive meniscus lens which is convex toward the object. The aperture stop 8 is located between the third lens 503 and the fourth lens 504.

Table 9 shows positions of the optical elements and properties and values of focal length of the lenses of the imaging optical system of Example 5. The focal length f of the whole imaging optical system is given by f=0.242. The F-number Fno is given by Fno=2.459. HFOV representing a half value of angle of view is given by HFOV=50 (degrees). In Table 9, each of the six lenses is represented respectively by lens 1 to lens 6 from the object side.

In the present example, the object distance from the object to the first lens is 5.242(=5.142+0.100) millimeters. Surface 1 does not correspond to a physical object.

TABLE 9

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −1.22661 | 0.147 | Plastic | 1.5311 | 55.634 | −0.519 |
| 3 | | 0.37137 | 0.062 | | | | |
| 4 | Lens 2 | ∞ | 0.137 | Plastic | 1.5311 | 55.634 | ∞ |
| 5 | | ∞ | 0.040 | | | | |
| 6 | Lens 3 | 0.27940 | 0.158 | Plastic | 1.6611 | 20.345 | 0.999 |
| 7 | | 0.37475 | 0.060 | | | | |
| 8 | Ape. | Plano | 0.046 | | | | |
| | Stop | | | | | | |
| 9 | Lens 4 | 1.14758 | 0.146 | Plastic | 1.5311 | 55.634 | 0.428 |
| 10 | | −0.27186 | 0.048 | | | | |
| 11 | Lens 5 | 0.39494 | 0.149 | Plastic | 1.5311 | 55.634 | 0.788 |
| 12 | | 5.98279 | 0.049 | | | | |
| 13 | Lens 6 | ∞ | 0.151 | Plastic | 1.6611 | 20.345 | ∞ |
| 14 | | ∞ | 0.079 | | | | |
| 15 | Image | Plano | 0.000 | | | | |

Table 10 shows conic constants and aspheric coefficients of each surface of each lens of Example 5.

TABLE 10

| Surface | K | A4 | A6 | A8 | A10 | A12 | A14 |
|---|---|---|---|---|---|---|---|
| 2 | −0.9900 | −1.62940E+00 | 1.12972E+01 | 5.43189E+00 | 6.86194E+01 | 2.21917E+02 | −6.08558E+03 |
| 3 | 0.5366 | −6.78796E+00 | 2.80887E+01 | −2.40459E+02 | −1.10497E+03 | −2.99893E+04 | −7.29764E+05 |
| 4 | 0.0000 | 4.29449E+00 | 5.30574E+02 | −3.23164E+03 | −7.93811E+03 | −6.80736E+04 | −4.83186E+05 |
| 5 | 0.0000 | −6.52892E+00 | 1.83585E+03 | −4.87563E+03 | −4.64971E+03 | 1.49093E+06 | 1.18558E+08 |
| 6 | −9.4817 | 3.76692E+01 | 3.67306E+02 | −6.56686E+03 | −5.01531E+01 | −1.96459E+05 | −1.44873E+08 |
| 7 | −8.9543 | 4.84743E+01 | 2.18838E+03 | −9.84270E+04 | 7.68443E+05 | −1.33403E+08 | −6.44867E+09 |
| 9 | 20.0000 | 3.76336E+01 | −8.04224E+01 | 2.98932E+04 | −1.22666E+06 | −3.99035E+07 | 4.49075E+08 |
| 10 | −12.5801 | −4.24427E+01 | 1.82266E+03 | 1.19186E+04 | 6.50614E+04 | −1.21271E+05 | −1.58567E+08 |
| 11 | 2.9093 | −1.33567E+01 | −7.36738E+02 | 6.99419E+02 | −1.17459E+04 | −3.12315E+05 | −1.60979E+07 |
| 12 | 20.0000 | −4.58007E+01 | 7.15245E+01 | 1.47842E+03 | −1.93900E+03 | −8.00120E+04 | −2.54268E+06 |
| 13 | 0.0000 | −2.79585E+01 | 5.14219E+02 | −1.92222E+03 | −2.24391E+04 | 8.96512E+03 | 5.55373E+06 |
| 14 | 0.0000 | 2.13393E+01 | 8.42973E+01 | −1.24751E+03 | −1.60032E+04 | −1.88648E+04 | −3.33566E+06 |

FIG. 18 shows spherical aberrations. The horizontal axis of FIG. 18 represents a position at which a ray that travels parallel to the optical axis and enters the imaging optical system intersects with the optical axis. The vertical axis of FIG. 18 represents distance of the above-described ray from the optical axis. The value of distance is normalized by the radius of the aperture. In other words, the value 1 on the vertical axis represents the radius of the aperture. In FIG. 18, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

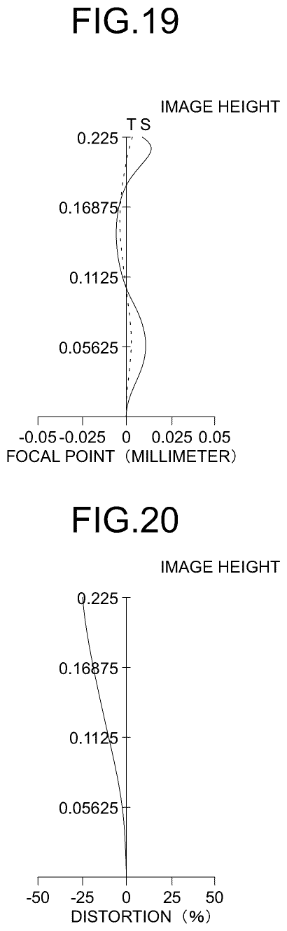

FIG. 19 shows astigmatism of the ray of wavelength of 0.580 micrometers. The horizontal axis of FIG. 19 represents a position in the optical axis direction of the focal point. The vertical axis of FIG. 19 represents image height. The solid line in FIG. 19 represents the graph of the sagittal plane, and the broken line in FIG. 19 represents the graph of the tangential plane.

FIG. 20 shows distortion of the ray of wavelength of 0.580 micrometers. The horizontal axis of FIG. 20 represents distortion. The unit is percent. The vertical axis of FIG. 20 represents image height.

### Example 6

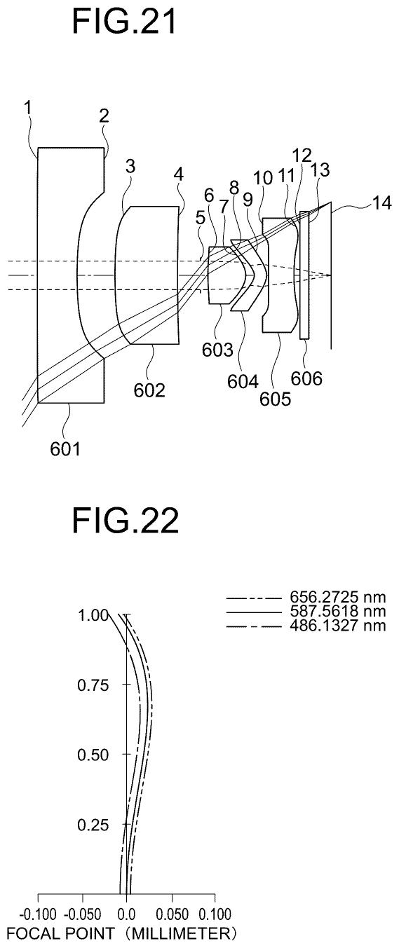

FIG. 21 shows a layout of an imaging optical system of Example 6. The imaging optical system includes five lenses and an infrared cut filter arranged from the object side to the image side. Each of the first lens 601 and the fifth lens 605 is an aspheric lens in which radius of curvature of each of both surfaces is infinity in the paraxial region and which has a power in the peripheral area. The second lens 602 is a positive meniscus lens which is convex toward the image. The third lens 603 is a biconvex lens. The fourth lens 604 is a positive meniscus lens which is convex toward the image. The aperture stop 5 is located between the second lens 602 and the third lens 603.

Table 11 shows positions of the optical elements and properties and values of focal length of the lenses of the imaging optical system of Example 6. The focal length f of the whole imaging optical system is given by f=1.68. The F-number Fno is given by Fno=2.4. HFOV representing a half value of angle of view is given by HFOV=60 (degrees). In Table 11, each of the five lenses is represented respectively by lens 1 to lens 5 from the object side.

In the present example, the object distance from the object to the first lens is infinity.

TABLE 11

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | ∞ | 0.969 | Plastic | 1.535 | 56 | ∞ |
| 2 | | ∞ | 0.907 | | | | |
| 3 | Lens 2 | −13.5368 | 1.500 | Plastic | 1.645 | 23 | 31.281 |
| 4 | | −8.4534 | 0.537 | | | | |
| 5 | Ape. | Plano | 0.184 | | | | |
| | Stop | | | | | | |
| 6 | Lens 3 | 2.9766 | 0.901 | Plastic | 1.545 | 56 | 0.927 |
| 7 | | −0.5432 | 0.209 | | | | |
| 8 | Lens 4 | −0.2916 | 0.300 | Plastic | 1.645 | 23 | −2.584 |
| 9 | | −0.4961 | 0.030 | | | | |
| 10 | Lens 5 | ∞ | 0.633 | Plastic | 1.645 | 23 | ∞ |
| 11 | | ∞ | 0.125 | | | | |
| 12 | IR cut | Plano | 0.500 | Glass | 1.517 | 64.2 | |
| | filter | | | | | | |
| 13 | | Plano | 0.550 | | | | |
| 14 | Image | Plano | | | | | |

Table 12 shows conic constants and aspheric coefficients of each surface of each lens of Example 6.

TABLE 12

| Surface | K | A4 | A6 | A8 | A10 | A12 | A14 |
|---|---|---|---|---|---|---|---|
| 1 | 90.0000 | −1.5303E−04 | 2.3334E−05 | 7.3498E−08 | 3.8255E−09 | 4.4162E−10 | 2.5073E−11 |
| 2 | 90.0000 | 3.6977E−02 | −7.4427E−04 | −1.4973E−04 | −1.6181E−06 | 1.1173E−07 | 1.7654E−08 |
| 3 | −74.9365 | 7.9875E−02 | −2.5245E−02 | 7.1781E−03 | −7.4100E−04 | −1.4753E−06 | −4.1539E−07 |
| 4 | 41.9571 | 1.0468E−01 | −4.0504E−03 | −3.3757E−03 | −3.7648E−05 | 4.4846E−07 | 2.0721E−11 |
| 6 | 4.8351 | −2.1381E−01 | −4.6331E−03 | 1.9591E−01 | −6.8003E−01 | 0.0000E+00 | 0.0000E+00 |
| 7 | −3.0495 | −6.5777E−01 | 1.1836E+00 | −1.0772E+00 | 5.2918E−02 | 3.7859E−10 | −3.1189E−11 |
| 8 | −1.5229 | 4.3333E−01 | 3.2376E−01 | −8.4899E−01 | 4.3482E−01 | −7.9761E−09 | −3.8638E−11 |
| 9 | −0.8285 | 1.0269E+00 | −3.0959E−01 | −1.4370E−01 | 2.5245E−01 | 1.0129E−05 | 1.5627E−11 |
| 10 | 90.0000 | 2.5915E−01 | −4.9768E−01 | 1.8165E−01 | 2.4883E−01 | −5.2312E−01 | 2.4268E−01 |
| 11 | 90.0000 | 3.2968E−01 | −3.9242E−01 | 1.8421E−01 | −4.8284E−02 | 5.7318E−03 | 1.8582E−07 |

FIG. 22 shows spherical aberrations. The horizontal axis of FIG. 22 represents a position at which a ray that travels parallel to the optical axis and enters the imaging optical system intersects with the optical axis. The vertical axis of FIG. 22 represents distance of the above-described ray from the optical axis. The value of distance is normalized by the radius of the aperture. In other words, the value 1 on the vertical axis represents the radius of the aperture. In FIG. 22, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

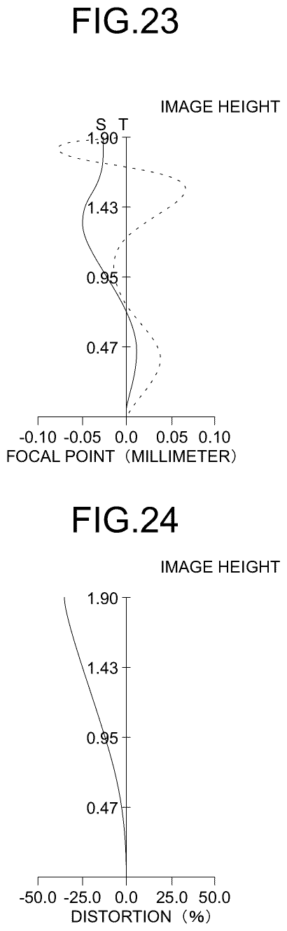

FIG. 23 shows astigmatism of the ray of wavelength of 587.5618 nanometers. The horizontal axis of FIG. 23 represents a position in the optical axis direction of the focal point. The vertical axis of FIG. 23 represents image height. The solid line in FIG. 23 represents the graph of the sagittal plane, and the broken line in FIG. 23 represents the graph of the tangential plane.

FIG. 24 shows distortion of the ray of wavelength of 587.5618 nanometers. The horizontal axis of FIG. 24 represents distortion. The unit is percent. The vertical axis of FIG. 24 represents image height.

### Example 7

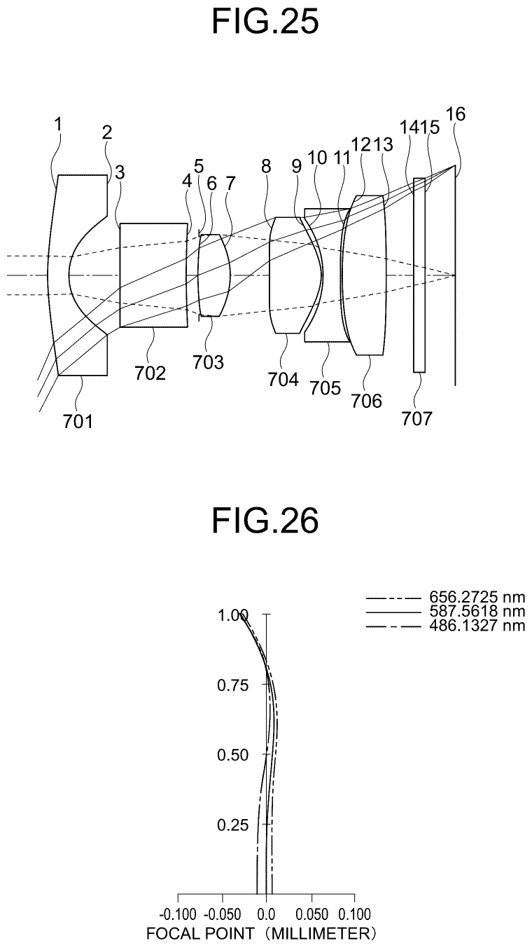

FIG. 25 shows a layout of an imaging optical system of Example 7. The imaging optical system includes six lenses and an infrared cut filter arranged from the object side to the image side. Each of the second lens 702 and the sixth lens 706 is an aspheric lens in which radius of curvature of each of both surfaces is infinity in the paraxial region and which has a power in the peripheral area. The first lens 701 is a negative meniscus lens which is convex toward the object. The third lens 703 is a biconvex lens. The fourth lens 704 is a positive meniscus lens which is convex toward the image. The fifth lens 705 is a negative meniscus lens which is convex toward the image. The aperture stop 5 is located between the second lens 702 and the third lens 703.

Table 13 shows positions of the optical elements and properties and values of focal length of the lenses of the imaging optical system of Example 7. The focal length f of the whole imaging optical system is given by f=1.388. The F-number Fno is given by Fno=2. HFOV representing a half value of angle of view is given by HFOV=65 (degrees). In Table 13, each of the six lenses is represented respectively by lens 1 to lens 6 from the object side.

In the present example, the object distance from the object to the first lens is infinity.

TABLE 13

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 5.2313 | 0.383 | Plastic | 1.545 | 56 | −2.084 |
| 2 | | 0.9091 | 0.939 | | | | |
| 3 | Lens 2 | ∞ | 1.200 | Plastic | 1.645 | 23 | ∞ |
| 4 | | ∞ | 0.228 | | | | |
| 5 | Ape. | Plano | −0.016 | | | | |
| | Stop | | | | | | |
| 6 | Lens 3 | 8.8092 | 0.583 | Plastic | 1.545 | 56 | 2.129 |
| 7 | | −1.3049 | 0.716 | | | | |
| 8 | Lens 4 | −14.5709 | 0.935 | Plastic | 1.545 | 56 | 1.953 |
| 9 | | −1.0144 | 0.032 | | | | |
| 10 | Lens 5 | −1.9136 | 0.326 | Plastic | 1.645 | 23 | −3.036 |
| 11 | | −90.0000 | 0.030 | | | | |
| 12 | Lens 6 | ∞ | 0.788 | Plastic | 1.545 | 56 | ∞ |
| 13 | | ∞ | 0.504 | | | | |
| 14 | IR cut | Plano | 0.210 | Glass | 1.517 | 64.2 | |
| | filter | | | | | | |
| 15 | | Plano | 0.550 | | | | |
| 16 | Image | Plano | | | | | |

Table 14 shows conic constants and aspheric coefficients of each surface of each lens of Example 7.

TABLE 14

| Surface | K | A4 | A6 | A8 | A10 | A12 | A14 |
|---|---|---|---|---|---|---|---|
| 1 | 4.7759 | −1.3084E−02 | −1.8551E−03 | −4.7601E−04 | −1.2301E−09 | 8.3189E−05 | −1.3940E−05 |
| 2 | −0.7006 | 1.0245E−02 | 5.5859E−03 | −1.8272E−02 | −4.4704E−03 | 1.1401E−03 | 6.4795E−09 |
| 3 | −90.0000 | −1.1638E−02 | 1.3507E−02 | −9.4542E−03 | 7.7719E−03 | −1.4475E−02 | 3.3476E−08 |
| 4 | −90.0000 | 9.1993E−02 | 1.1104E−01 | −2.9264E−05 | 9.7613E−04 | 3.4860E−03 | 2.2240E−03 |
| 6 | −90.0000 | 1.2776E−02 | 1.5072E−01 | −1.4084E−01 | 1.8401E−01 | 0.0000E+00 | 0.0000E+00 |
| 7 | −0.0254 | 4.8365E−02 | 8.9969E−02 | −2.0410E−01 | 2.6327E−01 | −1.1680E−06 | −2.9400E−07 |
| 8 | −90.0000 | 1.0899E−01 | 1.9091E−03 | 1.0352E−03 | 7.2516E−03 | 9.5711E−07 | −1.3997E−07 |
| 9 | −1.5662 | 2.9946E−02 | 5.6979E−03 | 1.8164E−02 | 1.4127E−02 | 2.9611E−06 | −8.8313E−08 |
| 10 | −5.1392 | −1.6115E−01 | 7.4276E−02 | 2.5788E−02 | −2.9371E−02 | −1.0694E−06 | 9.5361E−09 |
| 11 | −90.0000 | 6.2733E−02 | 7.6365E−02 | −6.1137E−02 | 1.1897E−02 | 5.8062E−04 | −3.7639E−08 |
| 12 | −90.0000 | 1.3444E−01 | −5.1185E−02 | 3.7287E−03 | −1.2368E−03 | 9.2680E−04 | 2.6585E−04 |
| 13 | −90.0000 | −5.2649E−03 | −2.2544E−04 | −9.4824E−05 | −1.5490E−03 | 4.4799E−04 | 4.7958E−08 |

FIG. 26 shows spherical aberrations. The horizontal axis of FIG. 26 represents a position at which a ray that travels parallel to the optical axis and enters the imaging optical system intersects with the optical axis. The vertical axis of FIG. 26 represents distance of the above-described ray from the optical axis. The value of distance is normalized by the radius of the aperture. In other words, the value 1 on the vertical axis represents the radius of the aperture. In FIG. 26, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

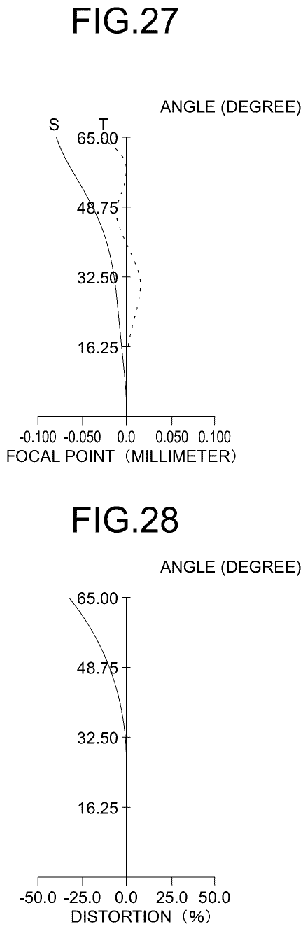

FIG. 27 shows astigmatism of the ray of wavelength of 587.5618 nanometers. The horizontal axis of FIG. 27 represents a position in the optical axis direction of the focal point. The vertical axis of FIG. 27 represents angle that a ray forms with the optical axis. The solid line in FIG. 27 represents the graph of the sagittal plane, and the broken line in FIG. 27 represents the graph of the tangential plane.

FIG. 28 shows distortion of the ray of wavelength of 587.5618 nanometers. The horizontal axis of FIG. 28 represents distortion. The unit is percent. The vertical axis of FIG. 28 represents angle that a ray forms with the optical axis.

### Example 8

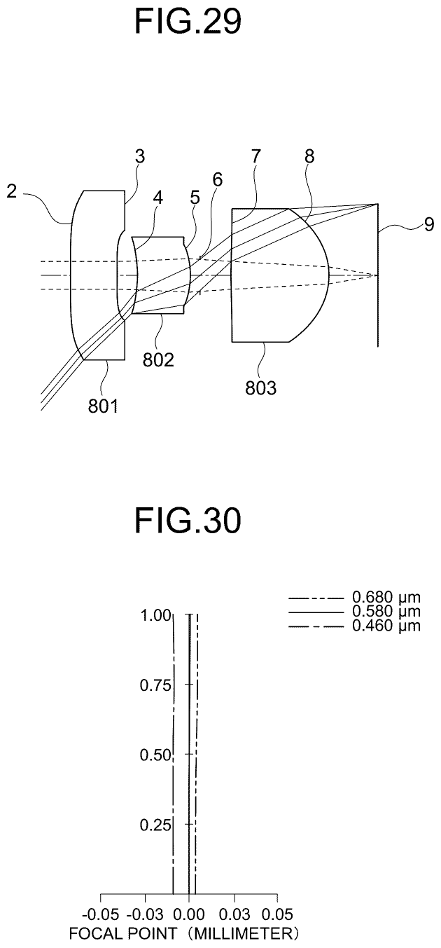

FIG. 29 shows a layout of an imaging optical system of Example 8. The imaging optical system includes three lenses arranged from the object side to the image side. The first lens 801 is an aspheric lens in which radius of curvature of each of both surfaces is infinity in the paraxial region and which has a power in the peripheral area. The second lens 802 is a positive meniscus lens which is convex toward the image. The third lens 803 is a biconvex lens. The aperture stop 6 is located between the second lens 802 and the third lens 803.

Table 15 shows positions of the optical elements and properties and values of focal length of the lenses of the imaging optical system of Example 8. The focal length f of the whole imaging optical system is given by f=0.281. The F-number Fno is given by Fno=3.207. HFOV representing a half value of angle of view is given by HFOV=50 (degrees). In Table 15, each of the three lenses is represented respectively by lens 1 to lens 3 from the object side.

In the present example, the object distance from the object to the first lens is 5.242(=5.142+0.100) millimeters. Surface 1 does not correspond to a physical object.

TABLE 15

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.148 | Plastic | 1.5311 | 55.634 | ∞ |
| 3 | | ∞ | 0.064 | | | | |
| 4 | Lens 2 | −0.43552 | 0.167 | Plastic | 1.6349 | 23.945 | 0.643 |
| 5 | | −0.24944 | 0.030 | | | | |
| 6 | Ape. | Plano | 0.099 | | | | |
| | Stop | | | | | | |
| 7 | Lens 3 | 0.88007 | 0.308 | Plastic | 1.5311 | 55.634 | 0.332 |
| 8 | | −0.19526 | 0.156 | | | | |
| 9 | Image | Plano | | | | | |

Table 16 shows conic constants and aspheric coefficients of each surface of each lens of Example 8.

TABLE 16

| Surface | K | A4 | A6 | A8 | A10 | A12 | A14 |
|---|---|---|---|---|---|---|---|
| 2 | 0.0000 | 6.3833E+00 | 6.0877E+01 | 2.0059E+01 | 2.0564E+02 | −1.7292E+04 | −5.5077E+04 |
| 3 | 0.0000 | 3.4041E+01 | 5.7955E+02 | 1.2425E+04 | 7.7665E+05 | 4.9493E+07 | 4.1164E+09 |
| 4 | −3.3331 | 2.1316E+00 | −1.5054E+02 | −1.0588E+04 | −8.2216E+05 | −5.3972E+07 | −2.8720E+09 |
| 5 | 2.9591 | 1.7724E+01 | 2.0762E+03 | −6.0037E+04 | −2.5347E+07 | 3.1934E+09 | −5.7530E+10 |
| 7 | −17.3616 | −3.4555E+01 | 2.5214E+03 | −1.2066E+05 | −1.1444E+07 | 9.9294E+08 | −1.6919E+10 |
| 8 | −0.441331964 | 1.3219E+01 | 1.9084E+01 | −3.8121E+03 | −5.3213E+04 | 1.4105E+06 | 1.3602E06 |

FIG. 30 shows spherical aberrations. The horizontal axis of FIG. 30 represents a position at which a ray that travels parallel to the optical axis and enters the imaging optical system intersects with the optical axis. The vertical axis of FIG. 30 represents distance of the above-described ray from the optical axis. The value of distance is normalized by the radius of the aperture. In other words, the value 1 on the vertical axis represents the radius of the aperture. In FIG. 30, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

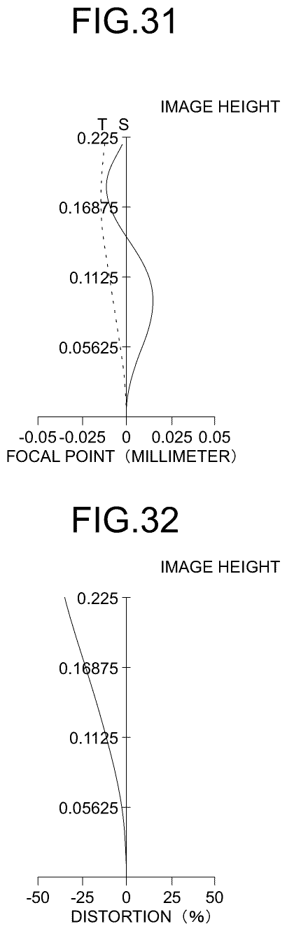

FIG. 31 shows astigmatism of the ray of wavelength of 0.580 micrometers. The horizontal axis of FIG. 31 represents a position in the optical axis direction of the focal point. The vertical axis of FIG. 31 represents image height. The solid line in FIG. 31 represents the graph of the sagittal plane, and the broken line in FIG. 31 represents the graph of the tangential plane.

FIG. 32 shows distortion of the ray of wavelength of 0.580 micrometers. The horizontal axis of FIG. 32 represents distortion. The unit is percent. The vertical axis of FIG. 32 represents image height.

### Example 9

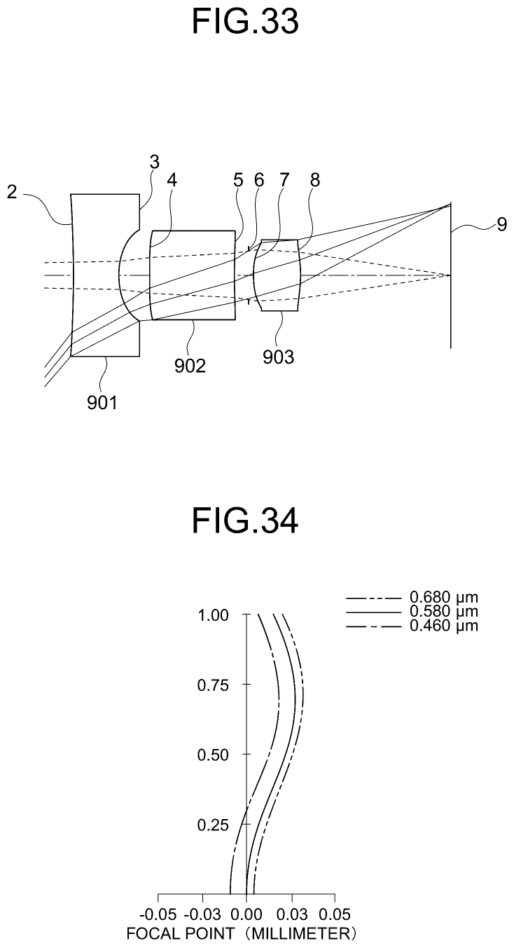

FIG. 33 shows a layout of an imaging optical system of Example 9. The imaging optical system includes three lenses arranged from the object side to the image side. The second lens 902 is an aspheric lens in which radius of curvature of each of both surfaces is infinity in the paraxial region and which has a power in the peripheral area. The first lens 901 is a biconcave lens. The third lens 903 is a biconvex lens. The aperture stop 6 is located between the second lens 902 and the third lens 903.

Table 17 shows positions of the optical elements and properties and values of focal length of the lenses of the imaging optical system of Example 9. The focal length f of the whole imaging optical system is given by f=0.271. The F-number Fno is given by Fno=3.397. HFOV representing a half value of angle of view is given by HFOV=50 (degrees). In Table 15, each of the three lenses is represented respectively by lens 1 to lens 3 from the object side.

In the present example, the object distance from the object to the first lens is 7.000(=6.900+0.100) millimeters. Surface 1 does not correspond to a physical object.

TABLE 17

| | | Radius of | Thickness | | Refractive | Abbe's | Focal |
|---|---|---|---|---|---|---|---|
| Surface | | curvature | or distance | Material | index | number | length |
| 0 | Object | Plano | 6.900 | | | | |
| 1 | | Plano | 0.100 | | | | |
| 2 | Lens 1 | −3.62787 | 0.144 | Plastic | 1.5311 | 55.634 | −0.425 |
| 3 | | 0.24417 | 0.096 | | | | |
| 4 | Lens 2 | ∞ | 0.266 | Plastic | 1.6349 | 23.945 | ∞ |
| 5 | | ∞ | 0.044 | | | | |
| 6 | Ape. | Plano | 0.016 | | | | |
| | Stop | | | | | | |
| 7 | Lens 3 | 0.25304 | 0.147 | Plastic | 1.5311 | 55.634 | 0.308 |
| 8 | | −0.36938 | 0.473 | | | | |
| 9 | Image | Plano | | | | | |

Table 18 shows conic constants and aspheric coefficients of each surface of each lens of Example 9.

TABLE 18

| Surface | K | A4 | A6 | A8 | A10 | A12 | A14 |
|---|---|---|---|---|---|---|---|
| 2 | −7.2871 | 1.8844E−01 | −2.1952E+00 | −6.4879E+00 | 1.5680E+02 | 1.6163E+03 | −1.9165E+05 |
| 3 | 1.2661 | 5.1522E+00 | 2.8599E+02 | 8.0518E+03 | 2.3607E+05 | 1.0022E+07 | 2.6602E+08 |
| 4 | 0.0000 | 1.1316E+01 | 3.7463E+02 | 1.1874E+04 | −1.4492E+05 | −9.3042E+06 | 9.0840E+08 |
| 5 | 0.0000 | 4.0526E+01 | −1.7543E+03 | −3.3923E+03 | 9.9262E+06 | 9.8045E+08 | −9.6190E+10 |
| 7 | 2.8927 | −1.0603E+01 | 3.4683E+03 | −2.7418E+05 | −9.1850E+06 | 2.0587E+09 | −1.0217E+11 |
| 8 | −8.0440 | 2.5712E+01 | −2.1733E+02 | 8.4674E+04 | 8.4327E+06 | 5.4233E+07 | −1.6701E+10 |

FIG. 34 shows spherical aberrations. The horizontal axis of FIG. 34 represents a position at which a ray that travels parallel to the optical axis and enters the imaging optical system intersects with the optical axis. The vertical axis of FIG. 34 represents distance of the above-described ray from the optical axis. The value of distance is normalized by the radius of the aperture. In other words, the value 1 on the vertical axis represents the radius of the aperture. In FIG. 34, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

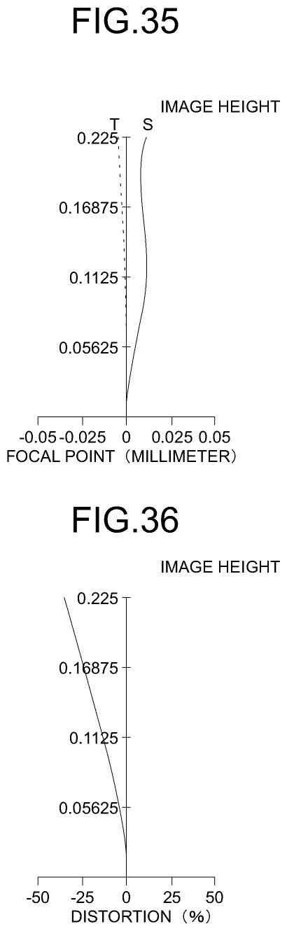

FIG. 35 shows astigmatism of the ray of wavelength of 0.580 micrometers. The horizontal axis of FIG. 35 represents a position in the optical axis direction of the focal point. The vertical axis of FIG. 35 represents image height. The solid line in FIG. 35 represents the graph of the sagittal plane, and the broken line in FIG. 35 represents the graph of the tangential plane.

FIG. 36 shows distortion of the ray of wavelength of 0.580 micrometers. The horizontal axis of FIG. 36 represents distortion. The unit is percent. The vertical axis of FIG. 36 represents image height.

### Example 10

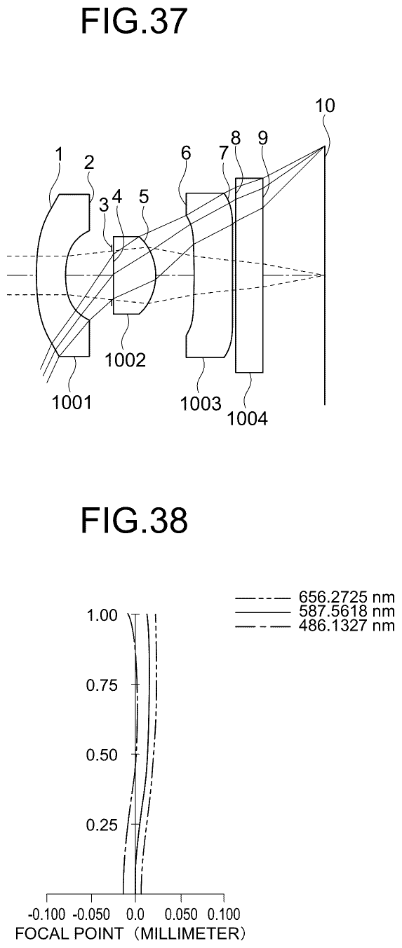

FIG. 37 shows a layout of an imaging optical system of Example 10. The imaging optical system includes three lenses and an infrared cut filter arranged from the object side to the image side. The third lens 1003 is an aspheric lens in which radius of curvature of each of both surfaces is infinity in the paraxial region and which has a power in the peripheral area. The first lens 1001 is a negative meniscus lens which is convex toward the object. The second lens 1002 is a biconvex lens. The aperture stop 3 is located between the first lens 1001 and the second lens 1002.

Table 19 shows positions of the optical elements and properties and values of focal length of the lenses of the imaging optical system of Example 10. The focal length f of the whole imaging optical system is given by f=0.87. The F-number Fno is given by Fno=2.8. HFOV representing a half value of angle of view is given by HFOV=65 (degrees). In Table 19, each of the three lenses is represented respectively by lens 1 to lens 3 from the object side.

In the present example, the object distance from the object to the first lens is infinity.

TABLE 19

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 2.9021 | 0.230 | Plastic | 1.545 | 56 | −1.58 |
| 2 | | 0.6455 | 0.370 | | | | |
| 3 | Ape. | Plano | 0.014 | | | | |
| | Stop | | | | | | |
| 4 | Lens 2 | 6.40245 | 0.335 | Plastic | 1.545 | 56 | 0.755 |
| 5 | | −0.4316 | 0.308 | | | | |
| 6 | Lens 3 | ∞ | 0.306 | Plastic | 1.63 | 24 | ∞ |
| 7 | | ∞ | 0.033 | | | | |
| 8 | IR cut | Plano | 0.210 | Glass | 1.517 | 64.2 | |
| | filter | | | | | | |
| 9 | | Plano | 0.500 | | | | |
| 10 | Image | Plano | | | | | |

Table 20 shows conic constants and aspheric coefficients of each surface of each lens of Example 10.

TABLE 20

| Surface | K | A4 | A6 | A8 | A10 | A12 | A14 |
|---|---|---|---|---|---|---|---|
| 1 | 16.0050 | 1.3252E+00 | −1.4936E+00 | −2.1568E−01 | −2.5552E+00 | −1.6221E−06 | −1.4352E−06 |
| 2 | 0.0575 | 3.3222E+00 | 2.9882E+01 | −2.0762E+02 | 1.2585E+03 | 4.9403E−08 | −4.1702E−10 |
| 4 | −90.0000 | −3.4220E+00 | 2.9371E+01 | −1.1755E+03 | 5.1917E+03 | −2.0131E−07 | 4.3571E−08 |
| 5 | 0.4340 | 5.2549E−01 | −7.1656E+00 | 1.0551E+02 | −6.6880E+02 | 2.5494E−08 | −8.0269E−10 |
| 6 | 0.0000 | −5.5175E−01 | −1.8052E+00 | −9.1508E+00 | 4.0814E+00 | −2.3728E−05 | 8.3786E−09 |
| 7 | 0.0000 | 5.3875E−01 | −3.3879E+00 | 3.8628E+00 | −2.2918E+00 | −8.0836E−06 | 3.7892E−10 |

FIG. 38 shows spherical aberrations. The horizontal axis of FIG. 38 represents a position at which a ray that travels parallel to the optical axis and enters the imaging optical system intersects with the optical axis. The vertical axis of FIG. 38 represents distance of the above-described ray from the optical axis. The value of distance is normalized by the radius of the aperture. In other words, the value 1 on the vertical axis represents the radius of the aperture. In FIG. 38, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

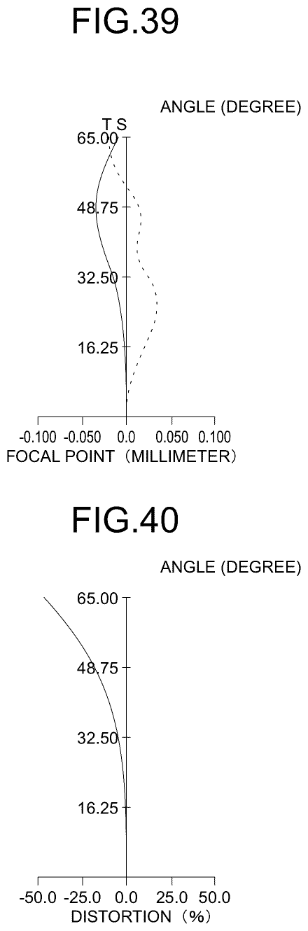

FIG. 39 shows astigmatism of the ray of wavelength of 587.5618 nanometers. The horizontal axis of FIG. 39 represents a position in the optical axis direction of the focal point. The vertical axis of FIG. 39 represents angle that a ray forms with the optical axis. The solid line in FIG. 39 represents the graph of the sagittal plane, and the broken line in FIG. 39 represents the graph of the tangential plane.

FIG. 40 shows distortion of the ray of wavelength of 587.5618 nanometers. The horizontal axis of FIG. 40 represents distortion. The unit is percent. The vertical axis of FIG. 40 represents angle that a ray forms with the optical axis.

### Example 11

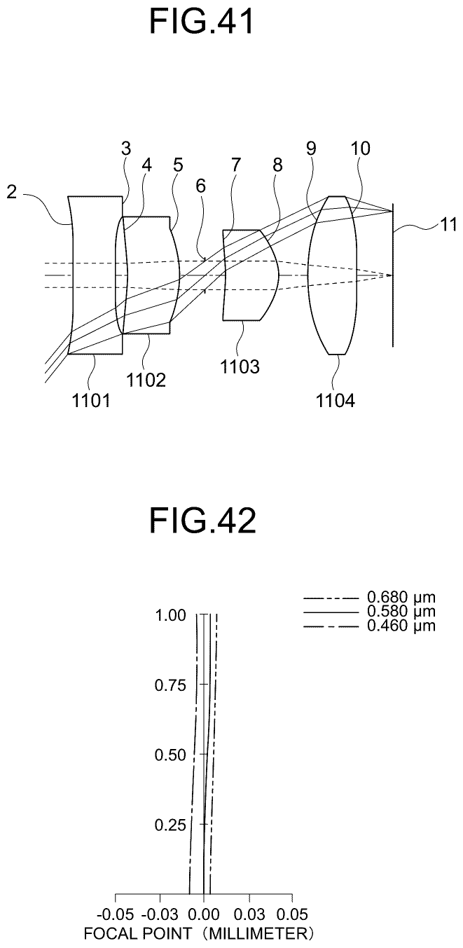

FIG. 41 shows a layout of an imaging optical system of Example 11. The imaging optical system includes four lenses arranged from the object side to the image side. The first lens 1101 is an aspheric lens in which radius of curvature of each of both surfaces is infinity in the paraxial region and which has a power in the peripheral area. The second lens 1102 is a positive meniscus lens which is convex toward the image. The third lens 1103 is a positive meniscus lens which is convex toward the image. The fourth lens 1104 is a biconvex lens. The aperture stop 6 is located between the second lens 1102 and the third lens 1103.

Table 21 shows positions of the optical elements and properties and values of focal length of the lenses of the imaging optical system of Example 11. The focal length f of the whole imaging optical system is given by f=0.273. The F-number Fno is given by Fno=3.25. HFOV representing a half value of angle of view is given by HFOV=50 (degrees). In Table 21, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 21

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.141 | Plastic | 1.5311 | 55.634 | ∞ |
| 3 | | ∞ | 0.043 | | | | |
| 4 | Lens 2 | −0.37496 | 0.177 | Plastic | 1.6349 | 23.945 | 1.238 |
| 5 | | −0.30569 | 0.085 | | | | |
| 6 | Ape. | Plano | 0.071 | | | | |
| | Stop | | | | | | |
| 7 | Lens 3 | −0.48652 | 0.181 | Plastic | 1.5311 | 55.634 | 0.410 |
| 8 | | −0.16989 | 0.100 | | | | |
| 9 | Lens 4 | 0.83415 | 0.162 | Plastic | 1.5311 | 55.634 | 1.313 |
| 10 | | −3.99663 | 0.125 | | | | |
| 11 | Image | Plano | | | | | |

Table 22 shows conic constants and aspheric coefficients of each surface of each lens of Example 11.

TABLE 22

| Surface | K | A4 | A6 | A8 | A10 | A12 | A14 |
|---|---|---|---|---|---|---|---|
| 2 | 0.0000 | −2.32836E+00 | −1.55438E+01 | −1.41717E+01 | −1.63171E+02 | 6.17353E+02 | 1.10256E+04 |
| 3 | 0.0000 | 1.64151E+01 | 1.46452E+01 | −3.38912E+02 | −5.85873E+03 | −1.86339E+05 | −4.65676E+06 |
| 4 | −17.5374 | 1.41791E+01 | −6.74238E+01 | −1.30252E+02 | −1.82588E+02 | 4.89228E+04 | 1.25134E+06 |
| 5 | −12.8678 | −9.41961E+00 | 7.20759E+01 | 1.65486E+02 | −2.84383E+04 | −5.79999E+05 | 1.00497E+08 |
| 7 | 2.3672 | −1.26715E+01 | 6.17218E+02 | 2.52732E+05 | 1.73377E+07 | 8.27034E+07 | −2.15756E+11 |
| 8 | −0.9986 | 1.52868E+00 | −7.21124E+01 | 7.03914E+03 | 2.45533E+05 | 7.79151E+06 | 2.92319E+08 |
| 9 | 6.6857 | 5.81604E+00 | −2.34589E+01 | 1.11135E+02 | −1.29976E+03 | −1.58222E+04 | −2.68141E+05 |
| 10 | 20.0000 | −3.97802E+00 | −2.06706E+01 | −2.53867E+01 | 2.87569E+02 | −1.94959E+03 | −1.83457E+05 |

FIG. 42 shows spherical aberrations. The horizontal axis of FIG. 42 represents a position at which a ray that travels parallel to the optical axis and enters the imaging optical system intersects with the optical axis. The vertical axis of FIG. 42 represents distance of the above-described ray from the optical axis. The value of distance is normalized by the radius of the aperture. In other words, the value 1 on the vertical axis represents the radius of the aperture. In FIG. 42, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

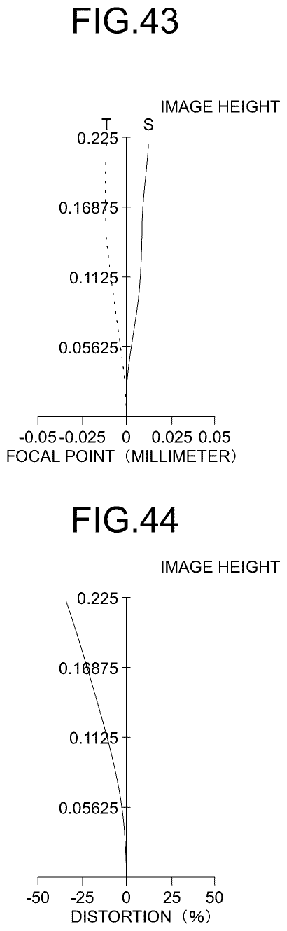

FIG. 43 shows astigmatism of the ray of wavelength of 0.580 micrometers. The horizontal axis of FIG. 43 represents a position in the optical axis direction of the focal point. The vertical axis of FIG. 43 represents image height. The solid line in FIG. 43 represents the graph of the sagittal plane, and the broken line in FIG. 43 represents the graph of the tangential plane.

FIG. 44 shows distortion of the ray of wavelength of 0.580 micrometers. The horizontal axis of FIG. 44 represents distortion. The unit is percent. The vertical axis of FIG. 44 represents image height.

### Example 12

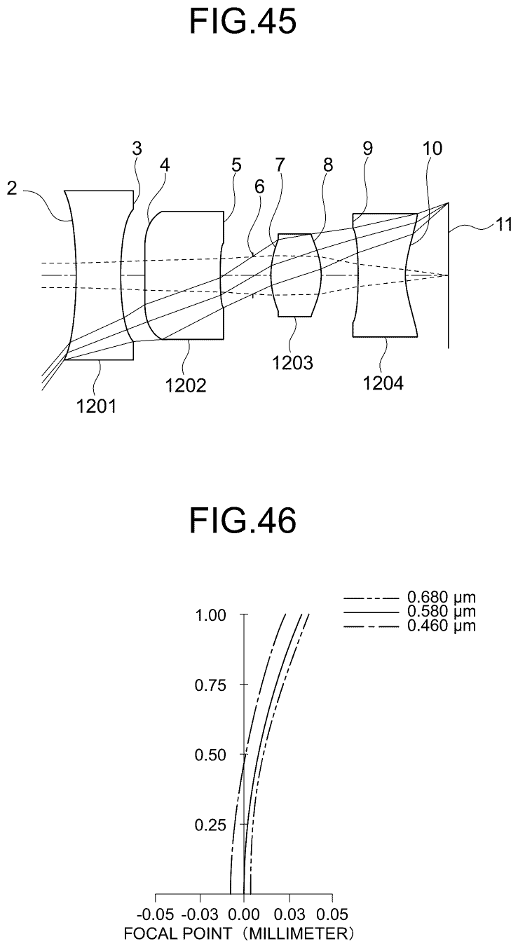

FIG. 45 shows a layout of an imaging optical system of Example 12. The imaging optical system includes four lenses arranged from the object side to the image side. The second lens 1202 is an aspheric lens in which radius of curvature of each of both surfaces is infinity in the paraxial region and which has a power in the peripheral area. The first lens 1201 is a biconcave lens. The third lens 1203 is a biconvex lens. The fourth lens 1204 is a biconcave lens. The aperture stop 6 is located between the second lens 1202 and the third lens 1203.

Table 23 shows positions of the optical elements and properties and values of focal length of the lenses of the imaging optical system of Example 12. The focal length f of the whole imaging optical system is given by f=0.265. The F-number Fno is given by Fno=3.577. HFOV representing a half value of angle of view is given by HFOV=50 (degrees). In Table 23, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 23

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −1.37206 | 0.136 | Plastic | 1.5311 | 55.634 | −0.915 |
| 3 | | 0.77994 | 0.074 | | | | |
| 4 | Lens 2 | ∞ | 0.235 | Plastic | 1.6349 | 23.945 | ∞ |
| 5 | | ∞ | 0.099 | | | | |
| 6 | Ape. | Plano | 0.058 | | | | |
| | Stop | | | | | | |
| 7 | Lens 3 | 0.34917 | 0.152 | Plastic | 1.5311 | 55.634 | 0.263 |
| 8 | | 0.19799 | 0.113 | | | | |
| 9 | Lens 4 | −1.19601 | 0.147 | Plastic | 1.4917 | 55.31 | −0.490 |
| 10 | | 0.31434 | 0.130 | | | | |
| 11 | Image | Plano | | | | | |

Table 24 shows conic constants and aspheric coefficients of each surface of each lens of Example 12.

TABLE 24

| Surface | K | A4 | A6 | A8 | A10 | A12 | A14 |
|---|---|---|---|---|---|---|---|
| 2 | 12.2313 | 6.69617E−01 | −2.33764E+01 | −1.23735E+01 | −8.76197E+01 | −1.82077E+03 | −2.21450E+02 |
| 3 | −12.4482 | 1.79394E+00 | 1.68880E+02 | −1.95345E+01 | 1.51058E+03 | 7.18888E+04 | 3.05010E+04 |
| 4 | 0.0000 | 1.41231E+01 | 3.70323E+02 | 6.49774E+02 | 8.27085E+03 | 3.05735E+05 | −2.37465E+05 |
| 5 | 0.0000 | 3.82694E+01 | 2.38445E+03 | 9.91706E+03 | 1.51919E+06 | 7.59284E+08 | 3.23483E+09 |
| 7 | 5.4641 | −1.21476E+01 | 1.06322E+03 | −9.68789E+03 | −6.93064E+05 | −2.46592E+08 | −3.16631E+08 |
| 8 | −2.2492 | 2.53282E+01 | −4.03037E+02 | 4.90848E+04 | 2.64671E+04 | 2.59425E+06 | 2.07856E+08 |
| 9 | 3.7970 | −2.64384E+00 | −3.27368E+02 | 1.54687E+03 | −1.10438E+04 | −1.31452E+06 | 4.00774E+06 |
| 10 | −5.3897 | −3.24395E+00 | −2.60617E+01 | −1.44229E+03 | −2.95760E+03 | −1.21851E+05 | −9.91530E+05 |

FIG. 46 shows spherical aberrations. The horizontal axis of FIG. 46 represents a position at which a ray that travels parallel to the optical axis and enters the imaging optical system intersects with the optical axis. The vertical axis of FIG. 46 represents distance of the above-described ray from the optical axis. The value of distance is normalized by the radius of the aperture. In other words, the value 1 on the vertical axis represents the radius of the aperture. In FIG. 46, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

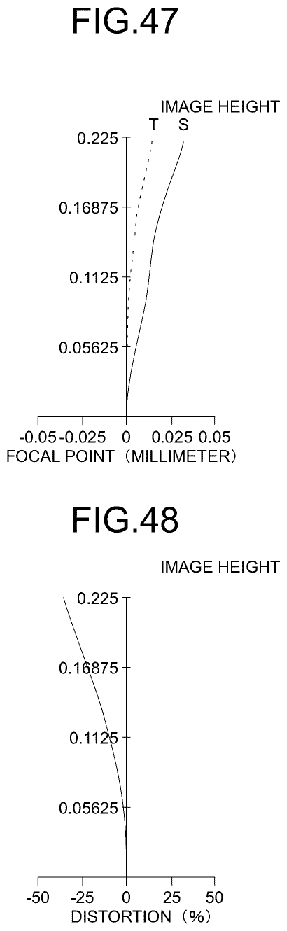

FIG. 47 shows astigmatism of the ray of wavelength of 0.580 micrometers. The horizontal axis of FIG. 47 represents a position in the optical axis direction of the focal point. The vertical axis of FIG. 47 represents image height. The solid line in FIG. 47 represents the graph of the sagittal plane, and the broken line in FIG. 47 represents the graph of the tangential plane.

FIG. 48 shows distortion of the ray of wavelength of 0.580 micrometers. The horizontal axis of FIG. 48 represents distortion. The unit is percent. The vertical axis of FIG. 48 represents image height.

### Reference Example 1

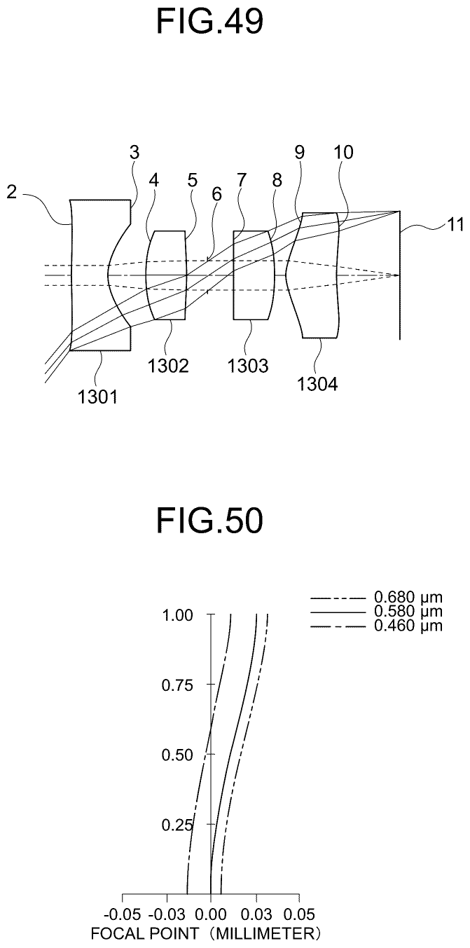

FIG. 49 shows a layout of an imaging optical system of Reference Example 1. The imaging optical system includes four lenses arranged from the object side to the image side. The third lens 1303 is an aspheric lens in which radius of curvature of each of both surfaces is infinity in the paraxial region and which has a power in the peripheral area. The first lens 1301 is a negative meniscus lens which is convex toward the object. The second lens 1302 is a biconvex lens. The fourth lens 1304 is a positive meniscus lens which is convex toward the object. The aperture stop 6 is located between the second lens 1302 and the third lens 1303.

Table 25 shows positions of the optical elements and properties and values of focal length of the lenses of the imaging optical system of Example 12. The focal length f of the whole imaging optical system is given by f=0.24. The F-number Fno is given by Fno=3.438. HFOV representing a half value of angle of view is given by HFOV=50 (degrees). In Table 25, each of the four lenses is represented respectively by lens 1 to lens 4 from the object side.

In the present reference example, the object distance from the object to the first lens is 5.242(=5.142+0.100) millimeters. Surface 1 does not correspond to a physical object.

TABLE 25

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | 1.45294 | 0.127 | Plastic | 1.5311 | 55.634 | −0.355 |
| 3 | | 0.16224 | 0.133 | | | | |
| 4 | Lens 2 | 0.45523 | 0.141 | Plastic | 1.6349 | 23.945 | 0.480 |
| 5 | | −0.92220 | 0.073 | | | | |
| 6 | Ape. | Plano | 0.089 | | | | |
| | Stop | | | | | | |
| 7 | Lens 3 | ∞ | 0.143 | Plastic | 1.5311 | 55.634 | ∞ |
| 8 | | ∞ | 0.040 | | | | |
| 9 | Lens 4 | 0.15850 | 0.176 | Plastic | 1.5311 | 55.634 | 0.342 |
| 10 | | 0.75592 | 0.219 | | | | |
| 11 | Image | Plano | | | | | |

Table 26 shows conic constants and aspheric coefficients of each surface of each lens of Reference Example 1.

TABLE 26

| Surface | K | A4 | A6 | A8 | A10 | A12 | A14 |
|---|---|---|---|---|---|---|---|
| 2 | −9.1435 | −5.83006E+00 | 2.78698E+00 | 6.78811E+01 | −5.82375E+01 | −2.41663E+03 | −6.70222E+04 |
| 3 | −1.0771 | −7.57825E+00 | −5.75350E+02 | 1.14496E+04 | −2.49280E+04 | −3.13127E+05 | −2.79784E+07 |
| 4 | −2.5817 | 2.77779E−01 | 2.40042E+02 | 3.85923E+03 | 7.30756E+04 | 1.36131E+06 | −1.24459E+08 |
| 5 | −20.0001 | 6.27636E+00 | 1.03990E+02 | 7.13269E+03 | −2.54640E+04 | 5.62848E+07 | −1.07027E+09 |
| 7 | 0.0000 | −1.73270E+01 | 3.83561E+03 | −1.29365E+05 | −5.18863E+05 | −1.86278E+07 | 2.60436E+09 |
| 8 | 0.0000 | −9.03193E+01 | 2.35365E+03 | −1.03609E+04 | 3.77145E+04 | 2.08807E+05 | −3.24329E+07 |
| 9 | −4.5848 | −2.57022E+00 | −4.28017E+02 | 7.07632E+03 | −5.85680E+02 | 3.80621E+04 | 1.59338E+06 |
| 10 | 9.2100 | −6.54348E+00 | −4.22838E+02 | 3.19529E+03 | −8.97533E+01 | −3.38674E+04 | −1.22112E+06 |

FIG. 50 shows spherical aberrations. The horizontal axis of FIG. 50 represents a position at which a ray that travels parallel to the optical axis and enters the imaging optical system intersects with the optical axis. The vertical axis of FIG. 50 represents distance of the above-described ray from the optical axis. The value of distance is normalized by the radius of the aperture. In other words, the value 1 on the vertical axis represents the radius of the aperture. In FIG. 50, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

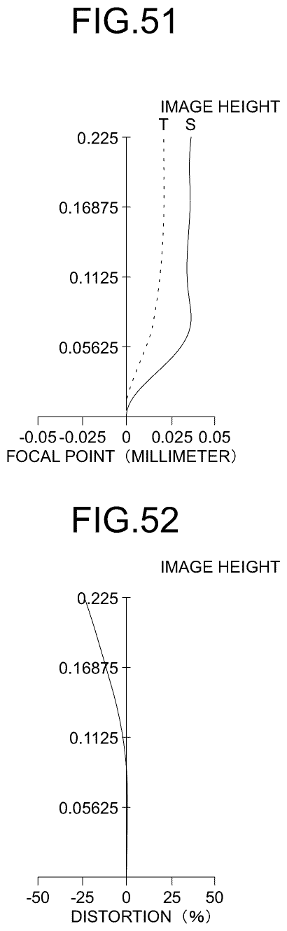

FIG. 51 shows astigmatism of the ray of wavelength of 0.580 micrometers. The horizontal axis of FIG. 51 represents a position in the optical axis direction of the focal point. The vertical axis of FIG. 51 represents image height. The solid line in FIG. 51 represents the graph of the sagittal plane, and the broken line in FIG. 51 represents the graph of the tangential plane.

FIG. 52 shows distortion of the ray of wavelength of 0.580 micrometers. The horizontal axis of FIG. 52 represents distortion. The unit is percent. The vertical axis of FIG. 52 represents image height.

### Example 14

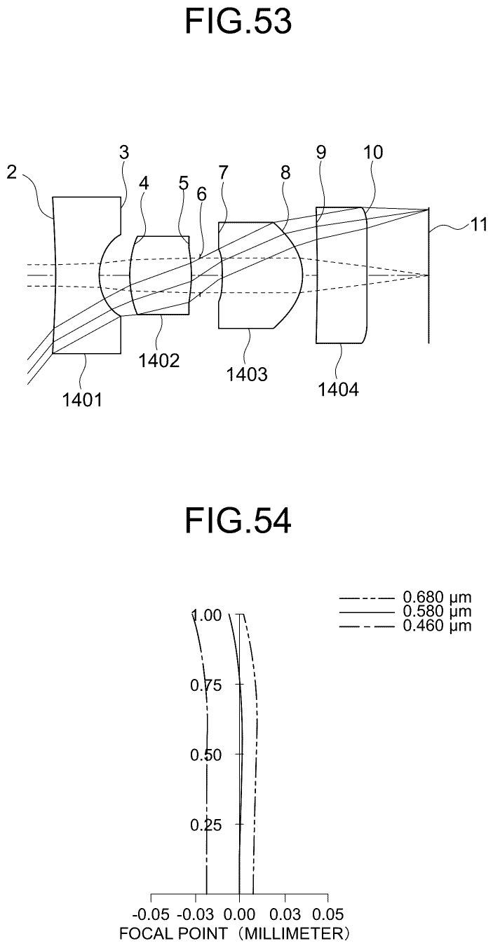

FIG. 53 shows a layout of an imaging optical system of Example 14. The imaging optical system includes four lenses arranged from the object side to the image side. The fourth lens 1404 is an aspheric lens in which radius of curvature of each of both surfaces is infinity in the paraxial region and which has a power in the peripheral area. The first lens 1401 is a biconcave lens. The second lens 1402 is a biconvex lens. The third lens 1403 is a positive meniscus lens which is convex toward the image. The aperture stop 6 is located between the second lens 1402 and the third lens 1403.

Table 27 shows positions of the optical elements and properties and values of focal length of the lenses of the imaging optical system of Example 14. The focal length f of the whole imaging optical system is given by f=0.244. The F-number Fno is given by Fno=3.185. HFOV representing a half value of angle of view is given by HFOV=50 (degrees). In Table 27, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 27

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −1.56147 | 0.146 | Plastic | 1.5311 | 55.634 | −0.295 |
| 3 | | 0.18019 | 0.105 | | | | |
| 4 | Lens 2 | 0.40965 | 0.208 | Plastic | 1.6349 | 23.945 | 0.363 |
| 5 | | 0.46414 | 0.029 | | | | |
| 6 | Ape. | Plano | 0.076 | | | | |
| | Stop | | | | | | |
| 7 | Lens 3 | 0.54489 | 0.271 | Plastic | 1.5311 | 55.634 | 0.394 |
| 8 | | 0.17756 | 0.048 | | | | |
| 9 | Lens 4 | ∞ | 0.169 | Plastic | 1.5311 | 55.634 | ∞ |
| 10 | | ∞ | 0.207 | | | | |
| 11 | Image | Plano | | | | | |

Table 28 shows conic constants and aspheric coefficients of each surface of each lens of Example 14.

TABLE 28

| Surface | K | A4 | A6 | A8 | A10 | A12 | A14 |
|---|---|---|---|---|---|---|---|
| 2 | −12.8414 | 3.31259E+00 | −7.19393E+00 | −6.70894E+01 | −3.66190E+02 | −4.93383E+02 | −6.11731E+03 |
| 3 | 0.4405 | −4.58397E−01 | 4.33687E+01 | 3.96877E+03 | 5.63172E+05 | 1.01356E+07 | −3.77482E+09 |
| 4 | −9.4333 | 2.31138E+01 | −1.21532E+02 | −3.55780E+03 | 2.75787E+04 | 9.49692E+06 | 6.24750E+08 |
| 5 | −6.7282 | −2.00366E+01 | −8.89183E+01 | −2.24590E+04 | −2.94207E+05 | 9.50845E+07 | 6.67465E+09 |
| 7 | 17.4482 | −5.80457E+01 | 2.65830E+03 | 1.02001E+05 | 2.38257E+06 | −9.97373E+07 | −6.23985E+10 |
| 8 | −0.2813 | 6.75849E+00 | 1.11674E+02 | 2.33977E+03 | 2.48072E+04 | 1.42314E+06 | 8.51453E+07 |
| 9 | 0.0000 | −1.66280E+00 | 1.25555E+01 | 7.18142E+02 | 9.91073E+03 | −1.32431E+05 | −1.43968E+07 |
| 10 | 0.0000 | −1.30962E+00 | −1.96094E+01 | −4.02359E+02 | −5.30328E+03 | −8.20004E+04 | −2.04582E+06 |

FIG. 54 shows spherical aberrations. The horizontal axis of FIG. 54 represents a position at which a ray that travels parallel to the optical axis and enters the imaging optical system intersects with the optical axis. The vertical axis of FIG. 54 represents distance of the above-described ray from the optical axis. The value of distance is normalized by the radius of the aperture. In other words, the value 1 on the vertical axis represents the radius of the aperture. In FIG. 54, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

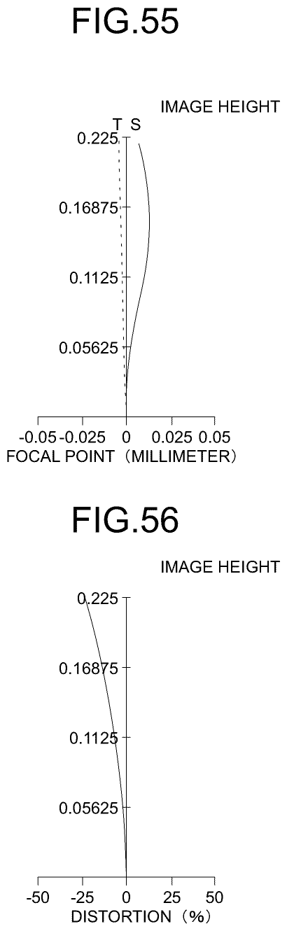

FIG. 55 shows astigmatism of the ray of wavelength of 0.580 micrometers. The horizontal axis of FIG. 55 represents a position in the optical axis direction of the focal point. The vertical axis of FIG. 55 represents image height. The solid line in FIG. 55 represents the graph of the sagittal plane, and the broken line in FIG. 55 represents the graph of the tangential plane.

FIG. 56 shows distortion of the ray of wavelength of 0.580 micrometers. The horizontal axis of FIG. 56 represents distortion. The unit is percent. The vertical axis of FIG. 56 represents image height.

### Example 15

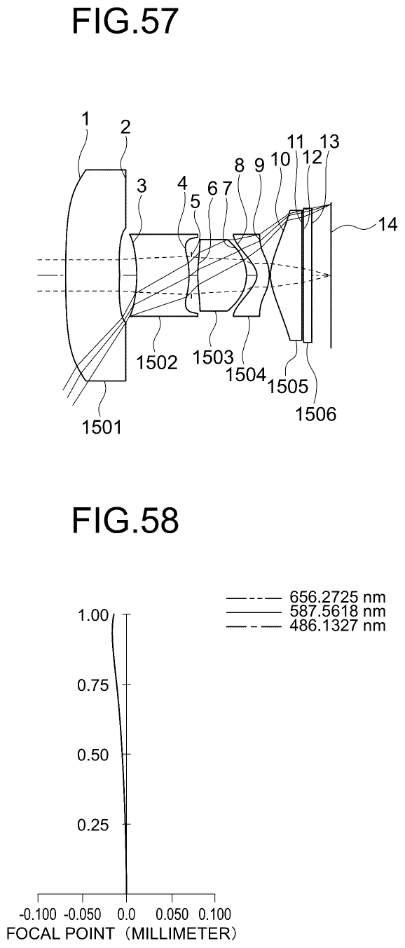

FIG. 57 shows a layout of an imaging optical system of Example 15. The imaging optical system includes five lenses and an infrared cut filter arranged from the object side to the image side. The first lens 1501 is an aspheric lens in which radius of curvature of each of both surfaces is infinity in the paraxial region and which has a power in the peripheral area. The second lens 1502 is a positive meniscus lens which is convex toward the image. The third lens 1503 is a biconvex lens. The fourth lens 1504 is a negative meniscus lens which is convex toward the image. The fifth lens 1505 is a positive meniscus lens which is convex toward the object. The aperture stop 5 is located between the second lens 1502 and the third lens 1503.

Table 29 shows positions of the optical elements and properties and values of focal length of the lenses of the imaging optical system of Example 15. The focal length f of the whole imaging optical system is given by f=1.69. The F-number Fno is given by Fno=2. HFOV representing a half value of angle of view is given by HFOV=60 (degrees). In Table 29, each of the five lenses is represented respectively by lens 1 to lens 5 from the object side.

In the present example, the object distance from the object to the first lens is infinity.

TABLE 29

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | ∞ | 1.500 | Plastic | 1.535 | 56 | ∞ |
| 2 | | ∞ | 0.505 | | | | |
| 3 | Lens 2 | −2.7857 | 1.500 | Plastic | 1.545 | 56 | 19.677 |
| 4 | | −2.6313 | 0.058 | | | | |
| 5 | Ape. | Plano | 0.169 | | | | |
| | Stop | | | | | | |
| 6 | Lens 3 | 2.4177 | 1.396 | Plastic | 1.545 | 56 | 1.468 |
| 7 | | −0.9520 | 0.285 | | | | |
| 8 | Lens 4 | 0.2845 | 0.340 | Plastic | 1.645 | 23 | −0.954 |
| 9 | | −0.7770 | 0.030 | | | | |
| 10 | Lens 5 | 0.7226 | 0.908 | Plastic | 1.535 | 56 | 1.334 |
| 11 | | 66.8602 | 0.050 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 30 shows conic constants and aspheric coefficients of each surface of each lens of Example 15.

TABLE 30

| Surface | K | A4 | A6 | A8 | A10 | A12 | A14 |
|---|---|---|---|---|---|---|---|
| 1 | 90.0000 | 1.7391E−02 | −1.8991E−03 | 2.0821E−05 | 1.5625E−05 | −1.2142E−06 | 6.5592E−08 |
| 2 | 90.0000 | 1.0834E−01 | −6.0218E−02 | 4.7490E−02 | −1.3516E−02 | −7.2380E−03 | 4.8288E−03 |
| 4 | −28.2707 | −2.9938E−02 | −2.7631E−03 | 3.4536E−03 | −4.1771E−03 | 1.1262E−04 | −7.0895E−07 |
| 5 | −9.5592 | −1.3215E−01 | 1.8042E−01 | −6.6468E−01 | 9.0942E−01 | 7.4246E−06 | −9.9031E−07 |
| 6 | −2.4812 | −9.6787E−02 | −3.3296E−02 | −1.8539E−01 | −3.0522E−01 | 0.0000E+00 | 0.0000E+00 |
| 7 | −0.5755 | 7.2623E−02 | −1.5101E−01 | 1.5996E−01 | −8.4019E−02 | −5.5327E−10 | −2.5667E−11 |
| 8 | −1.9162 | 1.1325E−01 | 3.3713E−02 | −2.6310E−02 | 2.0523E−02 | 4.7016E−10 | −5.2073E−11 |
| 9 | −2.3163 | 1.5675E−01 | 4.4456E−02 | −3.1523E−02 | 1.3948E−02 | −9.5419E−08 | 4.7284E−11 |
| 10 | −5.6505 | −5.7112E−02 | 1.2683E−02 | 4.8910E−03 | −1.4125E−03 | 2.2661E−05 | 7.1840E−10 |
| 11 | 33.8431 | 1.2749E−03 | −1.4602E−02 | 9.1121E−03 | −1.5879E−03 | 6.3516E−06 | 4.6752E−10 |

FIG. 58 shows spherical aberrations. The horizontal axis of FIG. 58 represents a position at which a ray that travels parallel to the optical axis and enters the imaging optical system intersects with the optical axis. The vertical axis of FIG. 58 represents distance of the above-described ray from the optical axis. The value of distance is normalized by the radius of the aperture. In other words, the value 1 on the vertical axis represents the radius of the aperture. In FIG. 58, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

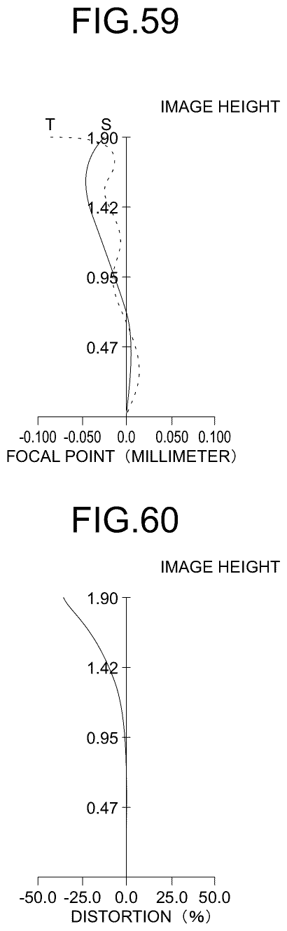

FIG. 59 shows astigmatism of the ray of wavelength of 587.5618 nanometers. The horizontal axis of FIG. 59 represents a position in the optical axis direction of the focal point. The vertical axis of FIG. 59 represents image height. The solid line in FIG. 59 represents the graph of the sagittal plane, and the broken line in FIG. 59 represents the graph of the tangential plane.

FIG. 60 shows distortion of the ray of wavelength of 587.5618 nanometers. The horizontal axis of FIG. 60 represents distortion. The unit is percent. The vertical axis of FIG. 60 represents image height.

### Example 16

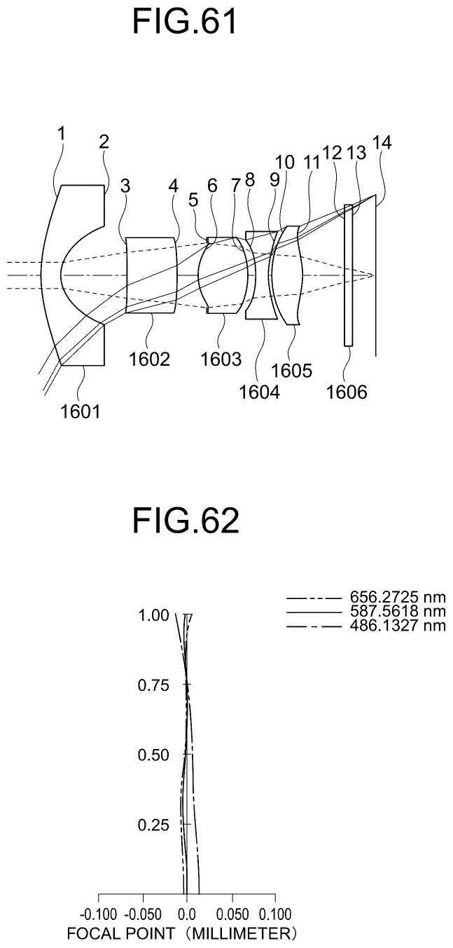

FIG. 61 shows a layout of an imaging optical system of Example 16. The imaging optical system includes five lenses and an infrared cut filter arranged from the object side to the image side. The second lens 1602 is an aspheric lens in which radius of curvature of each of both surfaces is infinity in the paraxial region and which has a power in the peripheral area. The first lens 1601 is a negative meniscus lens which is convex toward the object. The third lens 1603 is a biconvex lens. The fourth lens 1604 is a biconcave lens. The fifth lens 1605 is a biconvex lens. The aperture stop 5 is located closer to the object than the object-side surface of the third lens 1603.

Table 31 shows positions of the optical elements and properties and values of focal length of the lenses of the imaging optical system of Example 16. The focal length f of the whole imaging optical system is given by f=1.3. The F-number Fno is given by Fno=2. HFOV representing a half value of angle of view is given by HFOV=60 (degrees). In Table 31, each of the five lenses is represented respectively by lens 1 to lens 5 from the object side.

In the present example, the object distance from the object to the first lens is infinity.

TABLE 31

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 4.2189 | 0.479 | Plastic | 1.545 | 56 | −2.179 |
| 2 | | 0.8895 | 1.564 | | | | |
| 3 | Lens 2 | ∞ | 1.200 | Plastic | 1.645 | 23 | ∞ |
| 4 | | ∞ | 0.702 | | | | |
| 5 | Ape. | Plano | −0.184 | | | | |
| | Stop | | | | | | |
| 6 | Lens 3 | 1.2588 | 1.161 | Plastic | 1.545 | 56 | 1.552 |
| 7 | | −1.7404 | 0.221 | | | | |
| 8 | Lens 4 | −2.3807 | 0.300 | Plastic | 1.645 | 23 | −1.365 |
| 9 | | 1.4656 | 0.089 | | | | |
| 10 | Lens 5 | 1.8256 | 0.722 | Plastic | 1.545 | 56 | 1.944 |
| 11 | | −2.1737 | 0.986 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 32 shows conic constants and aspheric coefficients of each surface of each lens of Example 16.

TABLE 32

| Surface | K | A4 | A6 | A8 | A10 | A12 | A14 |
|---|---|---|---|---|---|---|---|
| 1 | 0.8179 | 5.7037E−03 | −4.1021E−03 | 2.3033E−04 | 2.2707E−05 | −1.6911E−06 | −6.5007E−08 |
| 2 | −0.8896 | 8.7653E−02 | −9.3382E−03 | 4.4523E−02 | −2.5845E−02 | −1.6860E−07 | 1.6171E−08 |
| 4 | 56.2288 | −6.6155E−02 | 2.1388E−02 | −2.2250E−02 | 7.2844E−03 | 2.6238E−09 | −1.9906E−12 |
| 5 | 56.2288 | −1.4473E−01 | 9.8671E−02 | −4.8968E−02 | 1.5996E−02 | 1.6634E−10 | −3.2330E−12 |
| 6 | −1.8767 | −1.4887E−02 | 1.3031E−02 | 5.5654E−02 | −9.9089E−02 | 0.0000E+00 | 0.0000E+00 |
| 7 | 0.4527 | 1.0433E−01 | −1.7960E−01 | 1.2839E−01 | −6.8380E−02 | −4.8765E−12 | −7.1656E−13 |
| 8 | 2.5650 | −1.4605E−01 | 2.1766E−03 | −2.9251E−02 | 4.8900E−02 | 2.0104E−11 | 4.3986E−12 |
| 9 | −13.1448 | 2.0720E−02 | −4.2816E−02 | 4.3296E−02 | −1.3094E−02 | −1.2225E−11 | −3.0361E−12 |
| 10 | −19.0957 | 8.6651E−02 | −2.0583E−02 | 1.5181E−02 | −9.1093E−04 | 5.7829E−10 | 1.5574E−12 |
| 11 | −1.5755 | 2.9450E−02 | 5.3841E−02 | 1.5708E−02 | −2.0297E−03 | 1.4035E−10 | −4.6034E−12 |

FIG. 62 shows spherical aberrations. The horizontal axis of FIG. 62 represents a position at which a ray that travels parallel to the optical axis and enters the imaging optical system intersects with the optical axis. The vertical axis of FIG. 62 represents distance of the above-described ray from the optical axis. The value of distance is normalized by the radius of the aperture. In other words, the value 1 on the vertical axis represents the radius of the aperture. In FIG. 62, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

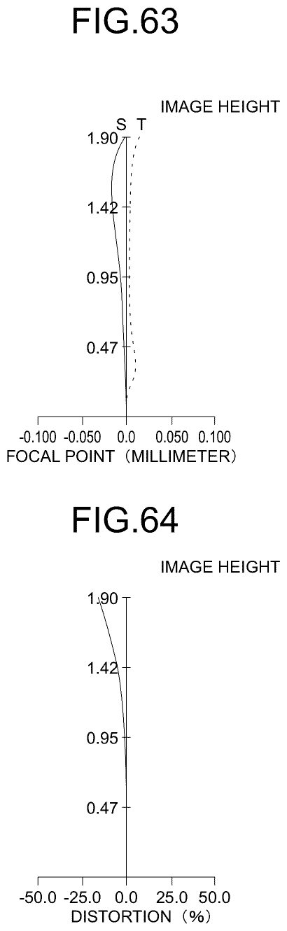

FIG. 63 shows astigmatism of the ray of wavelength of 587.5618 nanometers. The horizontal axis of FIG. 63 represents a position in the optical axis direction of the focal point. The vertical axis of FIG. 63 represents image height. The solid line in FIG. 63 represents the graph of the sagittal plane, and the broken line in FIG. 63 represents the graph of the tangential plane.

FIG. 64 shows distortion of the ray of wavelength of 587.5618 nanometers. The horizontal axis of FIG. 64 represents distortion. The unit is percent. The vertical axis of FIG. 64 represents image height.

### Example 17

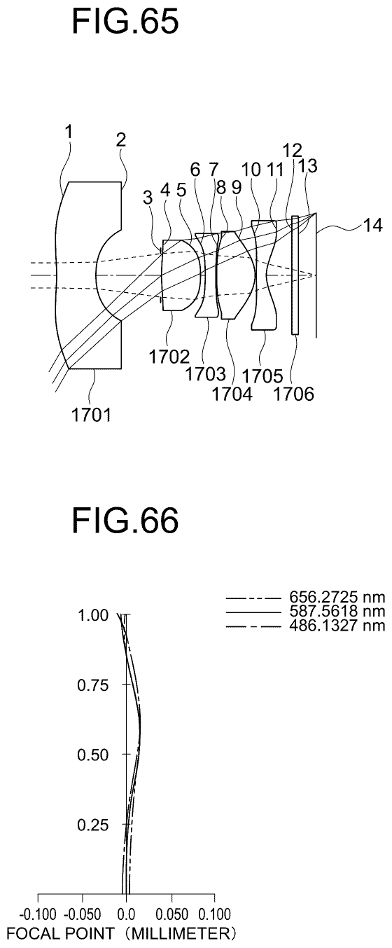

FIG. 65 shows a layout of an imaging optical system of Example 17. The imaging optical system includes five lenses and an infrared cut filter arranged from the object side to the image side. The third lens 1703 is an aspheric lens in which radius of curvature of each of both surfaces is infinity in the paraxial region and which has a power in the peripheral area. The first lens 1701 is a biconcave lens. The second lens 1702 is a biconvex lens. The fourth lens 1704 is a biconvex lens. The fifth lens 1705 is a negative meniscus lens which is convex toward the object. The aperture stop 3 is located between the first lens 1701 and the second lens 1702.

Table 33 shows positions of the optical elements and properties and values of focal length of the lenses of the imaging optical system of Example 17. The focal length f of the whole imaging optical system is given by f=1.55. The F-number Fno is given by Fno=2. HFOV representing a half value of angle of view is given by HFOV=60 (degrees). In Table 33, each of the five lenses is represented respectively by lens 1 to lens 5 from the object side.

In the present example, the object distance from the object to the first lens is infinity.

TABLE 33

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | −5.8565 | 1.200 | Plastic | 1.545 | 56 | −3.262 |
| 2 | | 2.7363 | 2.007 | | | | |
| 3 | Ape. Stop | Plano | 0.034 | | | | |
| 4 | Lens 2 | 3.3238 | 1.199 | Plastic | 1.545 | 56 | 2.98 |
| 5 | | −2.7704 | 0.144 | | | | |
| 6 | Lens 3 | ∞ | 0.300 | Plastic | 1.645 | 23 | ∞ |
| 7 | | ∞ | 0.030 | | | | |
| 8 | Lens 4 | 8.3040 | 1.199 | Plastic | 1.545 | 56 | 1.394 |
| 9 | | 0.7939 | 0.030 | | | | |
| 10 | Lens 5 | 2.7871 | 0.300 | Plastic | 1.645 | 23 | −1.41 |
| 11 | | 0.6568 | 0.798 | | | | |
| 12 | IR cut | Plano | 0.500 | Glass | 1.517 | 64.2 | |
| | filter | | | | | | |
| 13 | | Plano | 0.550 | | | | |
| 14 | Image | Plano | | | | | |

Table 34 shows conic constants and aspheric coefficients of each surface of each lens of Example 17.

TABLE 34

| Surface | K | A4 | A6 | A8 | A10 | A12 | A14 |
|---|---|---|---|---|---|---|---|
| 1 | −90.0000 | 2.3683E−02 | −3.0230E−03 | 1.8374E−04 | 3.3049E−06 | −1.4415E−06 | 6.4576E−08 |
| 2 | 0.7353 | 1.0740E−01 | −1.7952E−02 | 1.1163E−02 | 1.5900E−03 | −2.5554E−03 | 1.6924E−04 |
| 4 | −2.0771 | −8.2513E−02 | −1.3276E−01 | 2.6825E−01 | −5.5734E−01 | 0.0000E+00 | 0.0000E+00 |
| 5 | 4.9311 | −3.0360E−01 | 1.0233E−01 | 4.3446E−02 | −5.0432E−02 | −6.0615E−05 | −1.1237E−04 |
| 6 | −90.0000 | −1.9078E−01 | −2.1202E−02 | 4.1238E−02 | 3.8322E−03 | −1.8074E−03 | 9.4190E−07 |
| 7 | −90.0000 | 1.5694E−01 | −6.9520E−02 | −2.0582E−02 | 5.5314E−03 | 9.5360E−04 | −3.8668E−05 |
| 8 | 30.4139 | 8.1516E−02 | −3.2995E−02 | −4.3439E−03 | −3.2801E−03 | 9.6842E−04 | −7.5342E−06 |
| 9 | −5.6422 | −1.0386E−01 | 2.0671E−02 | 4.1304E−03 | 4.0088E−03 | 1.0830E−04 | 6.7512E−06 |
| 10 | −90.0000 | −1.1233E−01 | 1.2200E−02 | 9.6852E−03 | 6.1476E−05 | −4.9425E−04 | 6.8847E−05 |
| 11 | −6.2476 | −7.0994E−02 | 2.2889E−02 | −6.4327E−03 | 5.2260E−04 | 3.1255E−04 | −8.5887E−05 |

FIG. 66 shows spherical aberrations. The horizontal axis of FIG. 66 represents a position at which a ray that travels parallel to the optical axis and enters the imaging optical system intersects with the optical axis. The vertical axis of FIG. 66 represents distance of the above-described ray from the optical axis. The value of distance is normalized by the radius of the aperture. In other words, the value 1 on the vertical axis represents the radius of the aperture. In FIG. 66, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

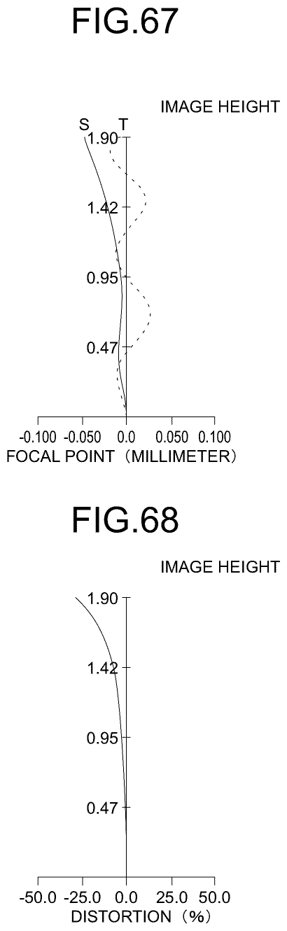

FIG. 67 shows astigmatism of the ray of wavelength of 587.5618 nanometers. The horizontal axis of FIG. 67 represents a position in the optical axis direction of the focal point. The vertical axis of FIG. 67 represents image height. The solid line in FIG. 67 represents the graph of the sagittal plane, and the broken line in FIG. 67 represents the graph of the tangential plane.

FIG. 68 shows distortion of the ray of wavelength of 587.5618 nanometers. The horizontal axis of FIG. 68 represents distortion. The unit is percent. The vertical axis of FIG. 68 represents image height.

### Example 18

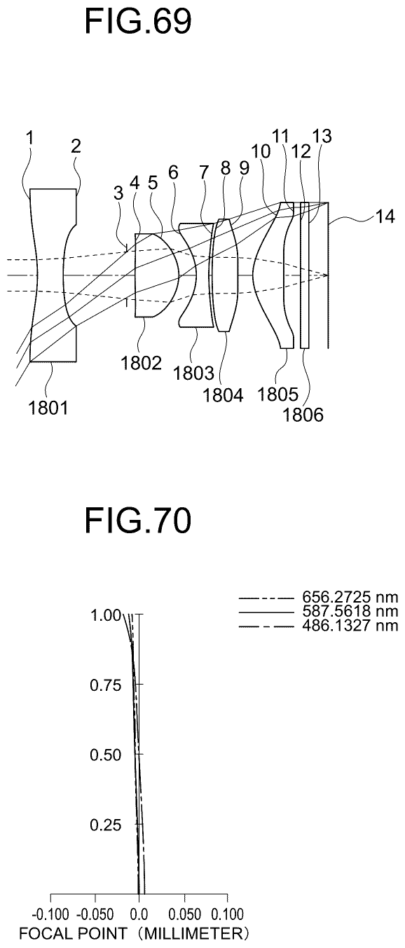

FIG. 69 shows a layout of an imaging optical system of Example 18. The imaging optical system includes five lenses and an infrared cut filter arranged from the object side to the image side. The fourth lens 1804 is an aspheric lens in which radius of curvature of each of both surfaces is infinity in the paraxial region and which has a power in the peripheral area. The first lens 1801 is a biconcave lens. The second lens 1802 is a biconvex lens. The third lens 1803 is a biconcave lens. The fifth lens 1805 is a biconvex lens. The aperture stop 3 is located between the first lens 1801 and the second lens 1802.

Table 35 shows positions of the optical elements and properties and values of focal length of the lenses of the imaging optical system of Example 18. The focal length f of the whole imaging optical system is given by f=1.6. The F-number Fno is given by Fno=2. HFOV representing a half value of angle of view is given by HFOV=60 (degrees). In Table 35, each of the five lenses is represented respectively by lens 1 to lens 5 from the object side.

In the present example, the object distance from the object to the first lens is infinity.

TABLE 35

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | −3.4343 | 0.728 | Plastic | 1.535 | 56 | −4.07 |
| 2 | | 6.3883 | 1.736 | | | | |
| 3 | Ape. | Plano | 0.208 | | | | |
| | Stop | | | | | | |
| 4 | Lens 2 | 4.1069 | 1.200 | Plastic | 1.545 | 56 | 1.623 |
| 5 | | −1.0109 | 0.480 | | | | |
| 6 | Lens 3 | −1.2477 | 0.368 | Plastic | 1.645 | 23 | −1.72 |
| 7 | | 11.1777 | 0.095 | | | | |
| 8 | Lens 4 | ∞ | 0.710 | Plastic | 1.545 | 56 | ∞ |
| 9 | | ∞ | 0.404 | | | | |
| 10 | Lens 5 | 1.3400 | 0.870 | Plastic | 1.545 | 56 | 2.031 |
| 11 | | −4.9039 | 0.440 | | | | |
| 12 | IR cut | Plano | 0.500 | Glass | 1.517 | 64.2 | |
| | filter | | | | | | |
| 13 | | Plano | 0.550 | | | | |
| 14 | Image | Plano | | | | | |

Table 36 shows conic constants and aspheric coefficients of each surface of each lens of Example 18.

TABLE 36

| Surface | K | A4 | A6 | A8 | A10 | A12 | A14 |
|---|---|---|---|---|---|---|---|
| 1 | −17.7525 | 1.4434E−02 | −2.1495E−03 | 7.7962E−05 | 1.1888E−05 | 3.5467E−07 | −2.6371E−08 |
| 2 | 21.4802 | 5.5206E−02 | −2.4357E−02 | 1.4916E−02 | −5.4165E−03 | 5.7491E−04 | 3.8718E−05 |
| 4 | −10.3220 | −7.1398E−02 | −1.1019E−01 | 8.9830E−02 | −3.1480E−01 | 0.0000E+00 | 0.0000E+00 |
| 5 | −0.2643 | 1.3778E−01 | −6.4736E−02 | 1.5652E−02 | 9.4026E−03 | −6.1774E−03 | 2.4407E−09 |
| 6 | −3.8823 | −6.6208E−02 | −2.6227E−02 | 3.3856E−02 | 3.4150E−03 | 2.7071E−06 | 3.8275E−11 |
| 7 | 63.9863 | 4.4551E−02 | −1.5592E−02 | −5.3728E−03 | −6.6682E−04 | 1.8545E−04 | −1.5125E−07 |
| 8 | −90.0000 | 7.6908E−02 | −1.6373E−02 | −5.7571E−04 | −2.0825E−04 | 2.8320E−05 | −3.7056E−06 |
| 9 | −90.0000 | −1.6408E−01 | 3.5443E−02 | 8.0217E−03 | 8.4281E−04 | −5.4806E−04 | 1.9163E−06 |
| 10 | −2.4784 | 1.2719E−02 | −2.8348E−03 | −1.4803E−03 | −2.5329E−04 | 4.6567E−05 | 1.4336E−05 |
| 11 | −12.9810 | 1.4639E−01 | −2.9263E−02 | −1.4918E−03 | 1.6018E−04 | 3.4148E−05 | 5.3126E−06 |

FIG. 70 shows spherical aberrations. The horizontal axis of FIG. 70 represents a position at which a ray that travels parallel to the optical axis and enters the imaging optical system intersects with the optical axis. The vertical axis of FIG. 70 represents distance of the above-described ray from the optical axis. The value of distance is normalized by the radius of the aperture. In other words, the value 1 on the vertical axis represents the radius of the aperture. In FIG. 70, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

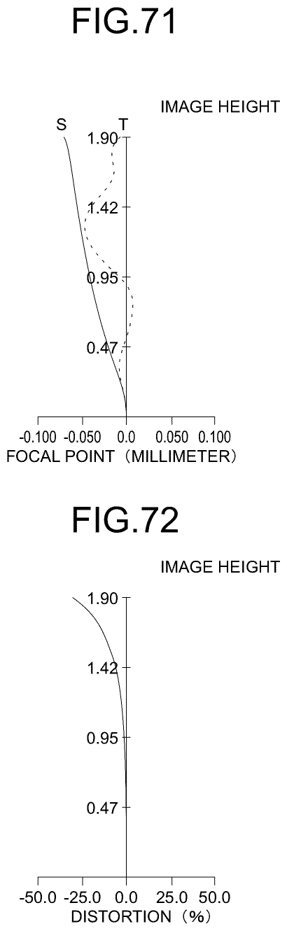

FIG. 71 shows astigmatism of the ray of wavelength of 587.5618 nanometers. The horizontal axis of FIG. 71 represents a position in the optical axis direction of the focal point. The vertical axis of FIG. 71 represents image height. The solid line in FIG. 71 represents the graph of the sagittal plane, and the broken line in FIG. 71 represents the graph of the tangential plane.

FIG. 72 shows distortion of the ray of wavelength of 587.5618 nanometers. The horizontal axis of FIG. 72 represents distortion. The unit is percent. The vertical axis of FIG. 72 represents image height.

### Example 19

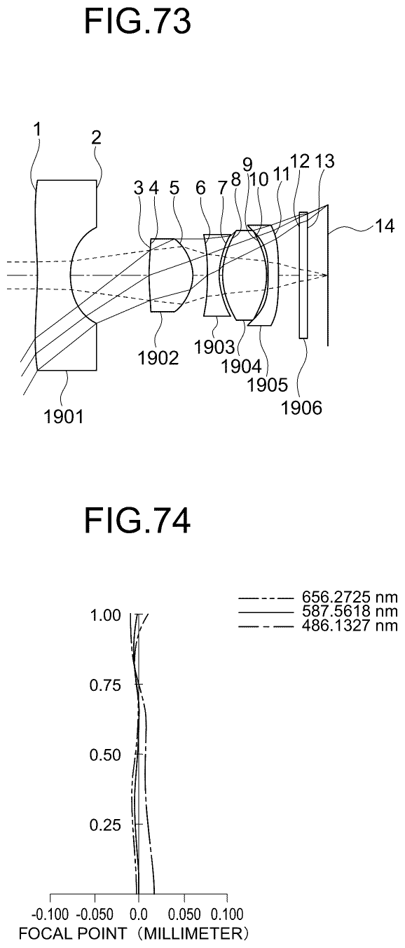

FIG. 73 shows a layout of an imaging optical system of Example 19. The imaging optical system includes five lenses and an infrared cut filter arranged from the object side to the image side. The fifth lens 1905 is an aspheric lens in which radius of curvature of each of both surfaces is infinity in the paraxial region and which has a power in the peripheral area. The first lens 1901 is a biconcave lens. The second lens 1902 is a biconvex lens. The third lens 1903 is a biconcave lens. The fourth lens 1904 is a biconvex lens. The aperture stop 3 is located closer to the object than the object-side surface of the second lens 1902.

Table 37 shows positions of the optical elements and properties and values of focal length of the lenses of the imaging optical system of Example 19. The focal length f of the whole imaging optical system is given by f=1.4. The F-number Fno is given by Fno=2. HFOV representing a half value of angle of view is given by HFOV=60 (degrees). In Table 37, each of the five lenses is represented respectively by lens 1 to lens 5 from the object side.

In the present example, the object distance from the object to the first lens is infinity.

TABLE 37

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | −7.3838 | 0.930 | Plastic | 1.545 | 56 | −2.557 |
| 2 | | 1.7941 | 2.194 | | | | |
| 3 | Ape. | Plano | −0.027 | | | | |
| | Stop | | | | | | |
| 4 | Lens 2 | 3.2782 | 1.200 | Plastic | 1.545 | 56 | 1.589 |
| 5 | | −1.0249 | 0.416 | | | | |
| 6 | Lens 3 | −6.3174 | 0.300 | Plastic | 1.645 | 23 | −1.43 |
| 7 | | 1.1001 | 0.109 | | | | |
| 8 | Lens 4 | 1.6435 | 1.200 | Plastic | 1.545 | 56 | 1.933 |
| 9 | | −2.1794 | 0.030 | | | | |
| 10 | Lens 5 | ∞ | 0.300 | Plastic | 1.645 | 23 | ∞ |
| 11 | | ∞ | 0.588 | | | | |
| 12 | IR cut | Plano | 0.500 | Glass | 1.517 | 64.2 | |
| | filter | | | | | | |
| 13 | | Plano | 0.550 | | | | |
| 14 | Image | Plano | | | | | |

Table 38 shows conic constants and aspheric coefficients of each surface of each lens of Example 19.

TABLE 38

| Surface | K | A4 | A6 | A8 | A10 | A12 | A14 |
|---|---|---|---|---|---|---|---|
| 1 | −90.0000 | −1.0207E−02 | 9.5231E−04 | 2.5930E−05 | −3.5208E−06 | −5.2298E−07 | 4.5176E−08 |
| 2 | −0.6839 | −2.2244E−02 | −1.8222E−02 | −1.7697E−03 | −3.3030E−04 | −3.6308E−06 | −1.1747E−06 |
| 4 | 0.1452 | 3.1763E−02 | 8.8548E−03 | −1.0762E−03 | −2.1196E−04 | −1.1015E−13 | 6.9690E−16 |
| 5 | 90.0000 | 5.8873E−02 | 4.1834E−02 | −1.0676E−02 | 2.4312E−02 | 4.4638E−10 | −1.0169E−11 |
| 6 | −1.5562 | 3.0436E−02 | 1.2059E−02 | −1.2073E−01 | −6.2694E−03 | 0.0000E+00 | 0.0000E+00 |
| 7 | −5.4943 | −1.4743E−01 | −5.9764E−02 | 5.1021E−02 | −2.9446E−02 | 2.2860E−14 | 1.1757E−15 |
| 8 | −4.6226 | 3.5341E−02 | −6.0148E−02 | −3.2539E−02 | 9.0784E−02 | 1.8405E−14 | 7.8387E−16 |
| 9 | −7.4724 | 1.4767E−01 | 2.3129E−02 | −1.2485E−02 | 7.1190E−02 | −5.6997E−12 | 1.1303E−15 |
| 10 | −90.0000 | 4.8492E−02 | −5.3535E−02 | 1.8189E−02 | 4.2188E−03 | −2.0268E−03 | −2.4637E−08 |
| 11 | −90.0000 | 2.4289E−02 | −1.0504E−02 | −3.8614E−03 | 8.8037E−04 | −1.1644E−05 | 8.3137E−08 |

FIG. 74 shows spherical aberrations. The horizontal axis of FIG. 74 represents a position at which a ray that travels parallel to the optical axis and enters the imaging optical system intersects with the optical axis. The vertical axis of FIG. 74 represents distance of the above-described ray from the optical axis. The value of distance is normalized by the radius of the aperture. In other words, the value 1 on the vertical axis represents the radius of the aperture. In FIG. 74, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

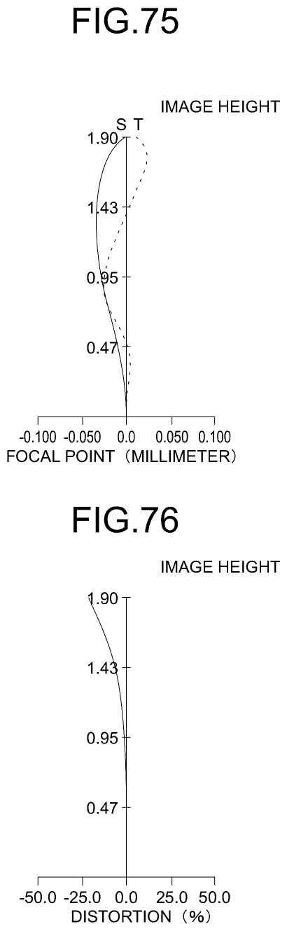

FIG. 75 shows astigmatism of the ray of wavelength of 587.5618 nanometers. The horizontal axis of FIG. 75 represents a position in the optical axis direction of the focal point. The vertical axis of FIG. 75 represents image height. The solid line in FIG. 75 represents the graph of the sagittal plane, and the broken line in FIG. 75 represents the graph of the tangential plane.

FIG. 76 shows distortion of the ray of wavelength of 587.5618 nanometers. The horizontal axis of FIG. 76 represents distortion. The unit is percent. The vertical axis of FIG. 76 represents image height.

### Example 20

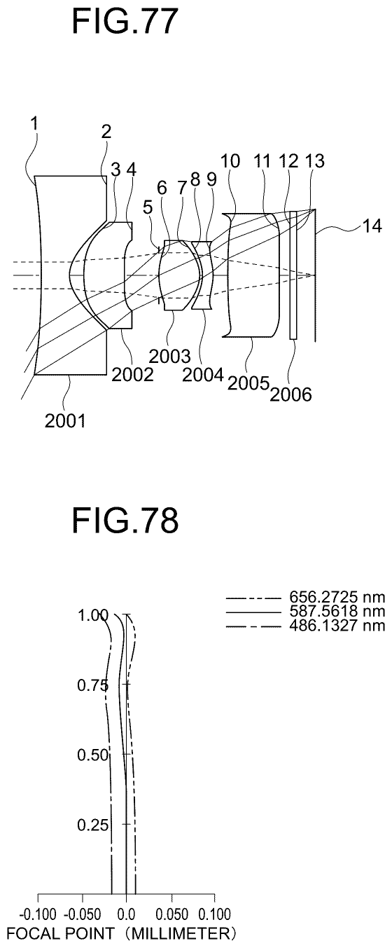

FIG. 77 shows a layout of an imaging optical system of Example 20. The imaging optical system includes five lenses and an infrared cut filter arranged from the object side to the image side. The fifth lens 2005 is an aspheric lens in which radius of curvature of each of both surfaces is infinity in the paraxial region and which has a power in the peripheral area. The first lens 2001 is a negative meniscus lens which is convex toward the object. The second lens 2002 is a positive meniscus lens which is convex toward the object. The third lens 2003 is a biconvex lens. The fourth lens 2004 is a negative meniscus lens which is convex toward the image. The aperture stop 5 is located between the second lens 2002 and the third lens 2003.

Table 39 shows positions of the optical elements and properties and values of focal length of the lenses of the imaging optical system of Example 20. The focal length f of the whole imaging optical system is given by f=1.69. The F-number Fno is given by Fno=2. HFOV representing a half value of angle of view is given by HFOV=60 (degrees). In Table 39, each of the five lenses is represented respectively by lens 1 to lens 5 from the object side.

In the present example, the object distance from the object to the first lens is infinity.

TABLE 39

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 90.0000 | 0.831 | Plastic | 1.545 | 56 | −1.939 |
| 2 | | 1.0413 | 0.398 | | | | |
| 3 | Lens 2 | 2.6261 | 1.199 | Plastic | 1.645 | 23 | 5.167 |
| 4 | | 10.1709 | 0.980 | | | | |
| 5 | Ape. | Plano | 0.027 | | | | |
| | Stop | | | | | | |
| 6 | Lens 3 | 1.7537 | 1.173 | Plastic | 1.545 | 56 | 1.356 |
| 7 | | −0.9761 | 0.105 | | | | |
| 8 | Lens 4 | −0.7664 | 0.300 | Plastic | 1.645 | 23 | −3.812 |
| 9 | | −1.2844 | 0.426 | | | | |
| 10 | Lens 5 | ∞ | 1.500 | Plastic | 1.535 | 56 | ∞ |
| 11 | | ∞ | 0.300 | | | | |
| 12 | IR cut | Plano | 0.500 | Glass | 1.517 | 64.2 | |
| | filter | | | | | | |
| 13 | | Plano | 0.550 | | | | |
| 14 | Image | Plano | | | | | |

Table 40 shows conic constants and aspheric coefficients of each surface of each lens of Example 20.

TABLE 40

| Surface | K | A4 | A6 | A8 | A10 | A12 | A14 |
|---|---|---|---|---|---|---|---|
| 1 | −90.0000 | 1.4022E−02 | −2.1589E−03 | 1.6078E−04 | −3.3578E−05 | 6.7209E−06 | −4.0845E−07 |
| 2 | −0.0777 | 5.0991E−02 | −3.4859E−02 | 3.7447E−02 | −1.5635E−03 | −1.7443E−02 | 6.6831E−03 |
| 4 | −10.5504 | −6.4805E−02 | −1.5919E−01 | 2.9595E−01 | −5.6178E−01 | 0.0000E+00 | 0.0000E+00 |
| 5 | −0.1480 | 2.0895E−01 | −1.7379E−01 | 1.3421E−01 | −3.2192E−02 | 7.2923E−07 | 2.2239E−07 |
| 6 | 33.3000 | −3.2874E−02 | 4.4554E−02 | −2.7515E−02 | 2.2700E−02 | 7.1933E−09 | −3.2419E−09 |
| 7 | −6.8625 | 1.4625E−02 | 2.5747E−05 | 6.4245E−04 | −2.8271E−03 | 1.3692E−04 | 2.7418E−09 |
| 8 | −11.1891 | 6.6853E−02 | 4.6226E−04 | −5.9200E−03 | 3.5794E−03 | 2.2220E−04 | −1.2089E−04 |
| 9 | −5.2796 | −1.3659E−01 | 4.0990E−02 | 1.3003E−02 | 1.4618E−02 | −6.4134E−03 | −4.0579E−05 |
| 10 | −90.0000 | −1.8409E−01 | −1.9550E−02 | −2.9351E−02 | 5.9433E−03 | 2.0842E−02 | −5.6960E−03 |
| 11 | −90.0000 | 2.4665E−02 | −4.6170E−02 | 1.2322E−02 | 2.2999E−03 | −5.3992E−04 | 2.2546E−04 |

FIG. 78 shows spherical aberrations. The horizontal axis of FIG. 78 represents a position at which a ray that travels parallel to the optical axis and enters the imaging optical system intersects with the optical axis. The vertical axis of FIG. 78 represents distance of the above-described ray from the optical axis. The value of distance is normalized by the radius of the aperture. In other words, the value 1 on the vertical axis represents the radius of the aperture. In FIG. 78, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

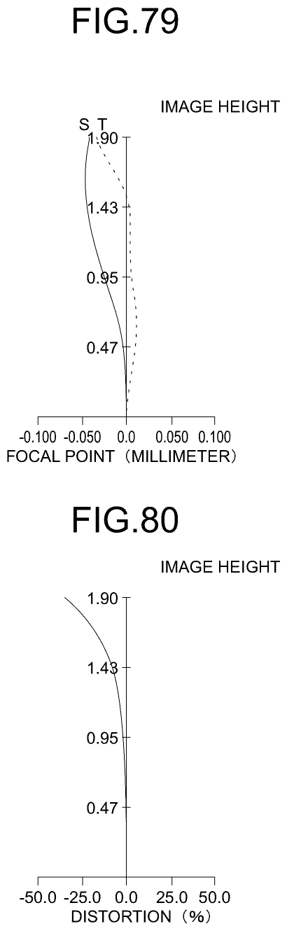

FIG. 79 shows astigmatism of the ray of wavelength of 587.5618 nanometers. The horizontal axis of FIG. 79 represents a position in the optical axis direction of the focal point. The vertical axis of FIG. 79 represents image height. The solid line in FIG. 79 represents the graph of the sagittal plane, and the broken line in FIG. 79 represents the graph of the tangential plane.

FIG. 80 shows distortion of the ray of wavelength of 587.5618 nanometers. The horizontal axis of FIG. 80 represents distortion. The unit is percent. The vertical axis of FIG. 80 represents image height.

### Example 21

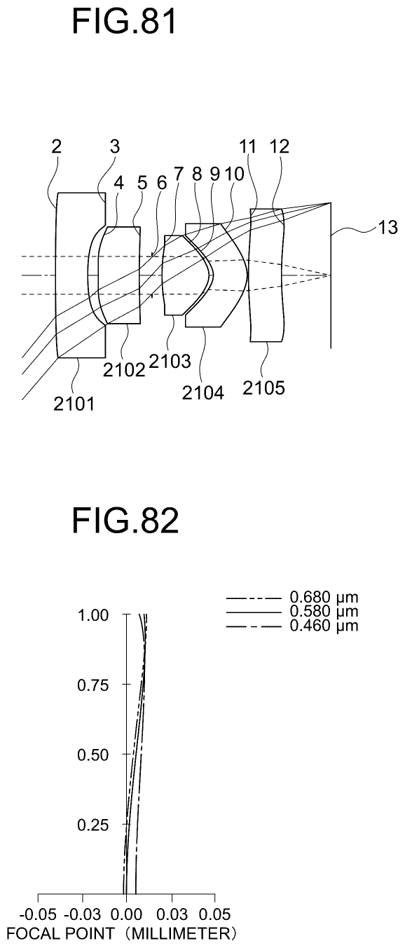

FIG. 81 shows a layout of an imaging optical system of Example 21. The imaging optical system includes five lenses arranged from the object side to the image side. Each of the first lens 2101, the second lens 2102 and the fifth lens 2105 is an aspheric lens in which radius of curvature of each of both surfaces is infinity in the paraxial region and which has a power in the peripheral area. The third lens 2103 is a biconvex lens. The fourth lens 2104 is a negative meniscus lens which is convex toward the image. The aperture stop 6 is located between the second lens 2102 and the third lens 2103.

Table 41 shows positions of the optical elements and properties and values of focal length of the lenses of the imaging optical system of Example 21. The focal length f of the whole imaging optical system is given by f=0.264. The F-number Fno is given by Fno=2.51. HFOV representing a half value of angle of view is given by HFOV=50 (degrees). In Table 41, each of the five lenses is represented respectively by lens 1 to lens 5 from the object side.

In the present example, the object distance from the object to the first lens is infinity.

TABLE 41

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.100 | Plastic | 1.5311 | 55.634 | ∞ |
| 3 | | ∞ | 0.029 | | | | |
| 4 | Lens 2 | ∞ | 0.124 | Plastic | 1.6611 | 20.345 | ∞ |
| 5 | | ∞ | 0.038 | | | | |
| 6 | Ape. | Plano | 0.030 | | | | |
| | Stop | | | | | | |
| 7 | Lens 3 | 0.34242 | 0.142 | Plastic | 1.5311 | 55.634 | 0.102 |
| 8 | | −0.05508 | 0.013 | | | | |
| 9 | Lens 4 | −0.04764 | 0.100 | Plastic | 1.6611 | 20.345 | −0.258 |
| 10 | | −0.12134 | 0.005 | | | | |
| 11 | Lens 5 | ∞ | 0.100 | Plastic | 1.6349 | 23.945 | ∞ |
| 12 | | ∞ | 0.150 | | | | |
| 13 | Image | Plano | 0.000 | | | | |

Table 42 shows conic constants and aspheric coefficients of each surface of each lens of Example 21.

TABLE 42

| Surface | K | A4 | A6 | A8 | A10 | A12 | A14 |
|---|---|---|---|---|---|---|---|
| 2 | 90.0000 | −2.22576E+00 | 6.23522E+01 | 1.53085E+02 | 8.89580E+02 | −8.35882E+03 | −5.91756E+05 |
| 3 | 90.0000 | 1.15995E+02 | −8.46068E+02 | 4.09923E+03 | 9.87895E+04 | −3.67235E+06 | −3.88181E+08 |
| 4 | −74.0000 | 1.16721E+02 | −2.17027E+03 | −7.23916E+03 | −1.25135E+05 | 2.81108E+06 | 2.88505E+08 |
| 5 | 41.0000 | 5.62622E+01 | −3.60024E+03 | 8.07693E+04 | 6.47018E+05 | −5.68949E+08 | 4.93227E+10 |
| 7 | −20.0000 | 2.81690E+01 | −4.39719E+03 | −3.15856E+05 | −6.54472E+06 | 1.84291E+09 | 9.37370E+10 |
| 8 | −1.9876 | 4.49814E+01 | −5.68453E+03 | −6.28784E+04 | −2.81565E+06 | 6.71141E+07 | 3.53324E+10 |
| 9 | −1.7135 | −2.43292E+01 | 2.15889E+03 | 9.12372E+04 | 6.76144E+06 | 1.85898E+08 | −2.34746E+10 |
| 10 | −0.9925 | 3.06889E+00 | 1.63863E+03 | −1.31779E+03 | −3.29863E+05 | −7.15018E+06 | 5.01160E+08 |
| 11 | 90.0000 | 4.43392E+01 | −1.04854E+03 | −3.75104E+02 | 5.62925E+04 | 1.40463E+05 | −2.69067E+08 |
| 12 | 90.0000 | 4.72473E+01 | −1.43463E+03 | −3.96014E+03 | 2.42354E+05 | 3.79666E+06 | −8.96607E+07 |

FIG. 82 shows spherical aberrations. The horizontal axis of FIG. 82 represents a position at which a ray that travels parallel to the optical axis and enters the imaging optical system intersects with the optical axis. The vertical axis of FIG. 82 represents distance of the above-described ray from the optical axis. The value of distance is normalized by the radius of the aperture. In other words, the value 1 on the vertical axis represents the radius of the aperture. In FIG. 82, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

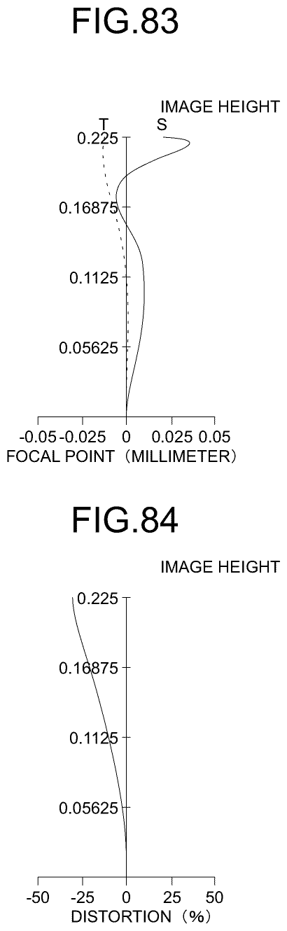

FIG. 83 shows astigmatism of the ray of wavelength of 0.580 micrometers. The horizontal axis of FIG. 83 represents a position in the optical axis direction of the focal point. The vertical axis of FIG. 83 represents image height. The solid line in FIG. 83 represents the graph of the sagittal plane, and the broken line in FIG. 83 represents the graph of the tangential plane.

FIG. 84 shows distortion of the ray of wavelength of 0.580 micrometers. The horizontal axis of FIG. 84 represents distortion. The unit is percent. The vertical axis of FIG. 84 represents image height.

### Example 22

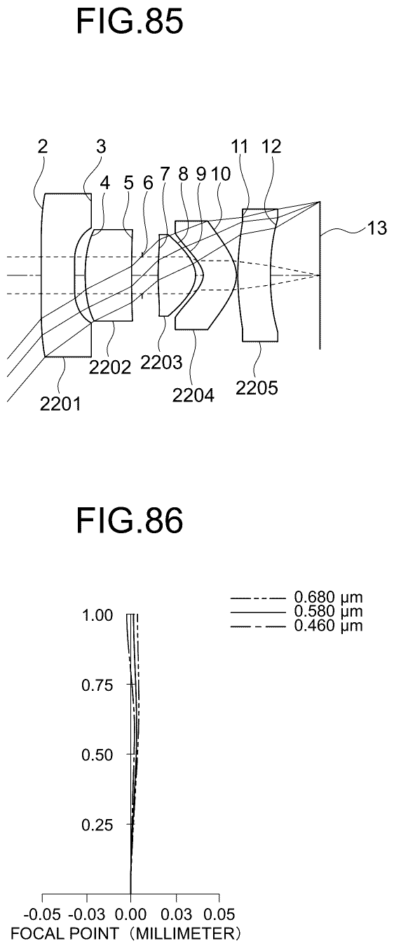

FIG. 85 shows a layout of an imaging optical system of Example 22. The imaging optical system includes five lenses arranged from the object side to the image side. Each of the first lens 2201, the second lens 2202 and the fifth lens 2205 is an aspheric lens in which radius of curvature of each of both surfaces is infinity in the paraxial region and which has a power in the peripheral area. The third lens 2203 is a biconvex lens. The fourth lens 2204 is a negative meniscus lens which is convex toward the image. The aperture stop 6 is located between the second lens 2202 and the third lens 2203.

Table 43 shows positions of the optical elements and properties and values of focal length of the lenses of the imaging optical system of Example 22. The focal length f of the whole imaging optical system is given by f=0.274. The F-number Fno is given by Fno=2.492. HFOV representing a half value of angle of view is given by HFOV=50 (degrees). In Table 43, each of the five lenses is represented respectively by lens 1 to lens 5 from the object side.

In the present example, the object distance from the object to the first lens is 5.242(=5.142+0.100) millimeters. Surface 1 does not correspond to a physical object.

TABLE 43

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.100 | Plastic | 1.5311 | 55.634 | ∞ |
| 3 | | ∞ | 0.034 | | | | |
| 4 | Lens 2 | ∞ | 0.139 | Plastic | 1.6611 | 20.345 | ∞ |
| 5 | | ∞ | 0.032 | | | | |
| 6 | Ape. | Plano | 0.047 | | | | |
| | Stop | | | | | | |
| 7 | Lens 3 | 0.34976 | 0.115 | Plastic | 1.5311 | 55.634 | 0.119 |
| 8 | | −0.06848 | 0.022 | | | | |
| 9 | Lens 4 | −0.05359 | 0.100 | Plastic | 1.6611 | 20.345 | −0.351 |
| 10 | | −0.12143 | 0.005 | | | | |
| 11 | Lens 5 | ∞ | 0.100 | Plastic | 1.6349 | 23.945 | ∞ |
| 12 | | ∞ | 0.150 | | | | |
| 13 | Image | Plano | 0.000 | | | | |

Table 44 shows conic constants and aspheric coefficients of each surface of each lens of Example 22.

TABLE 44

| Surface | K | A4 | A6 | A8 | A10 | A12 | A14 |
|---|---|---|---|---|---|---|---|
| 2 | 90.0000 | −9.94989E−01 | 5.89691E+01 | 1.01478E+02 | 4.25077E+02 | −9.02010E+03 | −4.33808E+05 |
| 3 | 90.0000 | 1.13049E+02 | 3.32982E+01 | 9.19805E+02 | 1.19988E+05 | −3.81374E+06 | −4.61293E+08 |
| 4 | −74.0000 | 1.19971E+02 | −2.43506E+03 | −1.09873E+04 | −1.74088E+05 | 4.62907E+06 | 6.01070E+08 |
| 5 | 41.0000 | 6.65036E+01 | −4.91397E+03 | −4.69611E+04 | 2.81649E+06 | 8.56024E+08 | 2.25028E+11 |
| 7 | −20.0000 | 2.46110E+01 | −4.07461E+03 | −3.27892E+05 | −9.95296E+06 | 1.51382E+09 | 3.12358E+10 |
| 8 | −1.9876 | 4.17064E+01 | −6.08499E+03 | −7.03565E+04 | −2.86170E+06 | 2.83848E+07 | 2.45611E+10 |
| 9 | −1.7135 | −2.52905E+01 | 2.20873E+03 | 9.42261E+04 | 6.89039E+06 | 1.71583E+08 | −2.66182E+10 |
| 10 | −0.9925 | 6.88180E+00 | 1.64012E+03 | −9.60759E+02 | −3.48523E+05 | −1.10789E+07 | 1.23385E+08 |
| 11 | 90.0000 | 4.76782E+01 | −7.13490E+02 | −5.69256E+03 | −4.52837E+04 | 1.59139E+06 | −1.28067E+08 |
| 12 | 90.0000 | 6.69547E+01 | −1.73837E+03 | −1.58527E+02 | 3.28859E+05 | 3.75890E+06 | −1.40394E+08 |

FIG. 86 shows spherical aberrations. The horizontal axis of FIG. 86 represents a position at which a ray that travels parallel to the optical axis and enters the imaging optical system intersects with the optical axis. The vertical axis of FIG. 86 represents distance of the above-described ray from the optical axis. The value of distance is normalized by the radius of the aperture. In other words, the value 1 on the vertical axis represents the radius of the aperture. In FIG. 86, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

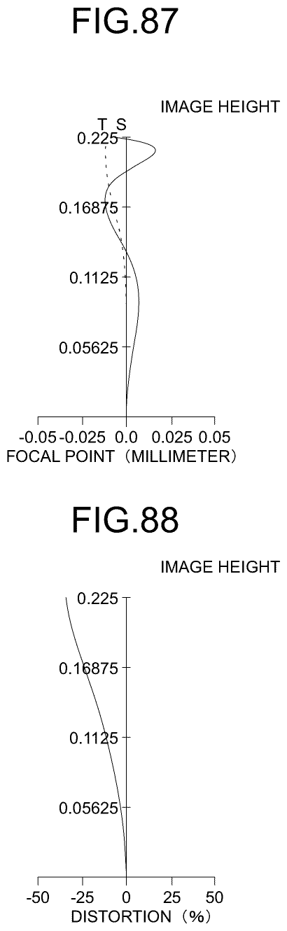

FIG. 87 shows astigmatism of the ray of wavelength of 0.580 micrometers. The horizontal axis of FIG. 87 represents a position in the optical axis direction of the focal point. The vertical axis of FIG. 87 represents image height. The solid line in FIG. 87 represents the graph of the sagittal plane, and the broken line in FIG. 87 represents the graph of the tangential plane.

FIG. 88 shows distortion of the ray of wavelength of 0.580 micrometers. The horizontal axis of FIG. 88 represents distortion. The unit is percent. The vertical axis of FIG. 88 represents image height.

### Example 23

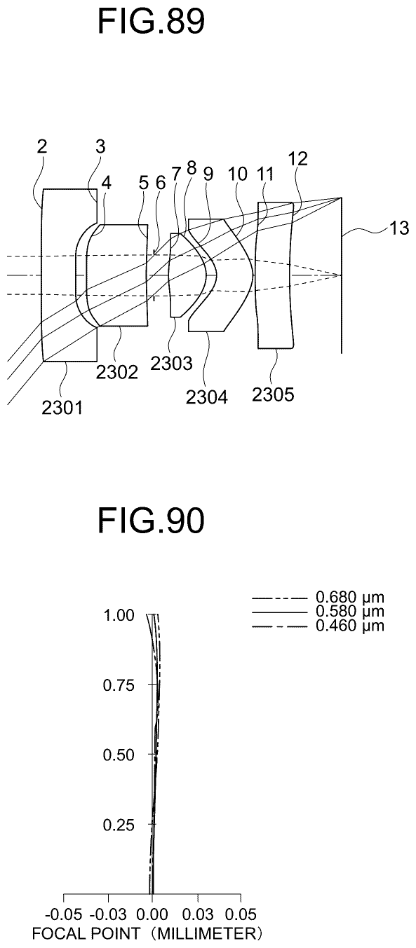

FIG. 89 shows a layout of an imaging optical system of Example 23. The imaging optical system includes five lenses arranged from the object side to the image side. Each of the first lens 2301, the second lens 2302 and the fifth lens 2305 is an aspheric lens in which radius of curvature of each of both surfaces is infinity in the paraxial region and which has a power in the peripheral area. The third lens 2303 is a biconvex lens. The fourth lens 2304 is a negative meniscus lens which is convex toward the image. The aperture stop 6 is located between the second lens 2302 and the third lens 2303.

Table 45 shows positions of the optical elements and properties and values of focal length of the lenses of the imaging optical system of Example 23. The focal length f of the whole imaging optical system is given by f=0.278. The F-number Fno is given by Fno=2.458. HFOV representing a half value of angle of view is given by HFOV=50 (degrees). In Table 45 each of the five lenses is represented respectively by lens 1 to lens 5 from the object side.

In the present example, the object distance from the object to the first lens is 5.242(=5.142+0.100) millimeters. Surface 1 does not correspond to a physical object.

TABLE 45

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.100 | Plastic | 1.5311 | 55.634 | ∞ |
| 3 | | ∞ | 0.032 | | | | |
| 4 | Lens 2 | ∞ | 0.172 | Plastic | 1.6611 | 20.345 | ∞ |
| 5 | | ∞ | 0.022 | | | | |
| 6 | Ape. | Plano | 0.043 | | | | |
| | Stop | | | | | | |
| 7 | Lens 3 | 0.41199 | 0.108 | Plastic | 1.5311 | 55.634 | 0.135 |
| 8 | | −0.07936 | 0.028 | | | | |
| 9 | Lens 4 | −0.05864 | 0.105 | Plastic | 1.6611 | 20.345 | −0.600 |
| 10 | | −0.11796 | 0.008 | | | | |
| 11 | Lens 5 | ∞ | 0.100 | Plastic | 1.6349 | 23.945 | ∞ |
| 12 | | ∞ | 0.150 | | | | |
| 13 | Image | Plano | 0.000 | | | | |

Table 46 shows conic constants and aspheric coefficients of each surface of each lens of Example 23.

TABLE 46

| Surface | K | A4 | A6 | A8 | A10 | A12 | A14 |
|---|---|---|---|---|---|---|---|
| 2 | 90.0000 | −9.70170E−01 | 3.86860E+01 | 9.74997E+01 | 3.59273E+02 | −1.01841E+04 | −4.70317E+05 |
| 3 | 90.0000 | 8.75567E+01 | 1.49643E+03 | −3.60693E+03 | 4.88479E+03 | −5.70712E+06 | −5.40166E+08 |
| 4 | −74.0000 | 1.01305E+02 | −9.60315E+02 | −1.23580E+04 | −1.75144E+05 | 6.42017E+06 | 7.12585E+08 |
| 5 | 41.0000 | 7.70464E+01 | −6.49073E+03 | −1.14975E+05 | 5.28758E+07 | 8.83493E+09 | −4.04033E+11 |
| 7 | −20.0000 | 2.81446E+01 | −3.56635E+03 | −3.02628E+05 | −8.82061E+06 | 1.54402E+09 | 1.30138E+10 |
| 8 | −1.9876 | 3.96451E+01 | −6.03641E+03 | −4.91808E+04 | −1.21510E+06 | 6.44120E+07 | 1.52226E+10 |
| 9 | −1.7135 | −2.59508E+01 | 2.15044E+03 | 9.06093E+04 | 6.95423E+06 | 1.94503E+08 | −2.66989E+10 |
| 10 | −0.9925 | 7.40086E+00 | 1.64959E+03 | 2.62202E+01 | −2.94239E+05 | −8.73012E+06 | 2.24069E+08 |
| 11 | 90.0000 | 3.01210E+01 | −3.00615E+02 | −5.84241E+03 | −4.67634E+04 | 1.93889E+06 | −9.94612E+07 |
| 12 | 90.0000 | 4.45533E+01 | −1.37479E+03 | −1.53551E+02 | 3.31391E+05 | 3.77831E+06 | −1.42171E+08 |

FIG. 90 shows spherical aberrations. The horizontal axis of FIG. 90 represents a position at which a ray that travels parallel to the optical axis and enters the imaging optical system intersects with the optical axis. The vertical axis of FIG. 90 represents distance of the above-described ray from the optical axis. The value of distance is normalized by the radius of the aperture. In other words, the value 1 on the vertical axis represents the radius of the aperture. In FIG. 90, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

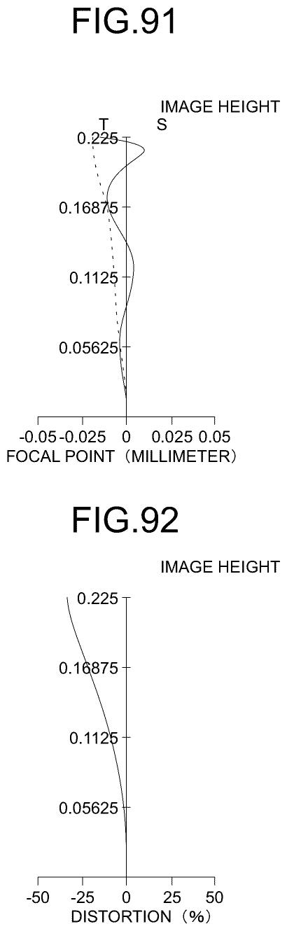

FIG. 91 shows astigmatism of the ray of wavelength of 0.580 micrometers. The horizontal axis of FIG. 91 represents a position in the optical axis direction of the focal point. The vertical axis of FIG. 91 represents image height. The solid line in FIG. 91 represents the graph of the sagittal plane, and the broken line in FIG. 91 represents the graph of the tangential plane.

FIG. 92 shows distortion of the ray of wavelength of 0.580 micrometers. The horizontal axis of FIG. 92 represents distortion. The unit is percent. The vertical axis of FIG. 92 represents image height.

### Example 24

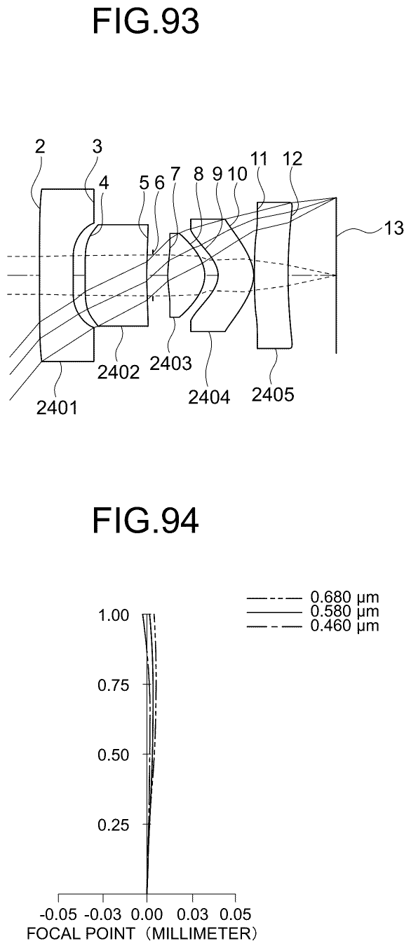

FIG. 93 shows a layout of an imaging optical system of Example 24. The imaging optical system includes five lenses arranged from the object side to the image side. Each of the first lens 2401, the second lens 2402 and the fifth lens 2405 is an aspheric lens in which radius of curvature of each of both surfaces is infinity in the paraxial region and which has a power in the peripheral area. The third lens 2403 is a biconvex lens. The fourth lens 2404 is a negative meniscus lens which is convex toward the image. The aperture stop 6 is located between the second lens 2402 and the third lens 2403.

Table 47 shows positions of the optical elements and properties and values of focal length of the lenses of the imaging optical system of Example 24. The focal length f of the whole imaging optical system is given by f=0.277. The F-number Fno is given by Fno=2.458. HFOV representing a half value of angle of view is given by HFOV=50 (degrees). In Table 47 each of the five lenses is represented respectively by lens 1 to lens 5 from the object side.

In the present example, the object distance from the object to the first lens is 5.242(=5.142+0.100) millimeters. Surface 1 does not correspond to a physical object.

TABLE 47

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | ∞ | 0.100 | Plastic | 1.5311 | 55.634 | ∞ |
| 3 | | ∞ | 0.031 | | | | |
| 4 | Lens 2 | ∞ | 0.181 | Plastic | 1.6611 | 20.345 | ∞ |
| 5 | | ∞ | 0.017 | | | | |
| 6 | Ape. | Plano | 0.040 | | | | |
| | Stop | | | | | | |
| 7 | Lens 3 | 0.42293 | 0.110 | Plastic | 1.5311 | 55.634 | 0.149 |
| 8 | | −0.08889 | 0.037 | | | | |
| 9 | Lens 4 | −0.06272 | 0.101 | Plastic | 1.6611 | 20.345 | −0.871 |
| 10 | | −0.11563 | 0.001 | | | | |
| 11 | Lens 5 | ∞ | 0.100 | Plastic | 1.6349 | 23.945 | ∞ |
| 12 | | ∞ | 0.140 | | | | |
| 13 | Image | Plano | 0.000 | | | | |

Table 48 shows conic constants and aspheric coefficients of each surface of each lens of Example 24.

TABLE 48

| Surface | K | A4 | A6 | A8 | A10 | A12 | A14 |
|---|---|---|---|---|---|---|---|
| 2 | 90.0000 | −1.37641E+00 | 3.71943E+01 | 1.07128E+02 | 6.59359E+02 | −6.66303E+03 | −5.29998E+05 |
| 3 | 90.0000 | 8.86599E+01 | 1.39340E+03 | −1.08550E+04 | −1.34802E+05 | −5.78030E+06 | −4.66440E+08 |
| 4 | −74.0000 | 9.91857E+01 | −9.82524E+02 | −1.11847E+04 | −9.61220E+04 | 6.70346E+06 | 4.97436E+08 |
| 5 | 41.0000 | 8.54878E+01 | −7.65320E+03 | 1.22655E+05 | 1.11775E+08 | −3.64873E+08 | 1.25889E+11 |
| 7 | −18.7258 | 3.24205E+01 | −2.95426E+03 | −2.65481E+05 | −6.81859E+06 | 1.46341E+09 | −1.10268E+10 |
| 8 | −1.8705 | 3.52866E+01 | −6.04501E+03 | −2.40640E+04 | 5.81010E+05 | 7.35222E+07 | 1.93656E+09 |
| 9 | −1.6388 | −2.72723E+01 | 2.07233E+03 | 8.54095E+04 | 6.95416E+06 | 2.16757E+08 | −2.58342E+10 |
| 10 | −1.0178 | 7.86476E+00 | 1.64494E+03 | 1.17276E+03 | −2.07317E+05 | −4.09184E+06 | 4.70018E+08 |
| 11 | 90.0000 | 3.14198E+01 | −3.16579E+02 | −6.31997E+03 | −4.91771E+04 | 2.48269E+06 | −7.00164E+07 |
| 12 | 90.0000 | 4.31251E+01 | −1.36551E+03 | 1.70746E+02 | 3.41192E+05 | 3.87243E+06 | −1.45233E+08 |

FIG. 94 shows spherical aberrations. The horizontal axis of FIG. 94 represents a position at which a ray that travels parallel to the optical axis and enters the imaging optical system intersects with the optical axis. The vertical axis of FIG. 94 represents distance of the above-described ray from the optical axis. The value of distance is normalized by the radius of the aperture. In other words, the value 1 on the vertical axis represents the radius of the aperture. In FIG. 94, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

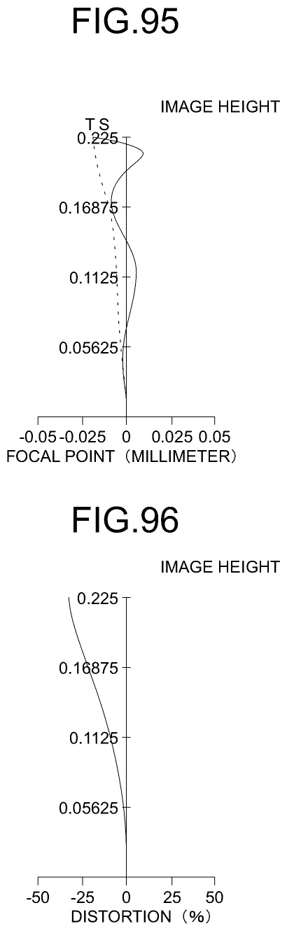

FIG. 95 shows astigmatism of the ray of wavelength of 0.580 micrometers. The horizontal axis of FIG. 95 represents a position in the optical axis direction of the focal point. The vertical axis of FIG. 95 represents image height. The solid line in FIG. 95 represents the graph of the sagittal plane, and the broken line in FIG. 95 represents the graph of the tangential plane.

FIG. 96 shows distortion of the ray of wavelength of 0.580 micrometers. The horizontal axis of FIG. 96 represents distortion. The unit is percent. The vertical axis of FIG. 96 represents image height.

### Example 25

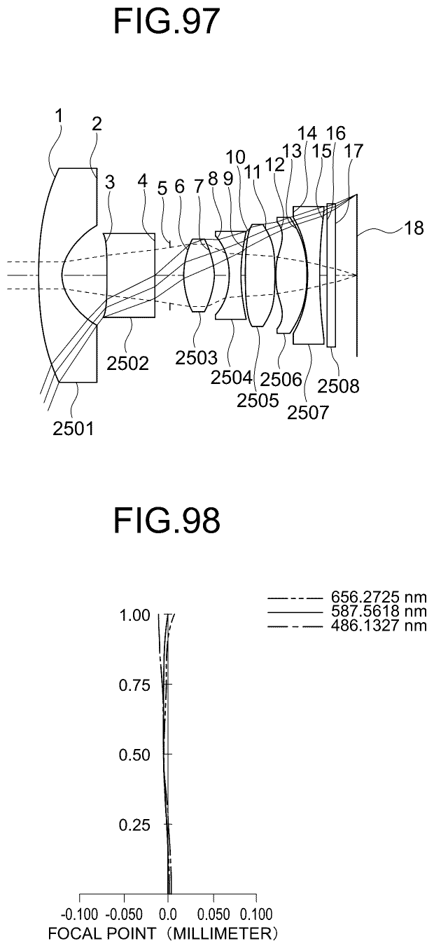

FIG. 97 shows a layout of an imaging optical system of Example 25. The imaging optical system includes seven lenses and an infrared cut filter arranged from the object side to the image side. Each of the second lens 2502, the fifth lens 2505 and the seventh lens 2507 is an aspheric lens in which radius of curvature of each of both surfaces is infinity in the paraxial region and which has a power in the peripheral area. The first lens 2501 is a negative meniscus lens which is convex toward the object. The third lens 2503 is a biconvex lens. The fourth lens 2504 is a biconcave lens. The sixth lens 2506 is a biconvex lens. The aperture stop 5 is located between the second lens 2502 and the third lens 2503.

Table 49 shows positions of the optical elements and properties and values of focal length of the lenses of the imaging optical system of Example 25. The focal length f of the whole imaging optical system is given by f=1.121. The F-number Fno is given by Fno=1.8. HFOV representing a half value of angle of view is given by HFOV=70 (degrees). In Table 49 each of the seven lenses is represented respectively by lens 1 to lens 7 from the object side.

In the present example, the object distance from the object to the first lens is infinity.

TABLE 49

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 8.8325 | 0.600 | Plastic | 1.545 | 56 | −2.031 |
| 2 | | 0.9602 | 1.109 | | | | |
| 3 | Lens 2 | ∞ | 1.200 | Plastic | 1.645 | 23 | ∞ |
| 4 | | ∞ | 0.377 | | | | |
| 5 | Ape. | Plano | 0.348 | | | | |
| | Stop | | | | | | |
| 6 | Lens 3 | 1.6386 | 0.777 | Plastic | 1.545 | 56 | 1.431 |
| 7 | | −1.2393 | 0.371 | | | | |
| 8 | Lens 4 | −1.7278 | 0.300 | Plastic | 1.645 | 23 | −1.816 |
| 9 | | 3.8810 | 0.112 | | | | |
| 10 | Lens 5 | ∞ | 0.741 | Plastic | 1.545 | 56 | ∞ |
| 11 | | ∞ | 0.030 | | | | |
| 12 | Lens 6 | 1.3703 | 0.762 | Plastic | 1.545 | 56 | 2.298 |
| 13 | | −11.6812 | 0.030 | | | | |
| 14 | Lens 7 | ∞ | 0.300 | Plastic | 1.645 | 23 | ∞ |
| 15 | | ∞ | 0.183 | | | | |
| 16 | IR cut | Plano | 0.210 | Glass | 1.517 | 64.2 | |
| | filter | | | | | | |
| 17 | | Plano | 0.550 | | | | |
| 18 | Image | Plano | | | | | |

Table 50 shows conic constants and aspheric coefficients of each surface of each lens of Example 25.

TABLE 50

| Surface | K | A4 | A6 | A8 | A10 | A12 | A14 |
|---|---|---|---|---|---|---|---|
| 1 | −62.1851 | 1.1578E−02 | −1.7482E−03 | 1.4338E−04 | 1.2043E−05 | −2.9993E−06 | 1.9193E−07 |
| 2 | −0.8595 | 2.7584E−02 | −1.2104E−03 | 9.3217E−03 | −7.8443E−03 | −7.2914E−12 | 6.8248E−14 |
| 3 | 90.0000 | −6.6194E−02 | −3.3047E−02 | 2.4922E−02 | −2.8086E−03 | −3.6288E−10 | 3.8723E−11 |
| 4 | 90.0000 | −5.0447E−02 | 5.2246E−02 | −2.4305E−02 | 7.7680E−02 | 6.3161E−07 | −1.2222E−07 |
| 6 | 0.6247 | −5.7843E−02 | −2.2039E−03 | −1.5732E−03 | −3.5953E−03 | 0.0000E+00 | 0.0000E+00 |
| 7 | −1.0993 | 1.2624E−01 | −1.3191E−01 | 9.1858E−02 | −1.8369E−02 | 2.3023E−17 | −1.9789E−17 |
| 8 | 1.3775 | 3.7533E−02 | −9.7942E−02 | 1.8567E−02 | 7.2124E−02 | −1.0038E−17 | 1.9153E−16 |
| 9 | −87.1420 | 2.8680E−02 | 7.0359E−03 | −4.5752E−03 | 5.4945E−04 | −3.9845E−14 | 3.4170E−20 |
| 10 | −90.0000 | 7.6187E−02 | −4.4773E−03 | −1.9230E−03 | 9.2948E−04 | 6.6470E−16 | −1.7949E−17 |
| 11 | 90.0000 | −2.6213E−01 | 6.2158E−02 | 1.0068E−02 | 1.8447E−03 | −8.5952E−10 | 9.1092E−17 |
| 12 | −5.1094 | −6.8876E−02 | −1.4034E−02 | −2.5598E−02 | 8.0676E−03 | −4.0758E−15 | −1.8176E−18 |
| 13 | 25.1787 | −2.7162E−01 | 1.4226E−01 | −1.2974E−02 | −5.6001E−03 | 5.1584E−15 | 8.8842E−18 |
| 14 | 90.0000 | −3.4083E−01 | 1.6127E−01 | 9.8832E−03 | −1.3727E−02 | −7.9999E−15 | −7.5851E−18 |
| 15 | −90.0000 | 7.2680E−02 | −4.5030E−02 | 1.4669E−02 | −2.2568E−03 | 3.7270E−14 | 9.1726E−17 |

FIG. 98 shows spherical aberrations. The horizontal axis of FIG. 98 represents a position at which a ray that travels parallel to the optical axis and enters the imaging optical system intersects with the optical axis. The vertical axis of FIG. 98 represents distance of the above-described ray from the optical axis. The value of distance is normalized by the radius of the aperture. In other words, the value 1 on the vertical axis represents the radius of the aperture. In FIG. 98, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

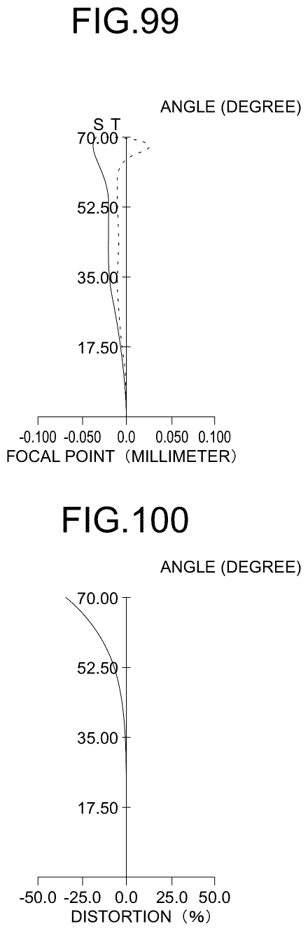

FIG. 99 shows astigmatism of the ray of wavelength of 587.5618 nanometers. The horizontal axis of FIG. 99 represents a position in the optical axis direction of the focal point. The vertical axis of FIG. 99 represents angle that a ray forms with the optical axis. The solid line in FIG. 99 represents the graph of the sagittal plane, and the broken line in FIG. 99 represents the graph of the tangential plane.

FIG. 100 shows distortion of the ray of wavelength of 587.5618 nanometers. The horizontal axis of FIG. 100 represents distortion. The unit is percent. The vertical axis of FIG. 100 represents angle that a ray forms with the optical axis.

### Example 26

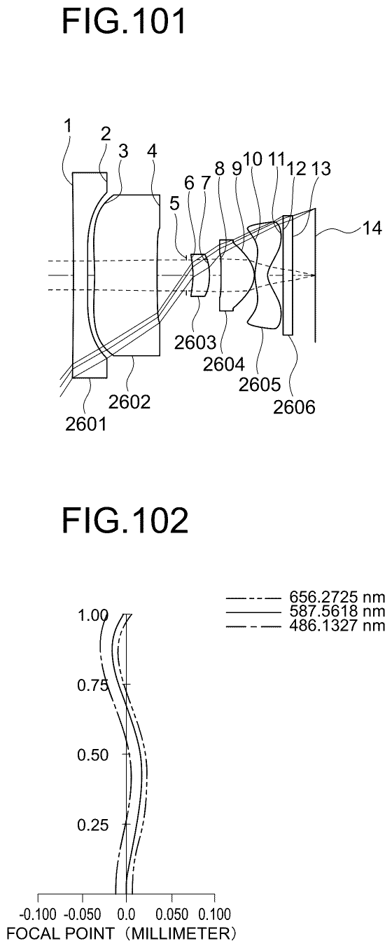

FIG. 101 shows a layout of an imaging optical system of Example 26. The imaging optical system includes five lenses and an infrared cut filter arranged from the object side to the image side. The first lens 2601 is an aspheric lens in which radius of curvature of each of both surfaces is infinity in the paraxial region and which has a power in the peripheral area. The second lens 2602 is a negative meniscus lens which is convex toward the image. The third lens 2603 is a biconvex lens. The fourth lens 2604 is a positive meniscus lens which is convex toward the image. The fifth lens 2605 is a negative meniscus lens which is convex toward the object. The aperture stop 5 is located between the second lens 2602 and the third lens 263.

Table 51 shows positions of the optical elements and properties and values of focal length of the lenses of the imaging optical system of Example 26. The focal length f of the whole imaging optical system is given by f=1.68. The F-number Fno is given by Fno=2. HFOV representing a half value of angle of view is given by HFOV=60 (degrees). In Table 51 each of the five lenses is represented respectively by lens 1 to lens 5 from the object side.

In the present example, the object distance from the object to the first lens is infinity.

TABLE 51

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | ∞ | 0.349 | Plastic | 1.535 | 56 | ∞ |
| 2 | | ∞ | 0.162 | | | | |
| 3 | Lens 2 | −11.0207 | 1.500 | Plastic | 1.645 | 23 | −36.205 |
| 4 | | −21.9839 | 0.707 | | | | |
| 5 | Ape. | Plano | 0.146 | | | | |
| | Stop | | | | | | |
| 6 | Lens 3 | 90.0000 | 0.413 | Plastic | 1.545 | 56 | 4.847 |
| 7 | | −2.7170 | 0.276 | | | | |
| 8 | Lens 4 | −90.0000 | 0.786 | Plastic | 1.545 | 56 | 1.441 |
| 9 | | −0.7808 | 0.030 | | | | |
| 10 | Lens 5 | 1.0213 | 0.321 | Plastic | 1.645 | 23 | −1.984 |
| 11 | | 0.4980 | 0.364 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 52 shows conic constants and aspheric coefficients of each surface of each lens of Example 26.

TABLE 52

| Surface | K | A4 | A6 | A8 | A10 | A12 | A14 |
|---|---|---|---|---|---|---|---|
| 1 | −90.0000 | −6.9421E−05 | 5.4176E−06 | −1.7155E−08 | −6.3514E−10 | 2.5690E−11 | 8.6148E−13 |
| 2 | −90.0000 | 1.6774E−02 | −1.9926E−04 | −2.3671E−05 | −1.5105E−07 | 6.1920E−09 | 5.7725E−10 |
| 4 | 19.4646 | 3.7447E−02 | −6.7602E−03 | 1.8804E−03 | −2.1067E−04 | −6.7450E−08 | 1.7032E−06 |
| 5 | 42.1039 | 3.6939E−02 | −1.1820E−03 | −2.4221E−03 | 5.5674E−04 | 2.5456E−08 | 2.6071E−11 |
| 6 | 90.0000 | −3.3361E−01 | −5.2116E−01 | 1.4333E+00 | −8.9413E+00 | 0.0000E+00 | 0.0000E+00 |
| 7 | −75.0131 | −6.8534E−01 | 4.0029E−01 | −3.3535E−01 | −1.2449E+00 | −1.0724E−09 | −5.0522E−12 |
| 8 | −90.0000 | 4.6505E−02 | −7.4567E−01 | 1.1307E+00 | −4.3636E−01 | −2.2796E−10 | 8.2887E−11 |
| 9 | −1.2609 | 1.7910E−01 | −3.8024E−01 | 1.9266E−01 | 8.3726E−02 | 5.5889E−07 | −5.7100E−11 |
| 10 | −8.6118 | −3.6102E−01 | −1.3218E−01 | 5.5871E−01 | −4.0511E−01 | 9.3666E−02 | 4.1621E−04 |
| 11 | −3.2615 | −3.4608E−01 | 2.6230E−01 | −1.1036E−01 | 2.0355E−02 | −1.2958E−03 | 1.8258E−08 |

FIG. 102 shows spherical aberrations. The horizontal axis of FIG. 102 represents a position at which a ray that travels parallel to the optical axis and enters the imaging optical system intersects with the optical axis. The vertical axis of FIG. 102 represents distance of the above-described ray from the optical axis. The value of distance is normalized by the radius of the aperture. In other words, the value 1 on the vertical axis represents the radius of the aperture. In FIG. 102, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

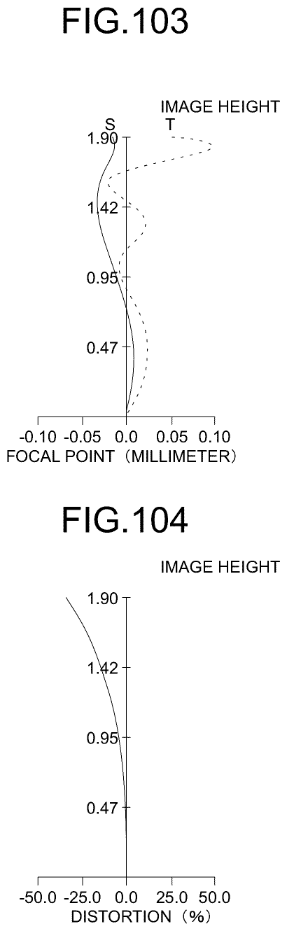

FIG. 103 shows astigmatism of the ray of wavelength of 587.5618 nanometers. The horizontal axis of FIG. 103 represents a position in the optical axis direction of the focal point. The vertical axis of FIG. 103 represents image height. The solid line in FIG. 103 represents the graph of the sagittal plane, and the broken line in FIG. 103 represents the graph of the tangential plane.

FIG. 104 shows distortion of the ray of wavelength of 587.5618 nanometers. The horizontal axis of FIG. 104 represents distortion. The unit is percent. The vertical axis of FIG. 104 represents image height.

### Example 27

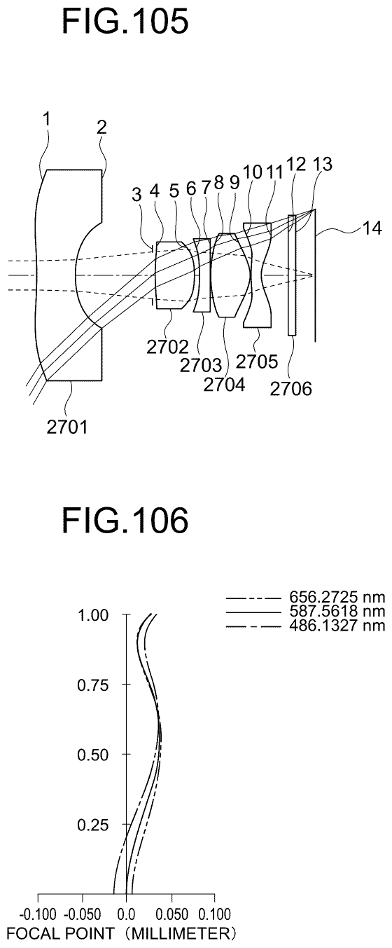

FIG. 105 shows a layout of an imaging optical system of Example 27. The imaging optical system includes five lenses and an infrared cut filter arranged from the object side to the image side. The third lens 2703 is an aspheric lens in which radius of curvature of each of both surfaces is infinity in the paraxial region and which has a power in the peripheral area. The first lens 2701 is a biconcave lens. The second lens 2702 is a biconvex lens. The fourth lens 2704 is a biconvex lens. The fifth lens 2705 is a negative meniscus lens which is convex toward the object. The aperture stop 3 is located between the first lens 2701 and the second lens 2702.

Table 53 shows positions of the optical elements and properties and values of focal length of the lenses of the imaging optical system of Example 27. The focal length f of the whole imaging optical system is given by f=1.593. The F-number Fno is given by Fno=2. HFOV representing a half value of angle of view is given by HFOV=60 (degrees). In Table 53 each of the five lenses is represented respectively by lens 1 to lens 5 from the object side.

In the present example, the object distance from the object to the first lens is infinity.

TABLE 53

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | −7.3474 | 1.119 | Plastic | 1.535 | 56 | −3.907 |
| 2 | | 3.0785 | 2.218 | | | | |
| 3 | Ape. Stop | Plano | 0.068 | | | | |
| 4 | Lens 2 | 3.5524 | 1.123 | Plastic | 1.545 | 56 | 3.259 |
| 5 | | −3.1565 | 0.148 | | | | |
| 6 | Lens 3 | ∞ | 0.303 | Plastic | 1.645 | 23 | ∞ |
| 7 | | ∞ | 0.031 | | | | |
| 8 | Lens 4 | 5.1694 | 1.112 | Plastic | 1.545 | 56 | −3.907 |
| 9 | | −1.0432 | 0.031 | | | | |
| 10 | Lens 5 | 1.6992 | 0.308 | Plastic | 1.645 | 23 | −1.816 |
| 11 | | 0.6439 | 0.779 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 54 shows conic constants and aspheric coefficients of each surface of each lens of Example 27.

TABLE 54

| Surface | K | A4 | A6 | A8 | A10 | A12 | A14 |
|---|---|---|---|---|---|---|---|
| 1 | −89.9935 | 1.2336E−02 | −8.8661E−04 | 2.1372E−05 | 1.1545E−06 | −1.2507E−07 | 2.7471E−09 |
| 2 | 0.4012 | 6.1198E−02 | −1.1255E−02 | 8.5458E−03 | −7.4403E−04 | −1.0877E−04 | −4.0362E−05 |
| 4 | −8.0516 | −5.8089E−02 | −2.1122E−01 | 3.8412E−01 | −5.8736E−01 | 0.0000E+00 | 0.0000E+00 |
| 5 | −52.8548 | −5.5347E−01 | 3.5211E−01 | −1.0357E−01 | −3.6064E−02 | −1.5454E−06 | −1.0158E−06 |
| 6 | 90.0000 | −3.1642E−01 | 1.2904E−01 | 8.4157E−02 | −4.8897E−02 | −3.3547E−05 | 5.2301E−10 |
| 7 | −90.0000 | 1.3398E−01 | −1.4543E−01 | −5.7001E−02 | 1.6389E−01 | −6.3925E−02 | −4.3793E−07 |
| 8 | 3.0096 | 2.4128E−01 | −3.8457E−01 | 2.1809E−01 | −1.9767E−02 | −9.7866E−03 | −1.8437E−07 |
| 9 | −7.3806 | −1.9949E−01 | 1.5049E−01 | −5.8356E−02 | −8.4727E−03 | 2.8194E−02 | −5.8296E−03 |
| 10 | −19.4505 | −3.9405E−01 | 1.3640E−01 | 6.1328E−02 | −2.8385E−02 | −9.8266E−03 | 4.5107E−03 |
| 11 | −4.4970 | −2.6664E−01 | 1.9499E−01 | −6.9343E−02 | 9.0644E−03 | 7.1903E−04 | −2.7370E−04 |

FIG. 106 shows spherical aberrations. The horizontal axis of FIG. 106 represents a position at which a ray that travels parallel to the optical axis and enters the imaging optical system intersects with the optical axis. The vertical axis of FIG. 106 represents distance of the above-described ray from the optical axis. The value of distance is normalized by the radius of the aperture. In other words, the value 1 on the vertical axis represents the radius of the aperture. In FIG. 106, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

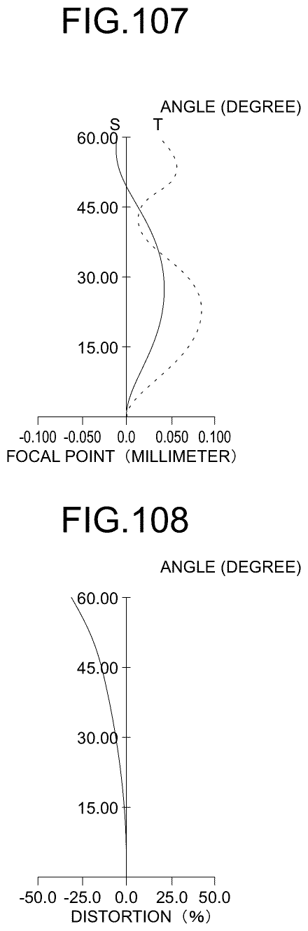

FIG. 107 shows astigmatism of the ray of wavelength of 587.5618 nanometers. The horizontal axis of FIG. 107 represents a position in the optical axis direction of the focal point. The vertical axis of FIG. 107 represents angle that a ray forms with the optical axis. The solid line in FIG. 107 represents the graph of the sagittal plane, and the broken line in FIG. 107 represents the graph of the tangential plane.

FIG. 108 shows distortion of the ray of wavelength of 587.5618 nanometers. The horizontal axis of FIG. 108 represents distortion. The unit is percent. The vertical axis of FIG. 108 represents angle that a ray forms with the optical axis.

### Example 28

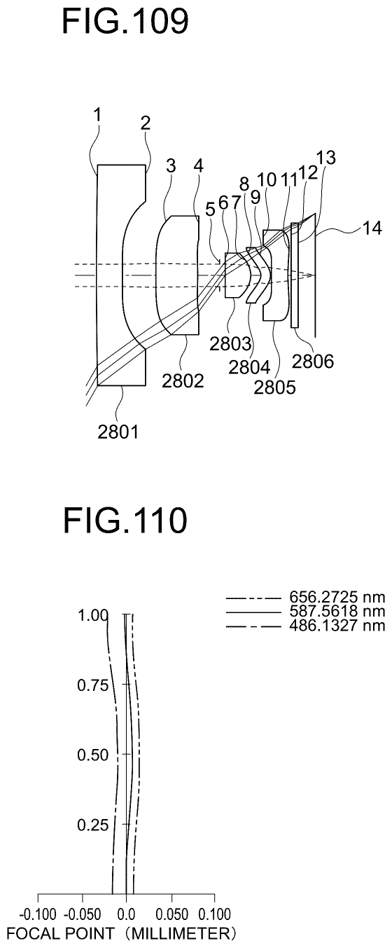

FIG. 109 shows a layout of an imaging optical system of Example 28. The imaging optical system includes five lenses and an infrared cut filter arranged from the object side to the image side. Each of the first lens 2801 and the fifth lens 2805 is an aspheric lens in which radius of curvature of each of both surfaces is infinity in the paraxial region and which has a power in the peripheral area. The second lens 2802 is a positive meniscus lens which is convex toward the image. The third lens 2803 is a biconvex lens. The fourth lens 2804 is a negative meniscus lens which is convex toward the image. The aperture stop 5 is located between the second lens 2802 and the third lens 2803.

Table 55 shows positions of the optical elements and properties and values of focal length of the lenses of the imaging optical system of Example 28. The focal length f of the whole imaging optical system is given by f=1.686. The F-number Fno is given by Fno=2.4. HFOV representing a half value of angle of view is given by HFOV=60 (degrees). In Table 55 each of the five lenses is represented respectively by lens 1 to lens 5 from the object side.

In the present example, the object distance from the object to the first lens is infinity.

TABLE 55

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | ∞ | 0.813 | Plastic | 1.535 | 56 | ∞ |
| 2 | | ∞ | 1.109 | | | | |
| 3 | Lens 2 | −16.6867 | 1.300 | Plastic | 1.645 | 23 | 31.793 |
| 4 | | −9.4812 | 0.714 | | | | |
| 5 | Ape. Stop | Plano | 0.153 | | | | |
| 6 | Lens 3 | 4.9607 | 0.842 | Plastic | 1.545 | 56 | 1.135 |
| 7 | | −0.6644 | 0.321 | | | | |
| 8 | Lens 4 | −0.3277 | 0.312 | Plastic | 1.585 | 30.5 | −6.858 |
| 9 | | −0.4823 | 0.030 | | | | |
| 10 | Lens 5 | ∞ | 0.527 | Plastic | 1.645 | 23 | ∞ |
| 11 | | ∞ | 0.118 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 56 shows conic constants and aspheric coefficients of each surface of each lens of Example 28.

TABLE 56

| Surface | K | A4 | A6 | A8 | A10 | A12 | A14 |
|---|---|---|---|---|---|---|---|
| 1 | 90.0000 | −5.7906E−05 | 2.3564E−05 | 2.9899E−07 | 7.4044E−09 | 6.5110E−10 | −1.7470E−10 |
| 2 | 90.0000 | 2.9480E−02 | −3.9810E−04 | 3.9269E−05 | −1.6123E−05 | −2.2714E−07 | −1.0303E−08 |
| 4 | −90.0000 | 7.1455E−02 | −1.9224E−02 | 4.8573E−03 | −4.0292E−04 | 2.7357E−06 | −4.5066E−07 |
| 5 | 46.1900 | 6.3253E−02 | 5.2687E−03 | −3.1245E−04 | 3.8680E−04 | 2.3337E−07 | 9.4519E−12 |
| 6 | −89.4451 | −2.2481E−01 | 2.2863E−01 | −4.0789E+00 | 2.8437E+00 | −1.8611E−16 | −1.3071E−18 |
| 7 | −2.8995 | −5.3933E−01 | 7.2151E−01 | −7.2436E−01 | −8.5717E−01 | 1.9695E−10 | −1.4408E−11 |
| 8 | −1.3331 | 6.6071E−01 | 7.6459E−01 | −2.2978E+00 | 1.5370E+00 | −4.1494E−09 | −1.7849E−11 |
| 9 | −0.7974 | 5.4204E−01 | 1.0311E+00 | −1.3908E+00 | 8.3086E−01 | 5.2695E−06 | 7.2186E−12 |
| 10 | 90.0000 | −1.0702E−01 | 9.5251E−02 | −4.2831E−01 | 2.5332E−01 | −2.7214E−01 | 1.1210E−01 |
| 11 | 90.0000 | 2.5257E−01 | −3.3899E−01 | 1.4561E−01 | −3.3977E−02 | 2.9819E−03 | 8.5839E−08 |

FIG. 110 shows spherical aberrations. The horizontal axis of FIG. 110 represents a position at which a ray that travels parallel to the optical axis and enters the imaging optical system intersects with the optical axis. The vertical axis of FIG. 110 represents distance of the above-described ray from the optical axis. The value of distance is normalized by the radius of the aperture. In other words, the value 1 on the vertical axis represents the radius of the aperture. In FIG. 110, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

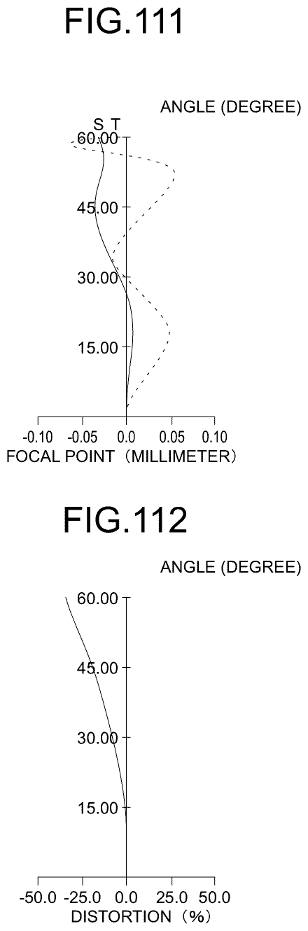

FIG. 111 shows astigmatism of the ray of wavelength of 587.5618 nanometers. The horizontal axis of FIG. 111 represents a position in the optical axis direction of the focal point. The vertical axis of FIG. 111 represents angle that a ray forms with the optical axis. The solid line in FIG. 111 represents the graph of the sagittal plane, and the broken line in FIG. 111 represents the graph of the tangential plane.

FIG. 112 shows distortion of the ray of wavelength of 587.5618 nanometers. The horizontal axis of FIG. 112 represents distortion. The unit is percent. The vertical axis of FIG. 112 represents angle that a ray forms with the optical axis.

### Example 29

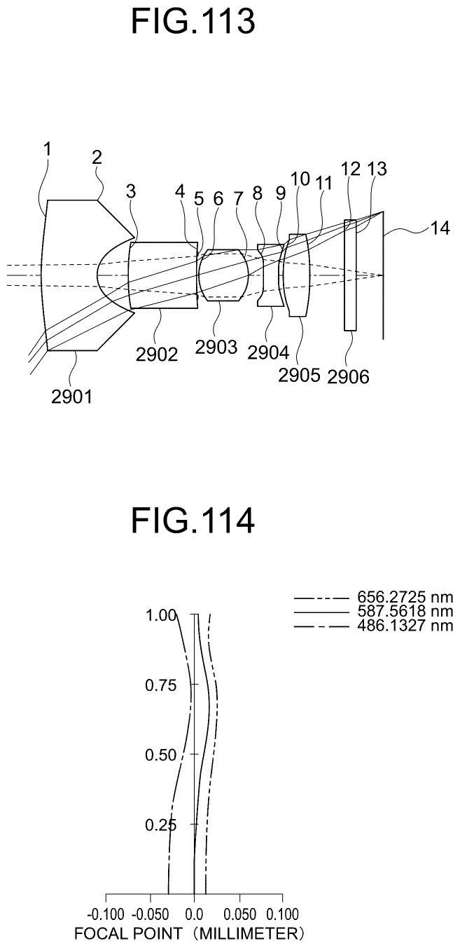

FIG. 113 shows a layout of an imaging optical system of Example 29. The imaging optical system includes five lenses and an infrared cut filter arranged from the object side to the image side. Each of the second lens 2902, the fourth lens 2904 and the fifth lens 2905 is an aspheric lens in which radius of curvature of each of both surfaces is infinity in the paraxial region and which has a power in the peripheral area. The first lens 2901 is a negative meniscus lens which is convex toward the object. The third lens 2903 is a biconvex lens. The aperture stop 5 is located between the second lens 2902 and the third lens 2903.

Table 57 shows positions of the optical elements and properties and values of focal length of the lenses of the imaging optical system of Example 29. The focal length f of the whole imaging optical system is given by f=1.344. The F-number Fno is given by Fno=2.4. HFOV representing a half value of angle of view is given by HFOV=60 (degrees). In Table 57 each of the five lenses is represented respectively by lens 1 to lens 5 from the object side.

In the present example, the object distance from the object to the first lens is infinity.

TABLE 57

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 11.6968 | 1.075 | Plastic | 1.545 | 56 | −1.735 |
| 2 | | 0.8467 | 0.618 | | | | |
| 3 | Lens 2 | ∞ | 1.300 | Plastic | 1.645 | 23 | ∞ |
| 4 | | ∞ | 0.024 | | | | |
| 5 | Ape. Stop | Plano | 0.016 | | | | |
| 6 | Lens 3 | 1.2412 | 0.963 | Plastic | 1.545 | 56 | 1.494 |
| 7 | | −1.7202 | 0.286 | | | | |
| 8 | Lens 4 | ∞ | 0.300 | Plastic | 1.645 | 23 | ∞ |
| 9 | | ∞ | 0.089 | | | | |
| 10 | Lens 5 | ∞ | 0.507 | Plastic | 1.545 | 56 | ∞ |
| 11 | | ∞ | 0.678 | | | | |
| 12 | IR cut | Plano | 0.210 | Glass | 1.517 | 64.2 | |
| | filter | | | | | | |
| 13 | | Plano | 0.550 | | | | |
| 14 | Image | Plano | | | | | |

Table 58 shows conic constants and aspheric coefficients of each surface of each lens of Example 29.

TABLE 58

| Surface | K | A4 | A6 | A8 | A10 | A12 | A14 |
|---|---|---|---|---|---|---|---|
| 1 | −89.9666 | 6.7538E−03 | 9.7790E−05 | −8.7913E−04 | 1.0502E−04 | −3.0490E−09 | 3.0302E−11 |
| 2 | −0.6153 | 9.4207E−02 | −6.3609E−04 | −2.4053E−04 | 8.8881E−01 | −1.5323E+00 | 5.7131E−01 |
| 4 | −90.0000 | 4.2817E−02 | 1.0454E−01 | 2.7378E−04 | −6.5257E−02 | −2.7901E−06 | −9.8651E−07 |
| 5 | −90.0000 | 8.9904E−02 | 7.6270E−01 | −2.2175E+00 | 4.2625E+00 | −5.3689E−04 | −2.0968E−06 |
| 6 | −2.1499 | 3.4408E−02 | 4.5057E−01 | −1.5011E+00 | 1.0568E+00 | 0.0000E+00 | 0.0000E+00 |
| 7 | 3.7950 | −3.4425E−01 | 4.9600E−01 | −5.7475E−01 | 8.4095E−01 | −5.1927E−14 | −6.6951E−15 |
| 8 | −90.0000 | −2.8460E−01 | −5.6084E−01 | 3.1477E−01 | −1.6753E+00 | −5.8498E−14 | −6.6879E−15 |
| 9 | −90.0000 | 7.2489E−01 | −8.3696E−01 | −1.5535E−01 | 5.2613E−01 | 1.8775E−07 | −6.9233E−15 |
| 10 | −90.0000 | 4.6606E−01 | −4.2736E−01 | 7.3160E−02 | 3.8986E−02 | −6.8051E−05 | −2.9397E−07 |
| 11 | −90.0000 | −1.2101E−01 | 1.7564E−02 | 1.1749E−01 | −8.1409E−02 | 8.7988E−05 | 2.2678E−06 |

FIG. 114 shows spherical aberrations. The horizontal axis of FIG. 114 represents a position at which a ray that travels parallel to the optical axis and enters the imaging optical system intersects with the optical axis. The vertical axis of FIG. 114 represents distance of the above-described ray from the optical axis. The value of distance is normalized by the radius of the aperture. In other words, the value 1 on the vertical axis represents the radius of the aperture. In FIG. 114, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

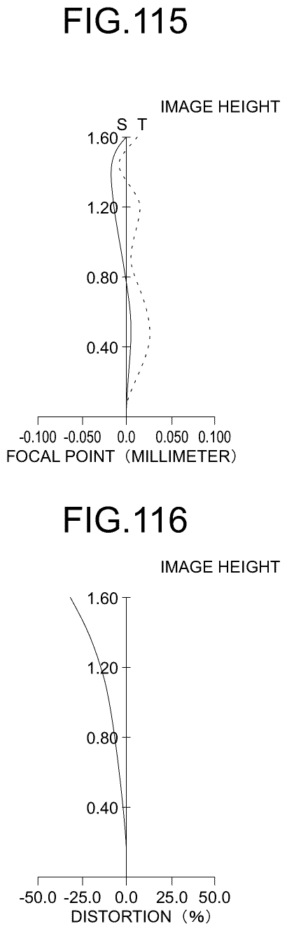

FIG. 115 shows astigmatism of the ray of wavelength of 587.5618 nanometers. The horizontal axis of FIG. 115 represents a position in the optical axis direction of the focal point. The vertical axis of FIG. 115 represents image height. The solid line in FIG. 115 represents the graph of the sagittal plane, and the broken line in FIG. 115 represents the graph of the tangential plane.

FIG. 116 shows distortion of the ray of wavelength of 587.5618 nanometers. The horizontal axis of FIG. 116 represents distortion. The unit is percent. The vertical axis of FIG. 116 represents image height.

### Example 30

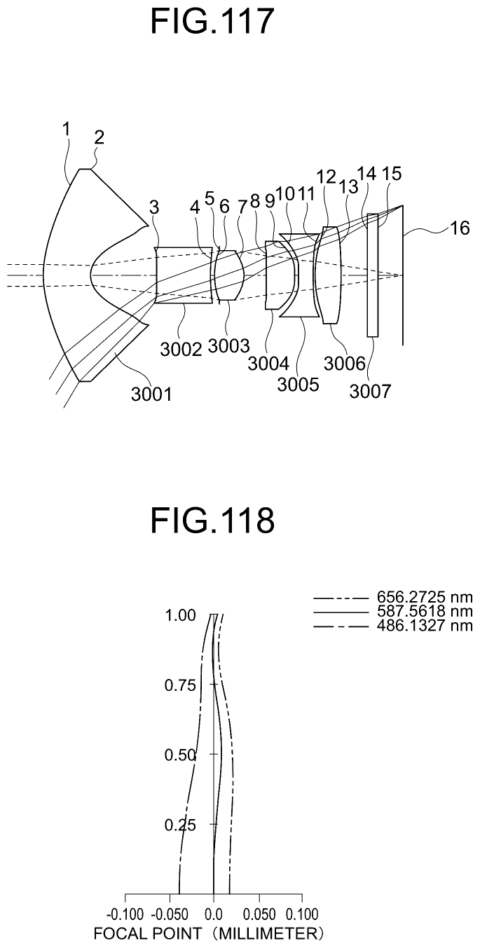

FIG. 117 shows a layout of an imaging optical system of Example 30. The imaging optical system includes six lenses and an infrared cut filter arranged from the object side to the image side. Each of the second lens 3002, the fourth lens 3004, the fifth lens 3005 and the sixth lens 3006 is an aspheric lens in which radius of curvature of each of both surfaces is infinity in the paraxial region and which has a power in the peripheral area. The first lens 3001 is a negative meniscus lens which is convex toward the object. The third lens 2903 is a biconvex lens. The aperture stop 5 is located closer to the object than the object-side surface of the third lens 3003.

Table 59 shows positions of the optical elements and properties and values of focal length of the lenses of the imaging optical system of Example 30. The focal length f of the whole imaging optical system is given by f=1.358. The F-number Fno is given by Fno=2.2. HFOV representing a half value of angle of view is given by HFOV=65 (degrees). In Table 59 each of the six lenses is represented respectively by lens 1 to lens 6 from the object side.

In the present example, the object distance from the object to the first lens is infinity.

TABLE 59

| | | Radius of | Thickness | | Refractive | Abbe's | Focal |
|---|---|---|---|---|---|---|---|
| Surface | | curvature | or distance | Material | index | number | length |
| 0 | Object | Plano | ∞ | | | | |
| 1 | Lens 1 | 4.5604 | 1.041 | Plastic | 1.545 | 56 | −2.018 |
| 2 | | 0.8147 | 1.498 | | | | |
| 3 | Lens 2 | ∞ | 1.200 | Plastic | 1.645 | 23 | ∞ |
| 4 | | ∞ | 0.175 | | | | |
| 5 | Ape. Stop | Plano | −0.094 | | | | |
| 6 | Lens 3 | 4.1263 | 0.644 | Plastic | 1.545 | 56 | 1.81 |
| 7 | | −1.2250 | 0.504 | | | | |
| 8 | Lens 4 | ∞ | 0.623 | Plastic | 1.545 | 56 | ∞ |
| 9 | | ∞ | 0.094 | | | | |
| 10 | Lens 5 | ∞ | 0.308 | Plastic | 1.645 | 23 | ∞ |
| 11 | | ∞ | 0.074 | | | | |
| 12 | Lens 6 | ∞ | 0.553 | Plastic | 1.545 | 56 | ∞ |
| 13 | | ∞ | 0.621 | | | | |
| 14 | IR cut | Plano | 0.210 | Glass | 1.517 | 64.2 | |
| | filter | | | | | | |
| 15 | | Plano | 0.550 | | | | |
| 16 | Image | Plano | | | | | |

Table 60 shows conic constants and aspheric coefficients of each surface of each lens of Example 30.

TABLE 60

| Surface | K | A4 | A6 | A8 | A10 | A12 | A14 |
|---|---|---|---|---|---|---|---|
| 1 | −0.0958 | −3.4890E−04 | −1.6363E−03 | 1.7937E−04 | −2.0508E−06 | −4.0446E−07 | 1.2155E−08 |
| 2 | −0.6764 | 2.6051E−02 | −3.2352E−02 | 2.1232E−02 | −3.2363E−02 | 4.6616E−06 | 1.0008E−11 |
| 3 | −90.0000 | −9.6975E−02 | −2.1960E−02 | −1.0789E−01 | 5.7627E−02 | −4.7470E−05 | 5.1462E−11 |
| 4 | −90.0000 | 1.9281E−01 | −2.3082E−01 | 1.2813E−01 | 3.1655E−02 | 1.4254E−05 | 3.3458E−06 |
| 6 | 10.6218 | 2.3569E−01 | −2.9968E−01 | 1.4995E−01 | −9.6436E−03 | 0.0000E+00 | 0.0000E+00 |
| 7 | −2.5077 | −1.2524E−02 | −4.3304E−02 | 1.5998E−02 | 2.4884E−03 | −4.6294E−09 | −4.5032E−10 |
| 8 | −90.0000 | 6.4612E−02 | −1.0432E−01 | −5.2552E−02 | −1.0445E−01 | 3.9242E−09 | −2.0697E−10 |
| 9 | −90.0000 | −8.0701E−01 | 6.7962E−01 | −3.1213E−01 | 3.5730E−02 | 1.2097E−08 | −1.3875E−10 |
| 10 | −90.0000 | −7.6802E−01 | 3.4605E−01 | 2.7186E−01 | −1.8112E−01 | −4.3329E−09 | 1.3121E−11 |
| 11 | −90.0000 | 1.8963E−01 | −1.5778E−01 | 8.1097E−02 | −1.8312E−02 | 2.3829E−06 | −5.3906E−11 |
| 12 | −90.0000 | 1.9706E−01 | −1.4015E−01 | 5.2914E−02 | −1.1537E−02 | −4.7100E−07 | 3.9993E−07 |
| 13 | −90.0000 | −6.9507E−02 | 7.2518E−02 | −2.7911E−02 | 1.2120E−03 | 1.8366E−06 | 5.2889E−11 |

FIG. 118 shows spherical aberrations. The horizontal axis of FIG. 118 represents a position at which a ray that travels parallel to the optical axis and enters the imaging optical system intersects with the optical axis. The vertical axis of FIG. 118 represents distance of the above-described ray from the optical axis. The value of distance is normalized by the radius of the aperture. In other words, the value 1 on the vertical axis represents the radius of the aperture. In FIG. 118, the solid line represents the graph of the ray of wavelength of 587.5618 nanometers, the chain line represents the graph of the ray of wavelength of 486.1327 nanometers and the two-dot chain line represents the graph of the ray of wavelength of 656.2725 nanometers.

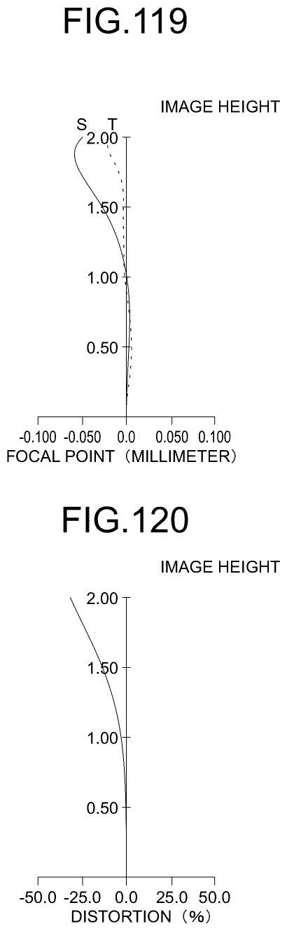

FIG. 119 shows astigmatism of the ray of wavelength of 587.5618 nanometers. The horizontal axis of FIG. 119 represents a position in the optical axis direction of the focal point. The vertical axis of FIG. 119 represents image height. The solid line in FIG. 119 represents the graph of the sagittal plane, and the broken line in FIG. 119 represents the graph of the tangential plane.

FIG. 120 shows distortion of the ray of wavelength of 587.5618 nanometers. The horizontal axis of FIG. 120 represents distortion. The unit is percent. The vertical axis of FIG. 120 represents image height.

### Features of Examples 1-30

Tables 61-66 show features of Examples 1-30. In the tables, n, NAT, f and HFOV respectively represent the number of all lenses, the number of an aspheric lens or aspheric lenses in each of which radius of curvature of each of both surfaces is infinity in the paraxial region and each of which has a power in the peripheral area, the focal length of the whole optical system and a half value of angle of view (a half angle of view). In the column of NAT in the tables, for example, “2 (L1, L4)” represents that the number of aspheric lenses in each of which radius of curvature of each of both surfaces is infinity in the paraxial region and each of which has a power in the peripheral area is two, and the two lenses are the first and fourth lenses. “fi” represents focal length of the i-th lens from the object side (the i-th lens) where i represent an integer from 1 to n. “Distortion at 90% of image height” represents distortion at the position of 90% of the maximum value of image height. “Term” represents the value of the following term.

$$( {\sum }_{i = 1}^{i = n} \vert \frac{1}{{f}_{i}} \vert ) \cdot \frac{f}{n}$$

TABLE 61

| | | | | | | Distortion |
|---|---|---|---|---|---|---|
| | | | | | | at 90% |
| | | | | Image | HFOV | of image |
| Example | n | NAT | n − NAT | height | (degree) | height (%) |
| 1 | 4 | 2 (L1, L4) | 2 | 0.225 | 50 | −27.27 |
| 2 | 5 | 2 (L1, L5) | 3 | 0.225 | 50 | −26.84 |
| 3 | 5 | 2 (L2, L5) | 3 | 0.225 | 50 | −13.07 |
| 4 | 6 | 2 (L1, L6) | 4 | 0.225 | 50 | −28.03 |
| 5 | 6 | 2 (L2, L6) | 4 | 0.225 | 50 | −21.18 |
| 6 | 5 | 2 (L1, L5) | 3 | 1.9 | 60 | −30.2 |
| 7 | 6 | 2 (L2, L6) | 4 | 2 | 65 | −22.6 |
| 8 | 3 | 1 (L1) | 2 | 0.225 | 50 | −27.41 |
| 9 | 3 | 1 (L2) | 2 | 0.225 | 50 | −28.24 |
| 10 | 3 | 1 (L3) | 2 | 1.04 | 65 | −37.5 |

TABLE 62

| Example | f | Term | f1 | f2 | f3 | f4 | f5 | f6 | f7 |
|---|---|---|---|---|---|---|---|---|---|
| 1 | 0.2808 | 0.254 | ∞ | 1.04 | 0.376 | ∞ | | | |
| 2 | 0.264 | 0.224 | ∞ | 0.586 | −19.968 | 0.401 | ∞ | | |
| 3 | 0.206 | 0.269 | −0.458 | ∞ | 0.358 | 0.638 | ∞ | | |
| 4 | 0.275 | 0.345 | ∞ | −0.644 | 0.78 | 0.273 | −0.962 | ∞ | |
| 5 | 0.242 | 0.264 | −0.519 | ∞ | 0.999 | 0.428 | 0.788 | ∞ | |
| 6 | 1.68 | 0.503 | ∞ | 31.281 | 0.927 | −2.584 | ∞ | | |
| 7 | 1.388 | 0.414 | −2.084 | ∞ | 2.129 | 1.953 | −3.036 | ∞ | |
| 8 | 0.281 | 0.428 | ∞ | 0.643 | 0.332 | | | | |
| 9 | 0.271 | 0.507 | −0.425 | ∞ | 0.308 | | | | |
| 10 | 0.87 | 0.652 | −1.58 | 0.755 | ∞ | | | | |

TABLE 63

| | | | | | | Distortion |
|---|---|---|---|---|---|---|
| | | | | | | at 90% |
| | | | | Image | HFOV | of image |
| Example | n | NAT | n − NAT | height | (degree) | height (%) |
| 11 | 4 | 1 (L1) | 3 | 0.225 | 50 | −25.85 |
| 12 | 4 | 1 (L2) | 3 | 0.225 | 50 | −26.59 |
| (Reference | 4 | 1 (L3) | 3 | 0.225 | 50 | −16.26 |
| example 1) | | | | | | |
| 14 | 4 | 1 (L4) | 3 | 0.225 | 50 | −17.39 |
| 15 | 5 | 1 (L1) | 4 | 1.9 | 60 | −24.1 |
| 16 | 5 | 1 (L2) | 4 | 1.9 | 60 | −10.9 |
| 17 | 5 | 1 (L3) | 4 | 1.9 | 60 | −17.9 |
| 18 | 5 | 1 (L4) | 4 | 1.9 | 60 | −15.4 |
| 19 | 5 | 1 (L5) | 4 | 1.9 | 60 | −14.9 |
| 20 | 5 | 1 (L5) | 4 | 1.9 | 60 | −19.6 |

TABLE 64

| Example | f | Term | f1 | f2 | f3 | f4 | f5 | f6 | f7 |
|---|---|---|---|---|---|---|---|---|---|
| 11 | 0.273 | 0.274 | ∞ | 1.238 | 0.41 | 1.313 | | | |
| 12 | 0.265 | 0.46 | −0.915 | ∞ | 0.263 | −0.49 | | | |
| (Reference | 0.24 | 0.468 | −0.355 | 0.48 | ∞ | 0.342 | | | |
| example 1) | | | | | | | | | |
| 14 | 0.244 | 0.53 | −0.295 | 0.363 | 0.394 | ∞ | | | |
| 15 | 1.69 | 0.855 | ∞ | 19.677 | 1.468 | 0.954 | 1.334 | | |
| 16 | 1.3 | 0.611 | −2.179 | ∞ | 1.552 | −1.365 | 1.944 | | |
| 17 | 1.55 | 0.641 | −3.262 | 2.98 | ∞ | 1.394 | −1.41 | | |
| 18 | 1.6 | 0.619 | −4.07 | 1.623 | −1.72 | ∞ | 2.031 | | |
| 19 | 1.4 | 0.625 | −2.557 | 1.589 | −1.43 | 1.933 | ∞ | | |
| 20 | 1.69 | 0.578 | −1.939 | 5.167 | 1.356 | −3.812 | ∞ | | |

TABLE 65

| | | | | | | Distortion |
|---|---|---|---|---|---|---|
| | | | | | | at 90% |
| Exam- | | | n − | Image | HFOV | of image |
| ple | n | NAT | NAT | height | (degree) | height (%) |
| 21 | 5 | 3 (L1, L2, L5) | 2 | 0.225 | 50 | −28.08 |
| 22 | 5 | 3 (L1, L2, L5) | 2 | 0.225 | 50 | −29.74 |
| 23 | 5 | 3 (L1, L2, L5) | 2 | 0.225 | 50 | −29.97 |
| 24 | 5 | 3 (L1, L2, L5) | 2 | 0.225 | 50 | −29.97 |
| 25 | 7 | 3 (L2, L5, L7) | 4 | 2 | 70 | −22.4 |
| 26 | 5 | 1 (L1) | 4 | 1.9 | 60 | −24.8 |
| 27 | 5 | 1 (L3) | 4 | 1.9 | 60 | −22.8 |
| 28 | 5 | 2 (L1, L5) | 3 | 1.9 | 60 | −31.3 |
| 29 | 5 | 3 (L2, L4, L5) | 2 | 1.6 | 60 | −22.7 |
| 30 | 6 | 4 (L2, L4, L5, L6) | 2 | 2 | 65 | −24.5 |

TABLE 66

| Example | f | Term | f1 | f2 | f3 | f4 | f5 | f6 | f7 |
|---|---|---|---|---|---|---|---|---|---|
| 21 | 0.264 | 0.724 | ∞ | ∞ | 0.102 | −0.258 | ∞ | | |
| 22 | 0.274 | 0.616 | ∞ | ∞ | 0.119 | −0.351 | ∞ | | |
| 23 | 0.278 | 0.503 | ∞ | ∞ | 0.135 | −0.6 | ∞ | | |
| 24 | 0.277 | 0.435 | ∞ | ∞ | 0.149 | −0.871 | ∞ | | |
| 25 | 1.121 | 0.349 | −2.031 | ∞ | 1.431 | −1.816 | ∞ | 2.298 | ∞ |
| 26 | 1.68 | 0.481 | ∞ | −36.205 | 4.847 | 1.441 | −1.984 | | |
| 27 | 1.593 | 0.436 | −3.907 | 3.259 | ∞ | 1.7 | −1.816 | | |
| 28 | 1.686 | 0.357 | ∞ | 31.793 | 1.135 | −6.858 | ∞ | | |
| 29 | 1.344 | 0.335 | −1.735 | ∞ | 1.494 | ∞ | ∞ | | |
| 30 | 1.358 | 0.237 | −2.018 | ∞ | 1.81 | ∞ | ∞ | ∞ | |

The power of an aspheric lens in which radius of curvature of each of both surfaces is infinity in the paraxial region and which has a power in the peripheral area will be described below. In Expression (1) which expresses each lens surface, R is infinity (R=∞). Accordingly, Expression (1) is expressed as below using terms up to the fourth-order of r.

$$z = {A}_{4} {r}^{4} \qquad {( 1 )}^{′}$$

When coordinates of a point on a lens surface through which a ray passes is represented by (z, r) and a distance between the point at which z=r holds and the optical axis is represented by h, h=r holds at the point at which z=r holds. Accordingly, the following Expression holds from Expression (1)′.

$$h = {A}_{4} {h}^{4} \qquad ( 2 )$$

$$h = {( \frac{1}{{A}_{4}} )}^{\frac{1}{3}} = r$$

When the shape of the surface containing the point on the optical axis and the points at which z=r holds is represented by an approximate spherical surface, the radius of the approximate spherical surface is represented by z=r. Accordingly, the power can be obtained from radii (radii of curvature) of the approximate spherical surfaces of both surfaces of a lens.

In general, power q of a lens can be obtained by the following expression.

$$φ = \frac{N - 1}{{r}_{a}} + \frac{1 - N}{{r}_{b}} - \frac{d}{N} \cdot \frac{N - 1}{{r}_{a}} \cdot \frac{1 - N}{{r}_{b}} \qquad ( 3 )$$

By substituting Expression (2) into Expression (3), the power φ of an aspheric lens in which radius of curvature of each of both surfaces is infinity in the paraxial region and which has a power in the peripheral area can be expressed by the following expression.

$$φ = \frac{N - 1}{{( \frac{1}{{A}_{4 a}} )}^{\frac{1}{3}}} + \frac{1 - N}{{( \frac{1}{{A}_{4 b}} )}^{\frac{1}{3}}} - \frac{d}{N} \cdot \frac{N - 1}{{( \frac{1}{{A}_{4 a}} )}^{\frac{1}{3}}} \cdot \frac{1 - N}{{( \frac{1}{{A}_{4 b}} )}^{\frac{1}{3}}} \qquad ( 4 )$$

What are expressed by the symbols used in Expression (3) and Expression (4) given above are as below.
N refractive index of a lens
d distance on the optical axis between the object-side surface and the image-side surface
rₐ radius of curvature of the object-side surface of the lens
r_{b} radius of curvature of the image-side surface of the lens
A₄ₐ Aspheric coefficient of the fourth-order term of Expression (1) of the object-side surface of the lens
A_{4b} Aspheric coefficient of the fourth-order term of Expression (1) of the object-side surface of the lens

In other words, the power φ of an aspheric lens in which radius of curvature of each of both surfaces is infinity in the paraxial region and which has a power in the peripheral area can be obtained as below. The shape of each surface is expressed by an expression including terms up to the fourth-order of r in Expression (1). Then, the points at which z=r holds on the shape of each surface are obtained. An approximate spherical surface containing the point of z=0 and the points of z=r of the shape of each surface is obtained. Then, the power φ can be obtained using radii (radii of curvature) (z) of both surfaces. The power φ described above is referred to as a power of the third-order aberration region in the peripheral area of an aspheric lens in which radius of curvature of each of both surfaces is infinity in the paraxial region and which has a power in the peripheral area.

Table 67 shows values of (φ·f) which are normalized values of power φ in the periphery area expressed by Expression (4). The normalization is performed by dividing values of power φ by (1/f), which is the inverse of the focal length of the whole optical system. For example, in the line concerning Example 1, L1 and L4 respectively represent the first lens and the fourth lens, each of which is an aspheric lens in which radius of curvature of each of both surfaces is infinity in the paraxial region and which has a power in the peripheral area.

TABLE 67

| Example | | | | | | | | |
|---|---|---|---|---|---|---|---|---|
| 1 | −0.621 | L1 | 0.502 | L4 | | | | |
| 2 | −0.507 | L1 | −0.812 | L5 | | | | |
| 3 | 0.0489 | L2 | 0.0271 | L5 | | | | |
| 4 | −0.086 | L1 | −0.0313 | L6 | | | | |
| 5 | 0.431 | L2 | −1.0116 | L6 | | | | |
| 6 | −0.35 | L1 | 0.0607 | L5 | | | | |
| 7 | −0.652 | L2 | 0.5 | L6 | | | | |
| 8 | −0.161 | L1 | | | | | | |
| 9 | −0.0705 | L2 | | | | | | |
| 10 | −0.939 | L3 | | | | | | |
| 11 | −0.584 | L1 | | | | | | |
| 12 | −0.0352 | L2 | | | | | | |
| 13 | 0.315 | L3 | | | | | | |
| 14 | −0.19 | L4 | | | | | | |
| 15 | −0.138 | L1 | | | | | | |
| 16 | 0.185 | L2 | | | | | | |
| 17 | −1.151 | L3 | | | | | | |
| 18 | 0.797 | L4 | | | | | | |
| 19 | 0.079 | L5 | | | | | | |
| 20 | −0.173 | L5 | | | | | | |
| 21 | −0.89 | L1 | 0.346 | L2 | 0.0707 | L5 | | |
| 22 | −0.872 | L1 | 0.359 | L2 | 0.0238 | L5 | | |
| 23 | −0.825 | L1 | 0.324 | L2 | −0.000942 | L5 | | |
| 24 | −0.845 | L1 | 0.31 | L2 | 0.0138 | L5 | | |
| 25 | 0.0255 | L2 | 0.607 | L5 | −0.832 | L7 | | |
| 26 | −0.268 | L1 | | | | | | |
| 27 | −1.268 | L3 | | | | | | |
| 28 | −0.317 | L1 | −1.271 | L5 | | | | |
| 29 | −0.0158 | L2 | −1.409 | L4 | 0.88 | L5 | | |
| 30 | −1.0178 | L2 | 0.925 | L4 | −1.361 | L5 | 0.7 | L6 |

The value of

|φ·f|

which is the absolute value of (φ·f) must be greater than 0.0007. When the absolute value is greater than 0.0007, also coefficients of the terms of the sixth or more order of r must be used to control aberrations in some cases. However, when the value of

|φ·f|

is greater than 0.007, aberrations can be controlled mainly using coefficients of the terms of the fourth order of r.

According to Tables 61-66, Examples 1-30 have the following features.

The number of the lenses of an imaging optical system is three to seven. The aperture stop is located within the imaging optical system. The imaging optical system includes one to four lenses, each of which is an aspheric lens in which radius of curvature of each of both surfaces is infinity in the paraxial region and which has a power in the peripheral area. The first lens is a negative lens or an aspheric lens in which radius of curvature of each of both surfaces is infinity in the paraxial region and which has a negative power in the peripheral area. The lens adjacent to the aperture stop on the image side of the aperture stop is a positive lens. The imaging optical system includes two or more lenses, each of which is not an aspheric lens in which radius of curvature of each of both surfaces is infinity in the paraxial region and which has a power in the peripheral area. The half angle of view of the imaging optical system is greater than 40 degrees and smaller than 80 degrees. Concerning the imaging optical system, the following relationship is satisfied.

$$0.18 < ( {\sum }_{i = 1}^{i = n} \vert \frac{1}{{f}_{i}} \vert ) \cdot \frac{f}{n} < 0.9$$

According to paths of rays shown in FIG. 1 and other drawings, the bundle of rays that enters an imaging optical system and reaches the maximum value of image height (the bundle of rays being referred to as an off-axis bundle of rays hereinafter) and the bundle of rays that enters the imaging optical system and has the principal ray parallel to the optical axis (the bundle of rays being referred to as an axial bundle of rays hereinafter) do not intersect with each other within the first lens.

Examples 1-7, 21-25 and 28-30 further have the following features.

The number of the lenses of an imaging optical system is four to seven. The aperture stop is located between the second lens and the fourth lens. The imaging optical system includes at least one aspheric lens in which radius of curvature of each of both surfaces is infinity in the paraxial region and which has a power in the peripheral area respectively on the object side and on the image side of the aperture stop. When the aperture stop is located on the image side of the image-side surface of a lens, the lens is defined as being located on the object side of the aperture stop, and when the aperture stop is located on the object side of the object-side surface of a lens, the lens is defined as being located on the image side of the aperture stop. The first lens and/or the second lens is an aspheric lens in which radius of curvature of each of both surfaces is infinity in the paraxial region and which has a power in the peripheral area. The lens closest to the image is an aspheric lens in which radius of curvature of each of both surfaces is infinity in the paraxial region and which has a power in the peripheral area. Concerning the imaging optical system, the following relationship is satisfied.

$$0.18 < ( {\sum }_{i = 1}^{i = n} \vert \frac{1}{{f}_{i}} \vert ) \cdot \frac{f}{n} < 0.82$$

The off-axis bundle of rays and the axial bundle of rays do not intersect with each other within the lens closest to the image.

In general, aberration coefficients of lens surfaces will be described below. The value of the aberration coefficient of an optical system is given as an algebraic sum of aberration coefficients of respective lens surfaces that form the optical system. In the case of an aspheric lens in which radius of curvature of each of both surfaces is infinity in the paraxial region and which has a power in the peripheral area, the curvature at the center of each lens surface is zero, and therefore aberration coefficients of spherical aberration, curvature of field and distortion can be expressed by the following approximation formulas that include aspheric coefficients alone as variables (Yoshiya Matsui, Lens design method, Kyoritsu Shuppan Co., Ltd. pp 87 etc.).

Spherical aberration

$$A \cdot {A}_{4} \cdot {h}^{4}$$

Curvature of field

$$A \cdot {A}_{4} \cdot {h}^{2} \cdot {\overline{h}}^{2}$$

### Distortion

$$A \cdot {A}_{4} \cdot h \cdot {\overline{h}}^{3}$$

In the approximation formulas, A represents a number determined by refractive index and constants alone, A₄ represents an aspheric coefficient of the fourth-order term of r of Expression (1) that represents each lens surface, and h represents height at which a ray of the axial bundle of rays passes through and
h̅
represents height at which a ray of the off-axis bundle of rays passes through.

Thus, aberrations can be expressed using an aspheric coefficient A₄ of the fourth-order term of r of Expression (1) that represents each lens surface. This means that the aberrations can be corrected by the power φ expressed by Expression (4) in the peripheral area of an aspheric lens in which radius of curvature of each of both surfaces is infinity in the paraxial region and which has a power in the peripheral area.

The sign of h is positive, and the sign of
h̅
is negative when a surface is located on the object side of the aperture stop and positive when a surface is located on the image side of the aperture stop.

Accordingly, by locating at least one aspheric lens in which radius of curvature of each of both surfaces is infinity in the paraxial region and which has a power in the peripheral area at an appropriate position in an imaging optical system and by determining an appropriate value of A₄ of each lens surface in consideration of the value of h and the value of
h̅,
the aberrations of the imaging optical system can be reduced without using a great number of lenses that have great powers in the paraxial region.

The design principals of imaging optical systems of the examples are below. First, at a position where h is relatively great, a lens that have a great power in the paraxial region is located so as to determine values concerning the paraxial region such as the value of focal length and further to correct spheric aberrations using aspheric surfaces. Secondly, at a position where h is relatively small and the absolute value of
h̅
is relatively great, an aspheric lens in which radius of curvature of each of both surfaces is infinity in the paraxial region and which has a power in the peripheral area is located so as to correct curvature of field and distortion.

When an aspheric lens in which radius of curvature of each of both surfaces is infinity in the paraxial region and which has a power in the peripheral area is located on the image side of the aperture stop, the sign of h and the sign of
h̅
are identical with each other, and therefore both curvature of field and distortion can be simultaneously corrected. However, when an aspheric lens in which radius of curvature of each of both surfaces is infinity in the paraxial region and which has a power in the peripheral area is located on the object side of the aperture stop, the sign of h and the sign of
h̅
are different from each other, and therefore curvature of field and distortion cannot be simultaneously corrected.

In practical applications, that is, in Examples 1-7, Examples 21-25 and Examples 28-30, the off-axis bundle of rays and the axial bundle of rays do not intersect with each other either within the first lens closest to the object or within the lens closest to the image, and each of the first and/or the second lens and the lens closest to the image is an aspheric lens in which radius of curvature of each of both surfaces is infinity in the paraxial region and which has a power in the peripheral area. The reason why an aspheric lens in which radius of curvature of each of both surfaces is infinity in the paraxial region and which has a power in the peripheral area is located on the object-side of the aperture stop is to reduce lens diameters and the whole length particularly of a wide-angle of view imaging optical system. In this case, off-axis aberrations generated in lenses on the object side of the aperture stop can be effectively corrected by an aspheric lens in which radius of curvature of each of both surfaces is infinity in the paraxial region and which has a power in the peripheral area located on the image side of the aperture stop.

In most of the other examples, an aspheric lens in which radius of curvature of each of both surfaces is infinity in the paraxial region and which has a power in the peripheral area is located at a position where the off-axis bundle of rays and the axial bundle of rays do not intersect with each other or at a position where an overlapping area of the off-axis bundle of rays and the axial bundle of rays is relatively small.

In general, in an imaging optical system used for any application other than measurement of a measuring instrument or the like, if distortion that does not directly affect resolution is corrected such that the distortion is not completely eliminated and a negative distortion remains, other aberrations than distortion that affect resolution can be advantageously corrected. Further, even if the aperture efficiency is great, the illuminance ratio at the periphery on the image plane decreases according to the cosine fourth law and remarkably decreases particularly in the case that the angle of view is great. The decrease in the illuminance ratio is, however, advantageously relieved by the negative distortion. Further, distortion of an imaging optical system can be corrected also by image processing. Values of distortion of the above-described examples are in the range from −10% to −40% at the position of 90% of the maximum value of image height.

In the examples, by appropriately using an aspheric lens in which radius of curvature of each of both surfaces is infinity in the paraxial region and which has a power in the peripheral area, axial aberrations and off-axis aberrations can be separately and efficiently corrected. Thus, high-performance wide-angle of view imaging optical systems can be obtained.

Imaging optical systems of Examples 31 to 53, each of which includes a single aspheric lens in which radius of curvature of each of both surfaces is infinity in the paraxial region and which has a power in the peripheral area will be described below.

### Example 31

Example 31 is identical with Example 8.

### Example 32

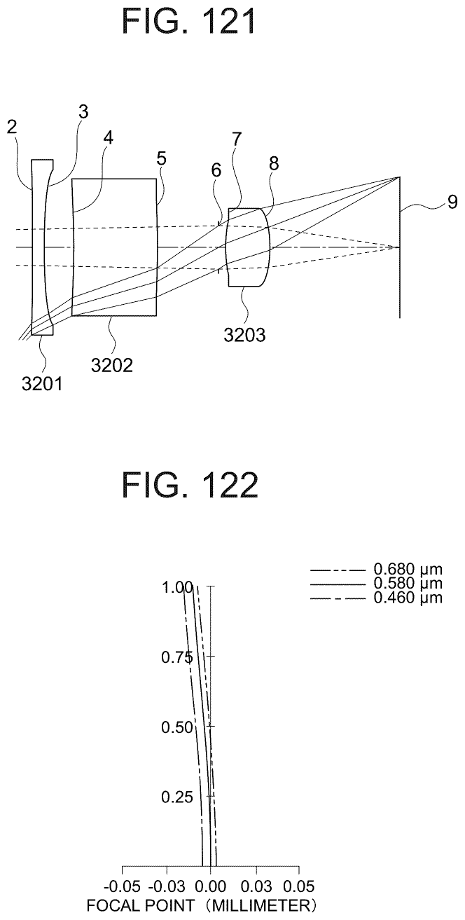

FIG. 121 shows a layout of an imaging optical system of Example 32. The imaging optical system includes three lenses arranged from the object side to the image side. The first lens 3201 is an aspheric lens in which radius of curvature of each of both surfaces is infinity in the paraxial region and which has a power in the peripheral area. The second lens 3202 is a biconcave lens. The third lens 3203 is a biconvex lens. The aperture stop 6 is located between the second lens 3202 and the third lens 3203.

Table 68 shows positions of the optical elements and properties and values of focal length of the lenses of the imaging optical system of Example 32. The focal length f of the whole imaging optical system is given by f=0.3750421. The F-number Fno is given by Fno=3.225. HFOV representing a half value of angle of view is given by HFOV=50 (degrees). In Table 68, each of the three lenses is represented respectively by lens 1 to lens 3 from the object side.

In the present example, the object distance from the object to the first lens is 7.000(=6.900+0.100) millimeters. Surface 1 does not correspond to a physical object.

TABLE 68

| | | Radius of | Thickness | | Refractive | Abbe's | Focal |
|---|---|---|---|---|---|---|---|
| Surface | | curvature | or distance | Material | index | number | length |
| 0 | Object | Plano | 6.900 | | | | |
| 1 | | Plano | 0.100 | | | | |
| 2 | Lens 1 | Infinity | 0.035 | Plastic | 1.5311 | 55.634 | Infinity |
| 3 | | Infinity | 0.088 | | | | |
| 4 | Lens 2 | −5.09649 | 0.246 | Plastic | 1.6349 | 23.945 | −5.314 |
| 5 | | 10.24696 | 0.181 | | | | |
| 6 | Ape. Stop | Infinity | 0.023 | | | | |
| 7 | Lens 3 | 0.48489 | 0.127 | Plastic | 1.5311 | 55.634 | 0.374 |
| 8 | | −0.30656 | 0.382 | | | | |
| 9 | Image | Plano | | | | | |

Table 69 shows conic constants and aspheric coefficients of each surface of each lens of Example 32.

TABLE 69

| Surface | K | A4 | A6 | A8 | A10 | A12 | A14 |
|---|---|---|---|---|---|---|---|
| 2 | 0.0000 | 1.1260E+00 | −7.7117E+00 | −7.5315E+01 | −7.1734E+02 | −6.8530E+03 | 0.0000E+00 |
| 3 | 0.0000 | 7.6684E+00 | −3.8203E+00 | 1.9874E+02 | 5.2539E+03 | 9.2569E+04 | 0.0000E+00 |
| 4 | −5.0005 | 1.7090E−01 | −2.5711E+00 | −5.7717E+01 | −5.1303E+02 | 7.2816E+03 | 0.0000E+00 |
| 5 | 4.8367 | −6.8318E+00 | −9.4977E+01 | −8.7680E+02 | 2.5570E+04 | 2.9087E+06 | 0.0000E+00 |
| 7 | −5.0016 | −8.0691E+00 | −1.2082E+03 | −9.4234E+04 | 2.3665E+06 | 1.8804E+09 | 0.0000E+00 |
| 8 | 0.8769 | −7.2746E+00 | −2.1482E+02 | −5.3355E+03 | −9.6504E+04 | −1.6827E+06 | 0.0000E+00 |

FIG. 122 shows spherical aberrations. The horizontal axis of FIG. 122 represents a position at which a ray that travels parallel to the optical axis and enters the imaging optical system intersects with the optical axis. The vertical axis of FIG. 122 represents distance of the above-described ray from the optical axis. The value of distance is normalized by the radius of the aperture. In other words, the value 1 on the vertical axis represents the radius of the aperture. In FIG. 122, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

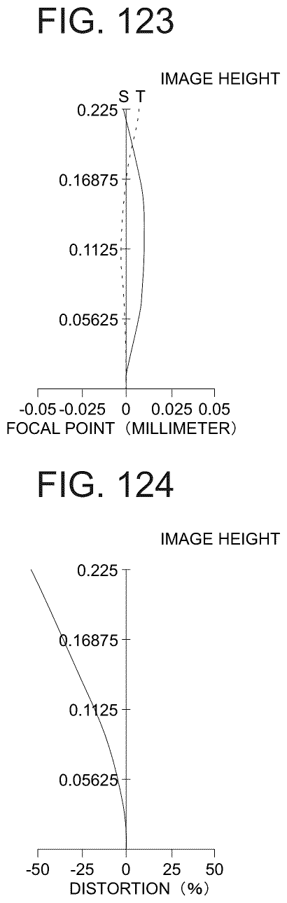

FIG. 123 shows astigmatism of the ray of wavelength of 0.580 micrometers. The horizontal axis of FIG. 123 represents a position in the optical axis direction of the focal point. The vertical axis of FIG. 123 represents image height. The solid line in FIG. 123 represents the graph of the sagittal plane, and the broken line in FIG. 123 represents the graph of the tangential plane.

FIG. 124 shows distortion of the ray of wavelength of 0.580 micrometers. The horizontal axis of FIG. 124 represents distortion. The unit is percent. The vertical axis of FIG. 124 represents image height.

### Example 33

Example 33 is identical with Example 10.

### Example 34

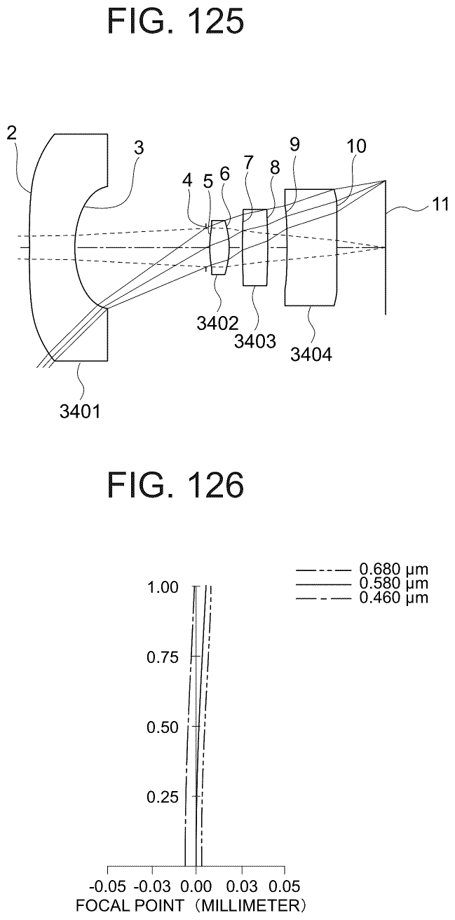

FIG. 125 shows a layout of an imaging optical system of Example 34. The imaging optical system includes four lenses arranged from the object side to the image side. The first lens 3401 is a biconcave lens. The second lens 3402 is a biconvex lens. The third lens 3403 is an aspheric lens in which radius of curvature of each of both surfaces is infinity in the paraxial region and which has a power in the peripheral area. The fourth lens 3404 is a positive meniscus lens which is convex toward the object. The aperture stop 4 is located between the first lens 3401 and the second lens 3402.

Table 70 shows positions of the optical elements and properties and values of focal length of the lenses of the imaging optical system of Example 34. The focal length f of the whole imaging optical system is given by f=0.259452. The F-number Fno is given by Fno=3.34357. HFOV representing a half value of angle of view is given by HFOV=50 (degrees). In Table 70, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 70

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −13.29342 | 0.144 | Plastic | 1.5311 | 55.634 | −0.853 |
| 3 | | 0.47183 | 0.420 | | | | |
| 4 | Ape. Stop | | 0.011 | | | | |
| 5 | Lens 2 | 0.40620 | 0.062 | Plastic | 1.5311 | 55.634 | 0.327 |
| 6 | | −0.28797 | 0.044 | | | | |
| 7 | Lens 3 | Infinity | 0.079 | Plastic | 1.5094 | 56.477 | Infinity |
| 8 | | Infinity | 0.060 | | | | |
| 9 | Lens 4 | 1.81575 | 0.161 | Plastic | 1.6349 | 23.945 | 2.856 |
| 10 | | 1409.04767 | 0.156 | | | | |
| 11 | Image | Plano | | | | | |

Table 71 shows conic constants and aspheric coefficients of each surface of each lens of Example 34.

TABLE 71

| Surface | K | A4 | A6 | A8 | A10 | A12 | A14 |
|---|---|---|---|---|---|---|---|
| 2 | −5.0000 | 3.64135E+00 | 4.68676E+01 | −3.59467E+02 | 6.02504E+02 | 0.00000E+00 | 0.00000E+00 |
| 3 | 4.7218 | 7.03622E+00 | 1.44317E+02 | 5.18191E+03 | 3.10392E+04 | 0.00000E+00 | 0.00000E+00 |
| 4 | −3.9607 | −6.67102E+00 | −4.51603E+02 | −6.93915E+03 | 1.61841E+06 | 0.00000E+00 | 0.00000E+00 |
| 5 | −0.7394 | 3.22865E+00 | −2.64163E+02 | −2.97923E+04 | 2.39197E+06 | 0.00000E+00 | 0.00000E+00 |
| 7 | 0.0000 | −3.29251E+00 | 4.76788E+02 | 3.27815E+03 | −9.46497E+05 | 1.52572E+08 | 4.43303E+09 |
| 8 | 0.0000 | −1.24339E+01 | −5.90609E+02 | −9.94394E+03 | 6.92919E+05 | 7.80438E+07 | 3.90899E+08 |
| 9 | −5.0000 | −1.32411E+01 | −3.40707E+02 | −1.44576E+04 | −8.06949E+05 | 7.58893E+05 | 0.00000E+00 |
| 10 | −5.0000 | 8.63262E+00 | −3.56349E+02 | −5.61807E+03 | −2.03689E+04 | 1.07806E+06 | 0.00000E+00 |

FIG. 126 shows spherical aberrations. The horizontal axis of FIG. 126 represents a position at which a ray that travels parallel to the optical axis and enters the imaging optical system intersects with the optical axis. The vertical axis of FIG. 126 represents distance of the above-described ray from the optical axis. The value of distance is normalized by the radius of the aperture. In other words, the value 1 on the vertical axis represents the radius of the aperture. In FIG. 126, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

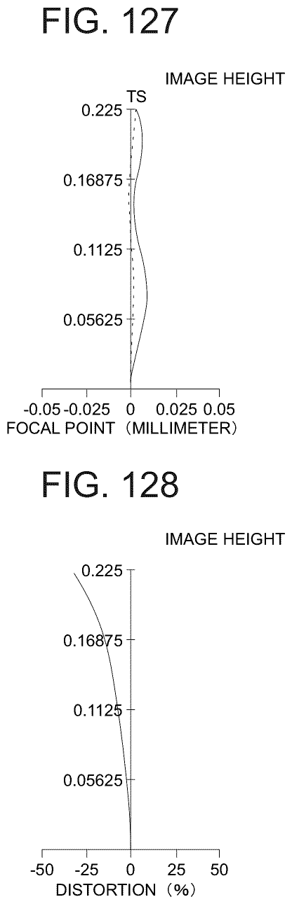

FIG. 127 shows astigmatism of the ray of wavelength of 0.580 micrometers. The horizontal axis of FIG. 127 represents a position in the optical axis direction of the focal point. The vertical axis of FIG. 127 represents image height. The solid line in FIG. 127 represents the graph of the sagittal plane, and the broken line in FIG. 127 represents the graph of the tangential plane.

FIG. 128 shows distortion of the ray of wavelength of 0.580 micrometers. The horizontal axis of FIG. 128 represents distortion. The unit is percent. The vertical axis of FIG. 128 represents image height.

### Example 35

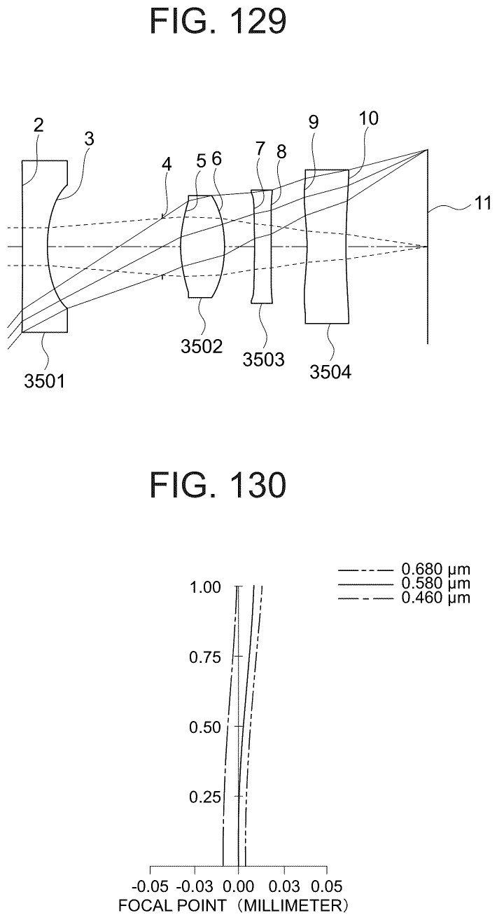

FIG. 129 shows a layout of an imaging optical system of Example 35. The imaging optical system includes four lenses arranged from the object side to the image side. The first lens 3501 is a biconcave lens. The second lens 3502 is a biconvex lens. The third lens 3503 is an aspheric lens in which radius of curvature of each of both surfaces is infinity in the paraxial region and which has a power in the peripheral area. The fourth lens 3504 is a negative meniscus lens which is convex toward the image. The aperture stop 4 is located between the first lens 3501 and the second lens 3502.

Table 72 shows positions of the optical elements and properties and values of focal length of the lenses of the imaging optical system of Example 35. The focal length f of the whole imaging optical system is given by f=0.282849. The F-number Fno is given by Fno=3.37755. HFOV representing a half value of angle of view is given by HFOV=50 (degrees). In Table 72, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 72

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | −1889.14713 | 0.056 | Plastic | 1.5311 | 55.634 | −0.544 |
| 3 | | 0.28937 | 0.253 | | | | |
| 4 | Ape. Stop | | 0.040 | | | | |
| 5 | Lens 2 | 0.26008 | 0.098 | Plastic | 1.5094 | 56.477 | 0.271 |
| 6 | | −0.25843 | 0.067 | | | | |
| 7 | Lens 3 | Infinity | 0.036 | Plastic | 1.6349 | 23.945 | Infinity |
| 8 | | Infinity | 0.079 | | | | |
| 9 | Lens 4 | −0.77778 | 0.086 | Plastic | 1.5311 | 55.634 | −1.469 |
| 10 | | −173.49046 | 0.180 | | | | |
| 11 | Image | Plano | | | | | |

Table 73 shows conic constants and aspheric coefficients of each surface of each lens of Example 35.

TABLE 73

| Surface | K | A4 | A6 | A8 | A10 | A12 | A14 |
|---|---|---|---|---|---|---|---|
| 2 | −5.0000 | 1.62886E+00 | −5.46877E+01 | −6.66432E+02 | −1.01931E+04 | 0.00000E+00 | 0.00000E+00 |
| 3 | 0.5854 | 1.19692E+01 | 3.12789E+02 | 2.98240E+03 | −6.28065E+04 | 0.00000E+00 | 0.00000E+00 |
| 4 | −2.0941 | −1.81836E+00 | −1.26118E+03 | 5.69113E+03 | 1.81936E+06 | 0.00000E+00 | 0.00000E+00 |
| 5 | 0.0745 | 2.98489E+00 | −4.43073E+02 | −8.19542E+04 | −1.74056E+05 | 0.00000E+00 | 0.00000E+00 |
| 7 | 0.0000 | −2.06591E+01 | −3.69850E+02 | −1.67740E+04 | −1.27775E+06 | −5.85087E+06 | −3.91386E+09 |
| 8 | 0.0000 | −9.61305E−01 | 3.61710E+02 | 1.41628E+04 | 3.52745E+05 | −2.86856E+07 | 1.40803E+09 |
| 9 | −5.0002 | 1.39453E+01 | 3.18254E+02 | 5.21105E+02 | −3.86796E+04 | 0.00000E+00 | 0.00000E+00 |
| 10 | −5.0000 | 2.00861E+01 | −2.91397E+02 | −4.58111E+03 | −4.82278E+03 | 0.00000E+00 | 0.00000E+00 |

FIG. 130 shows spherical aberrations. The horizontal axis of FIG. 130 represents a position at which a ray that travels parallel to the optical axis and enters the imaging optical system intersects with the optical axis. The vertical axis of FIG. 130 represents distance of the above described ray from the optical axis. The value of distance is normalized by the radius of the aperture. In other words, the value 1 on the vertical axis represents the radius of the aperture. In FIG. 130, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

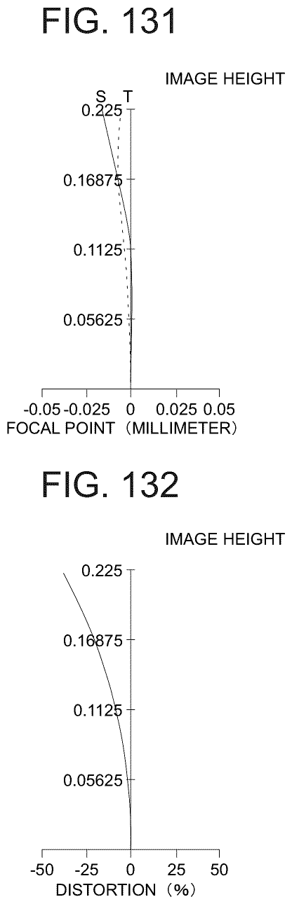

FIG. 131 shows astigmatism of the ray of wavelength of 0.580 micrometers. The horizontal axis of FIG. 131 represents a position in the optical axis direction of the focal point. The vertical axis of FIG. 131 represents image height. The solid line in FIG. 131 represents the graph of the sagittal plane, and the broken line in FIG. 131 represents the graph of the tangential plane. FIG. 132 shows distortion of the ray of wavelength of 0.580 micrometers. The horizontal axis of FIG. 132 represents distortion. The unit is percent. The vertical axis of FIG. 132 represents image height.

### Example 36

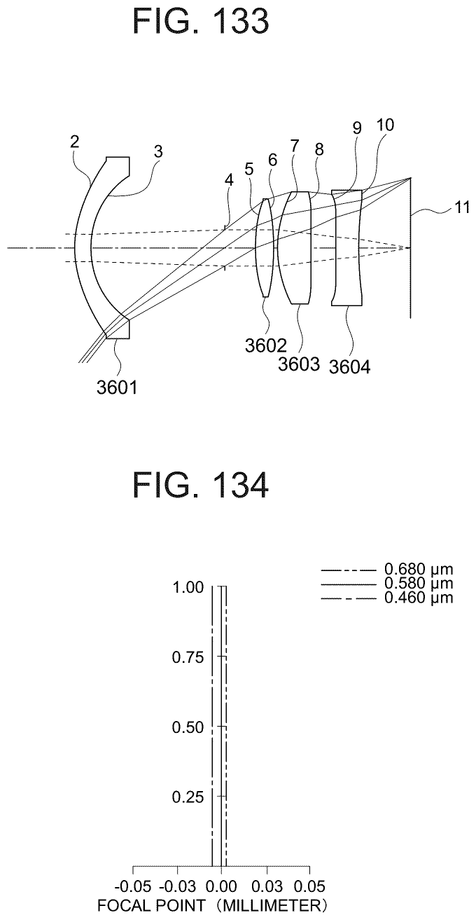

FIG. 133 shows a layout of an imaging optical system of Example 36. The imaging optical system includes four lenses arranged from the object side to the image side. The first lens 3601 is a negative meniscus lens which is convex toward the object. Each of the second lens 3602 and the third lens 3603 is a biconvex lens. The fourth lens 3604 is an aspheric lens in which radius of curvature of each of both surfaces is infinity in the paraxial region and which has a power in the peripheral area. The aperture stop 4 is located between the first lens 3601 and the second lens 3602.

Table 74 shows positions of the optical elements and properties and values of focal length of the lenses of the imaging optical system of Example 36. The focal length f of the whole imaging optical system is given by f=0.2877389. The F-number Fno is given by Fno=3.31144. HFOV representing a half value of angle of view is given by HFOV=50 (degrees). In Table 74, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 74

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | 0.36917 | 0.049 | Plastic | 1.5311 | 55.634 | −2.018 |
| 3 | | 0.26214 | 0.408 | | | | |
| 4 | Ape. Stop | | 0.094 | | | | |
| 5 | Lens 2 | 0.49054 | 0.054 | Plastic | 1.5094 | 56.477 | 0.576 |
| 6 | | −0.70716 | 0.011 | | | | |
| 7 | Lens 3 | 0.32951 | 0.105 | Plastic | 1.5311 | 55.634 | 0.619 |
| 8 | | −2832.62698 | 0.077 | | | | |
| 9 | Lens 4 | Infinity | 0.068 | Plastic | 1.6349 | 23.945 | Infinity |
| 10 | | Infinity | 0.158 | | | | |
| 11 | Image | Plano | | | | | |

Table 75 shows conic constants and aspheric coefficients of each surface of each lens of Example 36.

TABLE 75

| Surface | K | A4 | A6 | A8 | A10 | A12 | A14 |
|---|---|---|---|---|---|---|---|
| 2 | −0.5389 | 2.78790E+00 | −2.43023E+01 | −5.33866E+02 | 0.00000E+00 | 0.00000E+00 | 0.00000E+00 |
| 3 | 0.2175 | 1.76905E−01 | 4.31452E+01 | −3.53464E+03 | 0.00000E+00 | 0.00000E+00 | 0.00000E+00 |
| 4 | −1.4771 | −1.61694E+00 | −2.19259E+01 | 6.66724E+03 | 0.00000E+00 | 0.00000E+00 | 0.00000E+00 |
| 5 | 3.2950 | −1.35251E+00 | −2.30617E+01 | 1.57974E+03 | 0.00000E+00 | 0.00000E+00 | 0.00000E+00 |
| 7 | −0.8934 | 2.14445E−01 | −1.52892E+01 | −5.23135E+02 | 0.00000E+00 | 0.00000E+00 | 0.00000E+00 |
| 8 | 5.0073 | −7.15733E+00 | −6.61519E+01 | −9.33772E+02 | 0.00000E+00 | 0.00000E+00 | 0.00000E+00 |
| 9 | 0.0000 | −1.41181E+01 | −1.23327E+02 | −4.32917E+03 | −1.18661E+05 | −2.07677E+06 | 0.00000E+00 |
| 10 | 0.0000 | 2.65474E+01 | −4.16620E+02 | −4.83644E+03 | −6.09286E+04 | 1.88587E+06 | 0.00000E+00 |

FIG. 134 shows spherical aberrations. The horizontal axis of FIG. 134 represents a position at which a ray that travels parallel to the optical axis and enters the imaging optical system intersects with the optical axis. The vertical axis of FIG. 134 represents distance of the above described ray from the optical axis. The value of distance is normalized by the radius of the aperture. In other words, the value 1 on the vertical axis represents the radius of the aperture. In FIG. 134, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

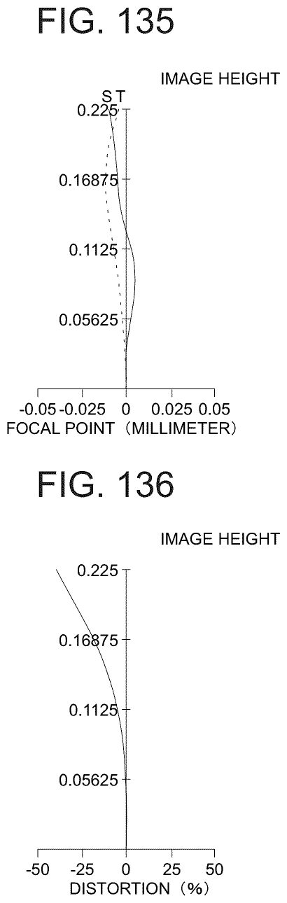

FIG. 135 shows astigmatism of the ray of wavelength of 0.580 micrometers. The horizontal axis of FIG. 135 represents a position in the optical axis direction of the focal point. The vertical axis of FIG. 135 represents image height. The solid line in FIG. 135 represents the graph of the sagittal plane, and the broken line in FIG. 135 represents the graph of the tangential plane.

FIG. 136 shows distortion of the ray of wavelength of 0.580 micrometers. The horizontal axis of FIG. 136 represents distortion. The unit is percent. The vertical axis of FIG. 136 represents image height.

### Example 37

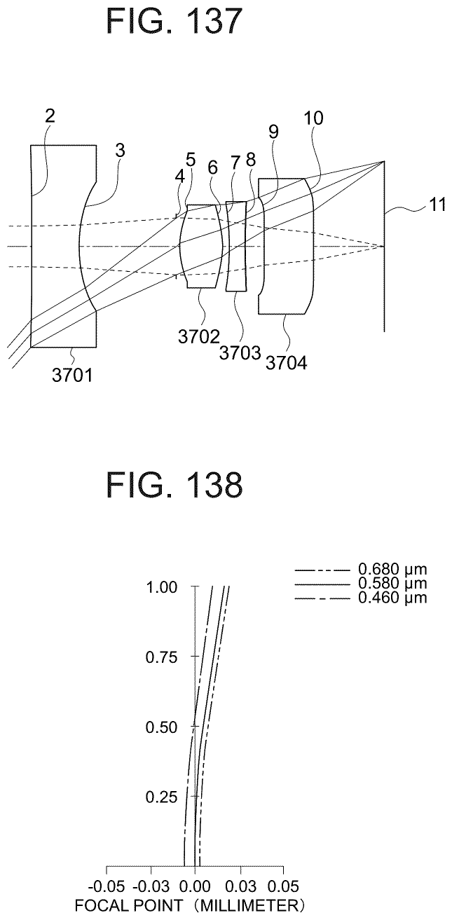

FIG. 137 shows a layout of an imaging optical system of Example 37. The imaging optical system includes four lenses arranged from the object side to the image side. The first lens 3701 is a negative meniscus lens which is convex toward the object. The second lens 3702 is a biconvex lens. The third lens 3703 is a negative meniscus lens which is convex toward the image. The fourth lens 3704 is an aspheric lens in which radius of curvature of each of both surfaces is infinity in the paraxial region and which has a power in the peripheral area. The aperture stop 4 is located between the first lens 3701 and the second lens 3702.

Table 76 shows positions of the optical elements and properties and values of focal length of the lenses of the imaging optical system of Example 37. The focal length f of the whole imaging optical system is given by f=0.284528. The F-number Fno is given by Fno=2.82731. HFOV representing a half value of angle of view is given by HFOV=50 (degrees). In Table 76, each of the four lenses is represented respectively by lens 1 to lens 4 from the object side.

In the present example, the object distance from the object to the first lens is 5.392(=5.142+0.250) millimeters. Surface 1 does not correspond to a physical object.

TABLE 76

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.250 | | | | |
| 2 | Lens 1 | 887.12207 | 0.122 | Plastic | 1.5094 | 56.477 | −0.877 |
| 3 | | 0.44723 | 0.243 | | | | |
| 4 | Ape. Stop | | 0.007 | | | | |
| 5 | Lens 2 | 0.20784 | 0.110 | Plastic | 1.5311 | 55.634 | 0.251 |
| 6 | | −0.30523 | 0.014 | | | | |
| 7 | Lens 3 | −0.90258 | 0.044 | Plastic | 1.5094 | 56.477 | −1.770 |
| 8 | | −1049.93756 | 0.046 | | | | |
| 9 | Lens 4 | Infinity | 0.122 | Plastic | 1.6349 | 23.945 | Infinity |
| 10 | | Infinity | 0.181 | | | | |
| 11 | Image | Plano | | | | | |

Table 77 shows conic constants and aspheric coefficients of each surface of each lens of Example 37.

TABLE 77

| Surface | K | A4 | A6 | A8 | A10 | A12 | A14 |
|---|---|---|---|---|---|---|---|
| 2 | −4.9999 | −1.33344E+00 | 9.10885E+00 | 3.50530E+01 | −1.01148E+03 | 0.00000E+00 | 0.00000E+00 |
| 3 | 5.0046 | 3.38057E+00 | −4.26071E+01 | −3.35800E+01 | 8.42419E+04 | 0.00000E+00 | 0.00000E+00 |
| 4 | −0.2754 | −1.31733E+01 | −1.59603E+02 | −6.22785E+03 | 1.82249E+06 | 0.00000E+00 | 0.00000E+00 |
| 5 | −0.8438 | −6.54652E−01 | −2.69637E+02 | −1.59219E+04 | −1.05563E+06 | 0.00000E+00 | 0.00000E+00 |
| 7 | 5.0030 | −1.19394E+01 | 3.77117E+02 | 8.75572E+03 | −1.64367E+06 | 0.00000E+00 | 0.00000E+00 |
| 8 | −5.0000 | 1.25277E+01 | −4.60787E+02 | −1.35695E+04 | 1.17843E+06 | 0.00000E+00 | 0.00000E+00 |
| 9 | 0.0000 | −2.73275E+01 | −4.83051E+02 | −9.07799E+04 | −8.53221E+05 | −9.24295E+07 | −8.85587E+09 |
| 10 | 0.0000 | 6.38544E+00 | −1.49836E+03 | 1.84095E+04 | −4.74440E+04 | −1.73698E+06 | −5.38093E+07 |

FIG. 138 shows spherical aberrations. The horizontal axis of FIG. 138 represents a position at which a ray that travels parallel to the optical axis and enters the imaging optical system intersects with the optical axis. The vertical axis of FIG. 138 represents distance of the above-described ray from the optical axis. The value of distance is normalized by the radius of the aperture. In other words, the value 1 on the vertical axis represents the radius of the aperture. In FIG. 138, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

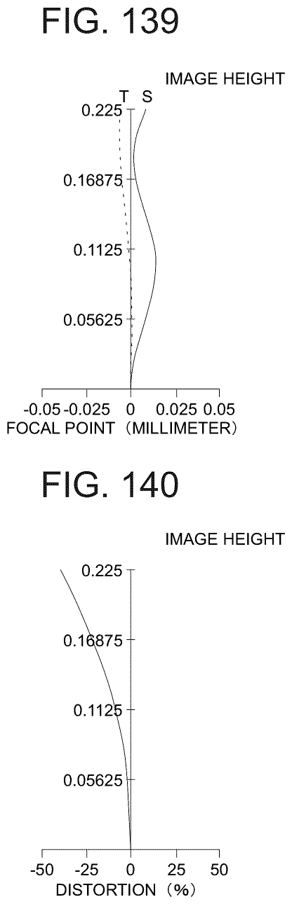

FIG. 139 shows astigmatism of the ray of wavelength of 0.580 micrometers. The horizontal axis of FIG. 139 represents a position in the optical axis direction of the focal point. The vertical axis of FIG. 139 represents image height. The solid line in FIG. 139 represents the graph of the sagittal plane, and the broken line in FIG. 139 represents the graph of the tangential plane.

FIG. 140 shows distortion of the ray of wavelength of 0.580 micrometers. The horizontal axis of FIG. 140 represents distortion. The unit is percent. The vertical axis of FIG. 140 represents image height.

### Example 38

Example 38 is identical with Example 11.

### Example 39

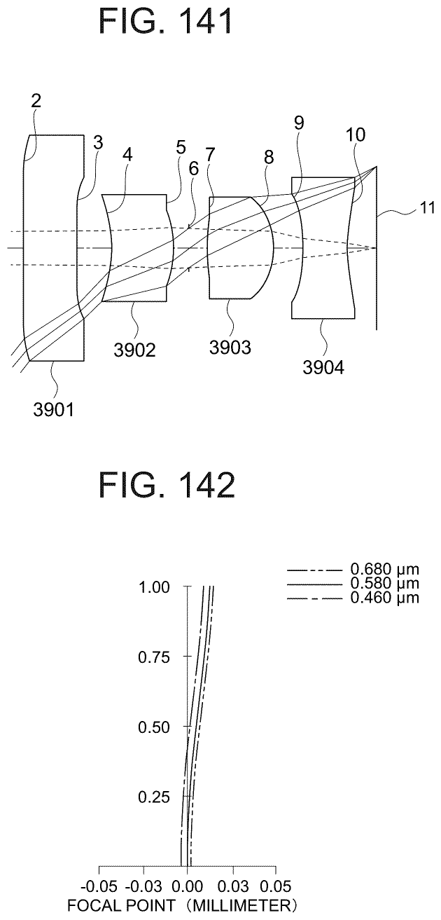

FIG. 141 shows a layout of an imaging optical system of Example 39. The imaging optical system includes four lenses arranged from the object side to the image side. The first lens 3901 is an aspheric lens in which radius of curvature of each of both surfaces is infinity in the paraxial region and which has a power in the peripheral area. The second lens 3902 is a positive meniscus lens which is convex toward the image. The third lens 3903 is a biconvex lens. The fourth lens 3904 is a biconcave lens. The aperture stop 6 is located between the second lens 3902 and the third lens 3903.

Table 78 shows positions of the optical elements and properties and values of focal length of the lenses of the imaging optical system of Example 39. The focal length f of the whole imaging optical system is given by f=0.269372. The F-number Fno is given by Fno=3.05596. HFOV representing a half value of angle of view is given by HFOV=50 (degrees). In Table 78, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 78

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.139 | Plastic | 1.5311 | 55.634 | Infinity |
| 3 | | Infinity | 0.093 | | | | |
| 4 | Lens 2 | −0.37858 | 0.163 | Plastic | 1.5311 | 55.634 | 1.020 |
| 5 | | −0.25631 | 0.043 | | | | |
| 6 | Ape. Stop | | 0.049 | | | | |
| 7 | Lens 3 | 0.57184 | 0.175 | Plastic | 1.5094 | 56.477 | 0.275 |
| 8 | | −0.16687 | 0.077 | | | | |
| 9 | Lens 4 | −0.72462 | 0.117 | Plastic | 1.6349 | 23.945 | −0.372 |
| 10 | | 0.37367 | 0.078 | | | | |
| 11 | Image | Plano | | | | | |

Table 79 shows conic constants and aspheric coefficients of each surface of each lens of Example 39.

TABLE 79

| Surface | K | A4 | A6 | A8 | A10 | A12 | A14 |
|---|---|---|---|---|---|---|---|
| 2 | 0.0000 | −2.02874E+00 | 5.31847E+01 | 6.96082E+01 | −2.93001E+03 | 8.01404E+03 | 3.16734E+04 |
| 3 | 0.0000 | 1.07995E+01 | −2.14081E+02 | 1.05685E+04 | 5.95916E+04 | −4.91099E+05 | −1.02431E+07 |
| 4 | −2.0013 | 4.57563E+00 | −2.87780E+01 | −7.54770E+03 | −8.67780E+04 | 0.00000E+00 | 0.00000E+00 |
| 5 | −2.8590 | 2.11352E+01 | −2.77910E+03 | 9.76369E+04 | −1.00131E+06 | 0.00000E+00 | 0.00000E+00 |
| 7 | −5.0044 | −3.16333E+01 | 1.00447E+03 | −1.18231E+05 | −1.30471E+06 | 0.00000E+00 | 0.00000E+00 |
| 8 | 0.0841 | 2.15430E+01 | −4.18325E+02 | 2.63100E+04 | 7.13290E+04 | 0.00000E+00 | 0.00000E+00 |
| 9 | 5.0002 | −2.96406E+01 | 1.59117E+02 | −6.28915E+03 | −8.39654E+04 | 0.00000E+00 | 0.00000E+00 |
| 10 | −5.1034 | −5.57454E+00 | −4.25539E+02 | 4.50286E+03 | 1.32437E+04 | 0.00000E+00 | 0.00000E+00 |

FIG. 142 shows spherical aberrations. The horizontal axis of FIG. 142 represents a position at which a ray that travels parallel to the optical axis and enters the imaging optical system intersects with the optical axis. The vertical axis of FIG. 142 represents distance of the above-described ray from the optical axis. The value of distance is normalized by the radius of the aperture. In other words, the value 1 on the vertical axis represents the radius of the aperture. In FIG. 142, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

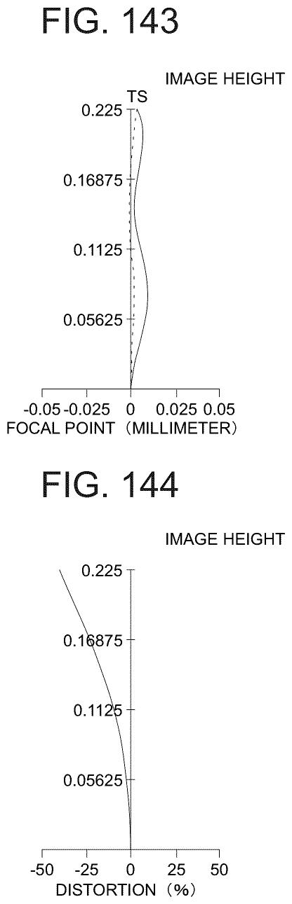

FIG. 143 shows astigmatism of the ray of wavelength of 0.580 micrometers. The horizontal axis of FIG. 143 represents a position in the optical axis direction of the focal point. The vertical axis of FIG. 143 represents image height. The solid line in FIG. 143 represents the graph of the sagittal plane, and the broken line in FIG. 143 represents the graph of the tangential plane.

FIG. 144 shows distortion of the ray of wavelength of 0.580 micrometers. The horizontal axis of FIG. 144 represents distortion. The unit is percent. The vertical axis of FIG. 144 represents image height.

### Example 40

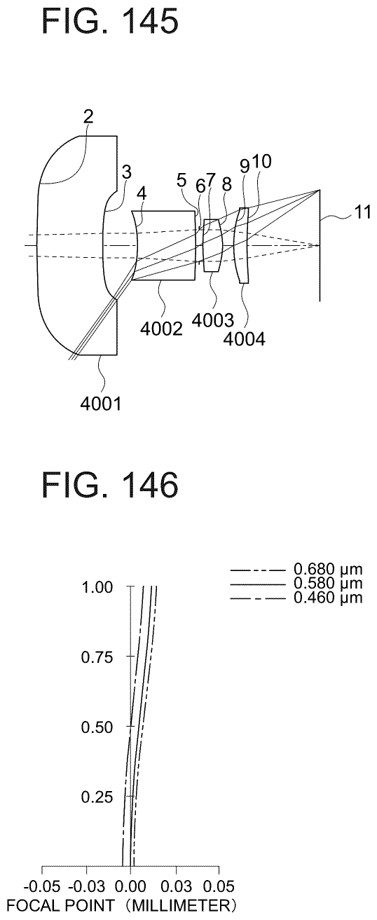

FIG. 145 shows a layout of an imaging optical system of Example 40. The imaging optical system includes four lenses arranged from the object side to the image side. The first lens 4001 is an aspheric lens in which radius of curvature of each of both surfaces is infinity in the paraxial region and which has a power in the peripheral area. The second lens 4002 is a negative meniscus lens which is convex toward the image. The third lens 4003 is a biconvex lens. The fourth lens 4004 is a positive meniscus lens which is convex toward the object. The aperture stop 6 is located between the second lens 4002 and the third lens 4003.

Table 80 shows positions of the optical elements and properties and values of focal length of the lenses of the imaging optical system of Example 40. The focal length f of the whole imaging optical system is given by f=0.277017. The F-number Fno is given by Fno=2.97364. HFOV representing a half value of angle of view is given by HFOV=50 (degrees). In Table 80, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 80

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.256 | Plastic | 1.5311 | 55.634 | Infinity |
| 3 | | Infinity | 0.135 | | | | |
| 4 | Lens 2 | −0.47096 | 0.225 | Plastic | 1.6349 | 23.945 | −1.719 |
| 5 | | −0.98085 | 0.013 | | | | |
| 6 | Ape. Stop | | 0.016 | | | | |
| 7 | Lens 3 | 0.67490 | 0.075 | Plastic | 1.5094 | 56.477 | 0.403 |
| 8 | | −0.28448 | 0.043 | | | | |
| 9 | Lens 4 | 0.39436 | 0.052 | Plastic | 1.5311 | 55.634 | 0.961 |
| 10 | | 1.64637 | 0.283 | | | | |
| 11 | Image | Plano | | | | | |

Table 81 shows conic constants and aspheric coefficients of each surface of each lens of Example 40.

TABLE 81

| Surface | K | A4 | A6 | A8 | A10 | A12 | A14 |
|---|---|---|---|---|---|---|---|
| 2 | 0.0000 | 2.94103E+00 | 1.12236E+01 | −5.83531E+01 | 1.05964E+02 | 1.32726E+03 | −7.25650E+02 |
| 3 | 0.0000 | 1.65956E+01 | −4.00734E+01 | 4.37058E+03 | 2.15037E+04 | −3.18047E+05 | 2.19163E+07 |
| 4 | 0.2949 | 1.64580E+00 | −2.38128E+02 | −8.44093E+03 | −3.41651E+04 | 2.26888E+06 | 3.75129E+08 |
| 5 | −5.0002 | 1.40153E+01 | −1.29395E+02 | −5.27394E+03 | −1.02198E+06 | −1.19775E+08 | 2.35344E+10 |
| 7 | −4.3076 | −1.16720E+00 | 8.37502E+02 | 3.12380E+04 | −1.05839E+06 | 1.48292E+07 | 3.74777E+10 |
| 8 | −0.9111 | 4.38328E+00 | −7.36792E+02 | 5.70086E+04 | −1.46149E+06 | 5.98907E+07 | 1.55819E+10 |
| 9 | −1.2558 | −2.74314E+00 | 1.42268E+02 | −2.55693E+03 | −5.16755E+04 | −3.74422E+06 | −1.60743E+08 |
| 10 | −5.0000 | −4.40308E−01 | −2.01522E+02 | 5.69700E+03 | 1.26405E+04 | −2.65327E+06 | −3.24914E+08 |

FIG. 146 shows spherical aberrations. The horizontal axis of FIG. 146 represents a position at which a ray that travels parallel to the optical axis and enters the imaging optical system intersects with the optical axis. The vertical axis of FIG. 146 represents distance of the above-described ray from the optical axis. The value of distance is normalized by the radius of the aperture. In other words, the value 1 on the vertical axis represents the radius of the aperture. In FIG. 146, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

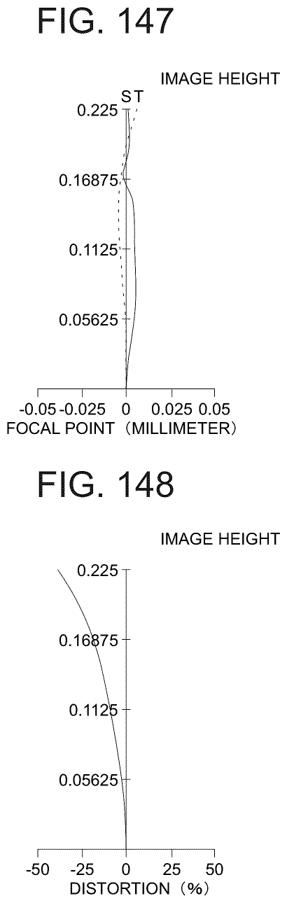

FIG. 147 shows astigmatism of the ray of wavelength of 0.580 micrometers. The horizontal axis of FIG. 147 represents a position in the optical axis direction of the focal point. The vertical axis of FIG. 147 represents image height. The solid line in FIG. 147 represents the graph of the sagittal plane, and the broken line in FIG. 147 represents the graph of the tangential plane.

FIG. 148 shows distortion of the ray of wavelength of 0.580 micrometers. The horizontal axis of FIG. 148 represents distortion. The unit is percent. The vertical axis of FIG. 148 represents image height.

### Example 41

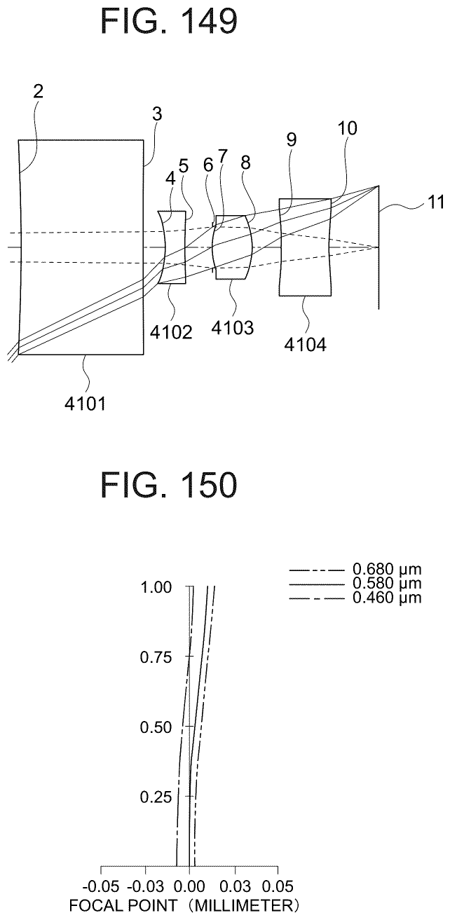

FIG. 149 shows a layout of an imaging optical system of Example 41. The imaging optical system includes four lenses arranged from the object side to the image side. The first lens 4101 is an aspheric lens in which radius of curvature of each of both surfaces is infinity in the paraxial region and which has a power in the peripheral area. The second lens 4102 is a biconcave lens. The third lens 4103 is a biconvex lens. The fourth lens 4104 is a negative meniscus lens which is convex toward the object. The aperture stop 6 is located between the second lens 4102 and the third lens 4103.

Table 82 shows positions of the optical elements and properties and values of focal length of the lenses of the imaging optical system of Example 41. The focal length f of the whole imaging optical system is given by f=0.305229. The F-number Fno is given by Fno=2.99459. HFOV representing a half value of angle of view is given by HFOV=50 (degrees). In Table 82, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 82

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.419 | Plastic | 1.6349 | 23.945 | Infinity |
| 3 | | Infinity | 0.081 | | | | |
| 4 | Lens 2 | −0.25382 | 0.068 | Plastic | 1.5311 | 55.634 | −0.470 |
| 5 | | 17.35830 | 0.091 | | | | |
| 6 | Ape. Stop | | 0.000 | | | | |
| 7 | Lens 3 | 0.21301 | 0.141 | Plastic | 1.5094 | 56.477 | 0.246 |
| 8 | | 0.23814 | 0.098 | | | | |
| 9 | Lens 4 | 1341.69296 | 0.168 | Plastic | 1.5311 | 55.634 | −1.891 |
| 10 | | 1.00540 | 0.165 | | | | |
| 11 | Image | Plano | | | | | |

Table 83 shows conic constants and aspheric coefficients of each surface of each lens of Example 41.

TABLE 83

| Surface | K | A4 | A6 | A8 | A10 | A12 | A14 |
|---|---|---|---|---|---|---|---|
| 2 | 0.0000 | −1.07236E+00 | 4.72552E+00 | 5.79043E+00 | −3.07909E+01 | −4.11761E+02 | 2.44928E+02 |
| 3 | 0.0000 | 3.40328E+00 | 2.05398E+01 | 1.06013E+03 | −4.36215E+03 | −2.09533E+06 | −5.49045E+05 |
| 4 | −3.4877 | −1.51825E+00 | −5.87416E+01 | −8.26229E+02 | −2.69532E+04 | −9.33040E+05 | −5.18374E+06 |
| 5 | 4.9996 | 1.75822E+00 | 2.18023E+02 | 2.56978E+04 | 1.84156E+05 | 1.24190E+07 | 4.41691E+08 |
| 7 | −3.3106 | −1.59838E+00 | 2.42849E+01 | 8.12427E+03 | −5.96664E+05 | 2.30104E+06 | 6.32961E+09 |
| 8 | −0.0195 | 1.30775E+01 | 4.24054E+01 | −1.77856E+04 | −1.54939E+05 | 1.20256E+07 | 1.57603E+09 |
| 9 | −5.0000 | −9.52078E+00 | −1.96386E+02 | −7.81006E+03 | −6.91880E+04 | −1.02309E+07 | −8.40604E+08 |
| 10 | −0.3508 | −7.45241E+00 | −1.62050E+02 | 4.95036E+03 | −7.30372E+03 | −1.25600E+06 | −7.74246E+07 |

FIG. 150 shows spherical aberrations. The horizontal axis of FIG. 150 represents a position at which a ray that travels parallel to the optical axis and enters the imaging optical system intersects with the optical axis. The vertical axis of FIG. 150 represents distance of the above-described ray from the optical axis. The value of distance is normalized by the radius of the aperture. In other words, the value 1 on the vertical axis represents the radius of the aperture. In FIG. 150, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

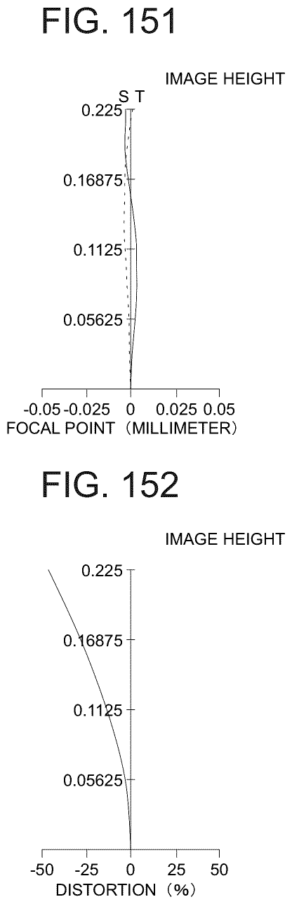

FIG. 151 shows astigmatism of the ray of wavelength of 0.580 micrometers. The horizontal axis of FIG. 151 represents a position in the optical axis direction of the focal point. The vertical axis of FIG. 151 represents image height. The solid line in FIG. 151 represents the graph of the sagittal plane, and the broken line in FIG. 151 represents the graph of the tangential plane.

FIG. 152 shows distortion of the ray of wavelength of 0.580 micrometers. The horizontal axis of FIG. 152 represents distortion. The unit is percent. The vertical axis of FIG. 152 represents image height.

### Example 42

Example 42 is identical with Example 14.

### Example 43

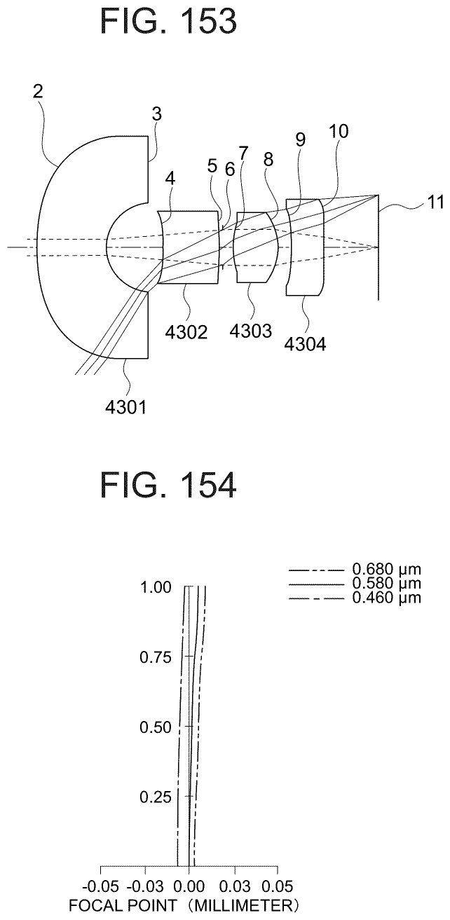

FIG. 153 shows a layout of an imaging optical system of Example 43. The imaging optical system includes four lenses arranged from the object side to the image side. The first lens 4301 is a negative meniscus lens which is convex toward the object. The second lens 4302 is a negative meniscus lens which is convex toward the image. The third lens 4303 is a biconvex lens. The fourth lens 4304 is an aspheric lens in which radius of curvature of each of both surfaces is infinity in the paraxial region and which has a power in the peripheral area. The aperture stop 6 is located between the second lens 4302 and the third lens 4303.

Table 84 shows positions of the optical elements and properties and values of focal length of the lenses of the imaging optical system of Example 43. The focal length f of the whole imaging optical system is given by f=0.18114. The F-number Fno is given by Fno=2.88205. HFOV representing a half value of angle of view is given by HFOV=50 (degrees). In Table 84, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 84

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | 0.96367 | 0.282 | Plastic | 1.5311 | 55.634 | −0.477 |
| 3 | | 0.18051 | 0.225 | | | | |
| 4 | Lens 2 | −0.48626 | 0.224 | Plastic | 1.6349 | 23.945 | −5.494 |
| 5 | | −0.66610 | 0.014 | | | | |
| 6 | Ape. Stop | | 0.043 | | | | |
| 7 | Lens 3 | 0.34649 | 0.184 | Plastic | 1.5094 | 56.477 | 0.290 |
| 8 | | −0.21147 | 0.051 | | | | |
| 9 | Lens 4 | Infinity | 0.131 | Plastic | 1.5311 | 55.634 | Infinity |
| 10 | | Infinity | 0.217 | | | | |
| 11 | Image | Plano | | | | | |

Table 85 shows conic constants and aspheric coefficients of each surface of each lens of Example 43.

TABLE 85

| Surface | K | A4 | A6 | A8 | A10 | A12 | A14 |
|---|---|---|---|---|---|---|---|
| 2 | 3.6550 | 1.05145E+00 | 8.46443E+00 | −2.19690E+00 | −4.99472E+00 | 1.27739E+02 | 1.18802E+03 |
| 3 | −0.0920 | −8.79703E+00 | 4.79052E+02 | 1.01611E+04 | 2.04482E+04 | 4.82695E+06 | 2.24591E+08 |
| 4 | −0.5088 | −8.70485E+00 | 4.55807E+00 | 1.47714E+03 | 7.00866E+03 | 4.59873E+05 | −6.20326E+07 |
| 5 | −4.7599 | 5.69374E+00 | 6.37678E+02 | −1.65362E+04 | −6.44412E+05 | 6.46527E+06 | 8.85142E+09 |
| 7 | −1.7299 | −3.04086E+00 | −1.28631E+02 | 2.17232E+04 | 1.85936E+04 | 2.02916E+06 | 1.70969E+08 |
| 8 | −0.1275 | 1.08914E+01 | −1.11309E+02 | 6.98923E+03 | 7.24333E+03 | 1.15574E+06 | 6.43077E+07 |
| 9 | 0.0000 | −2.15105E+01 | 2.59224E+02 | −3.92086E+04 | 4.42611E+04 | −1.25663E+06 | −2.28419E+08 |
| 10 | 0.0000 | 2.57990E−01 | −3.89272E+02 | −3.75451E+03 | −3.54150E+03 | 1.61161E+05 | 1.08553E+07 |

FIG. 154 shows spherical aberrations. The horizontal axis of FIG. 154 represents a position at which a ray that travels parallel to the optical axis and enters the imaging optical system intersects with the optical axis. The vertical axis of FIG. 154 represents distance of the above-described ray from the optical axis. The value of distance is normalized by the radius of the aperture. In other words, the value 1 on the vertical axis represents the radius of the aperture. In FIG. 154, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

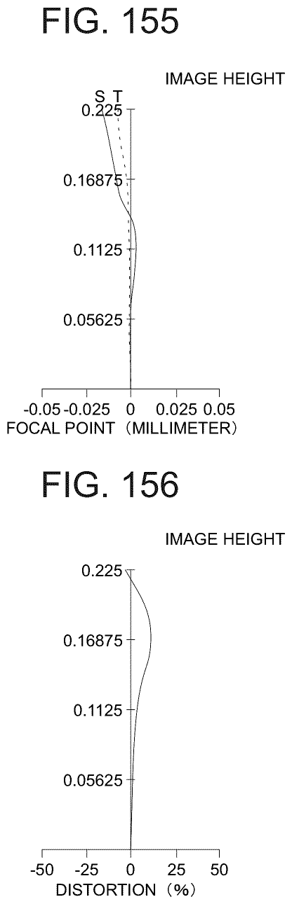

FIG. 155 shows astigmatism of the ray of wavelength of 0.580 micrometers. The horizontal axis of FIG. 155 represents a position in the optical axis direction of the focal point. The vertical axis of FIG. 155 represents image height. The solid line in FIG. 155 represents the graph of the sagittal plane, and the broken line in FIG. 155 represents the graph of the tangential plane.

FIG. 156 shows distortion of the ray of wavelength of 0.580 micrometers. The horizontal axis of FIG. 156 represents distortion. The unit is percent. The vertical axis of FIG. 156 represents image height.

### Example 44

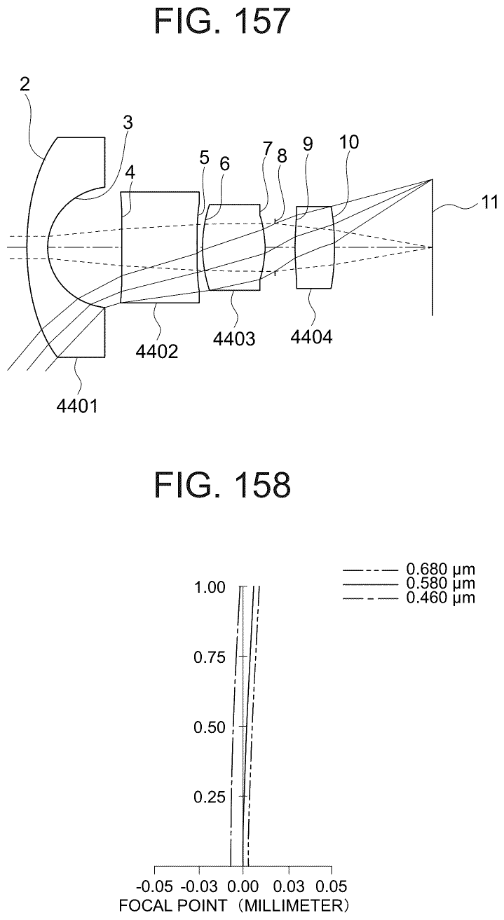

FIG. 157 shows a layout of an imaging optical system of Example 44. The imaging optical system includes four lenses arranged from the object side to the image side. The first lens 4401 is a negative meniscus lens which is convex toward the object. The second lens 4402 is an aspheric lens in which radius of curvature of each of both surfaces is infinity in the paraxial region and which has a power in the peripheral area. Each of the third lens 4403 and the fourth lens 4404 is a biconvex lens. The aperture stop 8 is located between the third lens 4403 and the fourth lens 4404.

Table 86 shows positions of the optical elements and properties and values of focal length of the lenses of the imaging optical system of Example 44. The focal length f of the whole imaging optical system is given by f=0.216924. The F-number Fno is given by Fno=2.88715. HFOV representing a half value of angle of view is given by HFOV=50 (degrees). In Table 86, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 86

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | 0.95326 | 0.065 | Plastic | 1.5311 | 55.634 | −0.437 |
| 3 | | 0.18245 | 0.230 | | | | |
| 4 | Lens 2 | Infinity | 0.235 | Plastic | 1.6349 | 23.945 | Infinity |
| 5 | | Infinity | 0.016 | | | | |
| 6 | Lens 3 | 0.49476 | 0.194 | Plastic | 1.5094 | 56.477 | 0.398 |
| 7 | | −0.29839 | 0.031 | | | | |
| 8 | Ape. Stop | | 0.063 | | | | |
| 9 | Lens 4 | 0.924 | 0.122 | Plastic | 1.5311 | 55.634 | 0.896 |
| 10 | | −0.940 | 0.300 | | | | |
| 11 | Image | Plano | | | | | |

Table 87 shows conic constants and aspheric coefficients of each surface of each lens of Example 44.

TABLE 87

| Surface | K | A4 | A6 | A8 | A10 | A12 | A14 |
|---|---|---|---|---|---|---|---|
| 2 | 4.9886 | 9.16237E−01 | −4.52003E−01 | 6.24558E−01 | −2.09003E+00 | −1.28951E+01 | −7.87980E+01 |
| 3 | −0.0589 | −3.84599E−03 | −7.38015E+00 | 4.61749E+01 | 8.88765E+00 | 9.12365E+03 | 1.19727E+06 |
| 4 | 0.0000 | −2.75751E+00 | 1.58458E+01 | 3.96672E+02 | 9.28410E+02 | 6.89404E+04 | 3.06066E+06 |
| 5 | 0.0000 | 1.19789E+01 | −2.28633E+01 | 2.31939E+03 | 4.88215E+03 | 1.80421E+05 | 4.26252E+06 |
| 7 | 2.1340 | 2.90420E+00 | 2.08030E+01 | −1.25353E+02 | −6.54735E+03 | −2.20330E+05 | −3.39674E+06 |
| 8 | −0.1387 | 6.63895E−01 | 6.19317E+01 | 7.45610E+01 | −1.27697E+03 | −3.48928E+05 | −3.09901E+07 |
| 9 | −5.0027 | −8.46033E+00 | −1.00569E+02 | 9.21717E+01 | −4.11820E+03 | −8.80728E+05 | 1.33518E+07 |
| 10 | 0.6390 | −2.67558E−01 | −1.72411E+02 | −3.73966E+02 | 4.28794E+03 | 1.06165E+06 | 7.19750E+07 |

FIG. 158 shows spherical aberrations. The horizontal axis of FIG. 158 represents a position at which a ray that travels parallel to the optical axis and enters the imaging optical system intersects with the optical axis. The vertical axis of FIG. 158 represents distance of the above-described ray from the optical axis. The value of distance is normalized by the radius of the aperture. In other words, the value 1 on the vertical axis represents the radius of the aperture. In FIG. 158, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

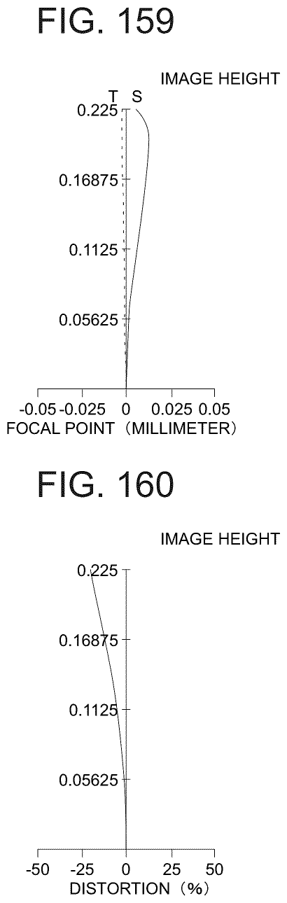

FIG. 159 shows astigmatism of the ray of wavelength of 0.580 micrometers. The horizontal axis of FIG. 159 represents a position in the optical axis direction of the focal point. The vertical axis of FIG. 159 represents image height. The solid line in FIG. 159 represents the graph of the sagittal plane, and the broken line in FIG. 159 represents the graph of the tangential plane.

FIG. 160 shows distortion of the ray of wavelength of 0.580 micrometers. The horizontal axis of FIG. 160 represents distortion. The unit is percent. The vertical axis of FIG. 160 represents image height.

### Example 45

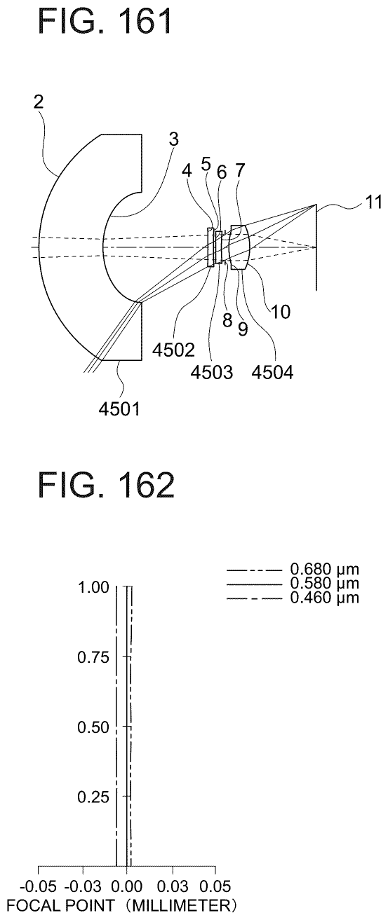

FIG. 161 shows a layout of an imaging optical system of Example 45. The imaging optical system includes four lenses arranged from the object side to the image side. The first lens 4501 is a negative meniscus lens which is convex toward the object. The second lens 4502 is an aspheric lens in which radius of curvature of each of both surfaces is infinity in the paraxial region and which has a power in the peripheral area. Each of the third lens 4503 and the fourth lens 4504 is a biconvex lens. The aperture stop 8 is located between the third lens 4503 and the fourth lens 4504.

Table 88 shows positions of the optical elements and properties and values of focal length of the lenses of the imaging optical system of Example 45. The focal length f of the whole imaging optical system is given by f=0.310707. The F-number Fno is given by Fno=2.92234. HFOV representing a half value of angle of view is given by HFOV=50 (degrees). In Table 88, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 88

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | 0.65851 | 0.320 | Plastic | 1.6349 | 23.945 | −2.186 |
| 3 | | 0.36254 | 0.524 | | | | |
| 4 | Lens 2 | Infinity | 0.026 | Plastic | 1.5094 | 56.477 | Infinity |
| 5 | | Infinity | 0.013 | | | | |
| 6 | Lens 3 | 3848.16509 | 0.027 | Plastic | 1.5311 | 55.634 | 121.800 |
| 7 | | −65.90627 | 0.019 | | | | |
| 8 | Ape. Stop | | 0.020 | | | | |
| 9 | Lens 4 | 0.364 | 0.100 | Plastic | 1.5311 | 55.634 | 0.302 |
| 10 | | −0.261 | 0.330 | | | | |
| 11 | Image | Plano | | | | | |

Table 89 shows conic constants and aspheric coefficients of each surface of each lens of Example 45.

TABLE 89

| Surface | K | A4 | A6 | A8 | A10 | A12 | A14 |
|---|---|---|---|---|---|---|---|
| 2 | 0.2054 | −1.58810E−01 | 1.80278E−01 | −1.66097E+00 | −6.68150E−01 | 8.08923E−01 | 1.45760E+01 |
| 3 | 0.8443 | −2.88641E−01 | 3.46617E+01 | −3.55901E+02 | 1.07842E+02 | 3.41541E+03 | 7.20289E+04 |
| 4 | 0.0000 | −1.01405E+01 | 1.11798E+02 | 2.11385E+04 | 5.77631E+05 | 9.10375E+06 | 7.28692E+08 |
| 5 | 0.0000 | 8.26591E+00 | 5.76954E+02 | −1.89695E+04 | 2.38235E+06 | −7.03297E+06 | 1.18098E+09 |
| 7 | −4.1228 | 6.41622E+00 | 4.15709E+02 | 2.03930E+03 | −6.81459E+04 | −1.25371E+07 | −1.74138E+09 |
| 8 | −4.9996 | 4.34460E+00 | 2.10906E+02 | 2.53140E+04 | 1.45981E+05 | 1.68924E+07 | 3.09738E+09 |
| 9 | 3.9396 | −1.05089E+01 | −4.49181E+02 | 2.67308E+04 | 8.38383E+04 | 2.51674E+07 | 8.21000E+09 |
| 10 | −0.0836 | 1.04378E+01 | 2.31371E+02 | 1.90503E+04 | 2.09181E+04 | 1.37851E+06 | 4.86777E+08 |

FIG. 162 shows spherical aberrations. The horizontal axis of FIG. 162 represents a position at which a ray that travels parallel to the optical axis and enters the imaging optical system intersects with the optical axis. The vertical axis of FIG. 162 represents distance of the above-described ray from the optical axis. The value of distance is normalized by the radius of the aperture. In other words, the value 1 on the vertical axis represents the radius of the aperture. In FIG. 162, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

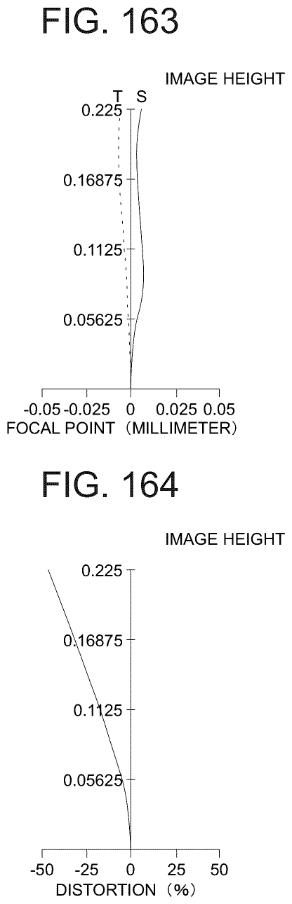

FIG. 163 shows astigmatism of the ray of wavelength of 0.580 micrometers. The horizontal axis of FIG. 163 represents a position in the optical axis direction of the focal point. The vertical axis of FIG. 163 represents image height. The solid line in FIG. 163 represents the graph of the sagittal plane, and the broken line in FIG. 163 represents the graph of the tangential plane.

FIG. 164 shows distortion of the ray of wavelength of 0.580 micrometers. The horizontal axis of FIG. 164 represents distortion. The unit is percent. The vertical axis of FIG. 164 represents image height.

### Example 46

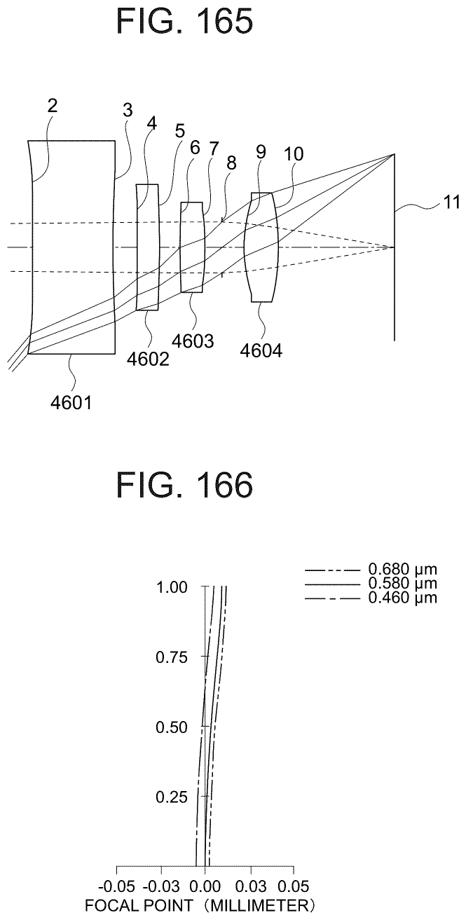

FIG. 165 shows a layout of an imaging optical system of Example 46. The imaging optical system includes four lenses arranged from the object side to the image side. The first lens 4601 is an aspheric lens in which radius of curvature of each of both surfaces is infinity in the paraxial region and which has a power in the peripheral area. Each of the second lens 4602, the third lens 4603 and the fourth lens 4604 is a biconvex lens. The aperture stop 8 is located between the third lens 4603 and the fourth lens 4604.

Table 90 shows positions of the optical elements and properties and values of focal length of the lenses of the imaging optical system of Example 46. The focal length f of the whole imaging optical system is given by f=0.316659. The F-number Fno is given by Fno=3.03055. HFOV representing a half value of angle of view is given by HFOV=50 (degrees). In Table 90, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 90

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.182 | Plastic | 1.6349 | 23.945 | Infinity |
| 3 | | Infinity | 0.055 | | | | |
| 4 | Lens 2 | 1814.542 | 0.050 | Plastic | 1.5094 | 56.477 | 4.989 |
| 5 | | −2.658 | 0.049 | | | | |
| 6 | Lens 3 | 35.11593 | 0.053 | Plastic | 1.5311 | 55.634 | 1.200 |
| 7 | | −0.62312 | 0.041 | | | | |
| 8 | Ape. Stop | | 0.049 | | | | |
| 9 | Lens 4 | 0.295 | 0.078 | Plastic | 1.5311 | 55.634 | 0.410 |
| 10 | | −0.759 | 0.263 | | | | |
| 11 | Image | Plano | | | | | |

Table 91 shows conic constants and aspheric coefficients of each surface of each lens of Example 46.

TABLE 91

| Surface | K | A4 | A6 | A8 | A10 | A12 | A14 |
|---|---|---|---|---|---|---|---|
| 2 | 0.0000 | −4.39695E+00 | −1.54554E+00 | 1.94345E+02 | −2.29703E+03 | −4.38232E+03 | −1.36838E+05 |
| 3 | 0.0000 | 6.04822E+00 | −5.84076E+00 | 1.27846E+02 | 1.69011E+04 | −2.41107E+05 | −1.00821E+07 |
| 4 | 3.0470 | −8.48762E−01 | −1.55603E+02 | −4.27763E+02 | −9.62051E+02 | 5.20706E+05 | 6.86142E+07 |
| 5 | −3.3957 | −8.94228E−01 | 1.71743E+02 | 5.27626E+02 | 7.06862E+04 | 5.72912E+06 | 5.54875E+07 |
| 7 | −4.6262 | 5.61153E+00 | 6.88555E+02 | 4.20708E+03 | −6.51623E+05 | −8.57831E+07 | −3.98639E+09 |
| 8 | −3.6682 | −5.45953E+00 | −6.25516E+02 | −2.00446E+04 | −4.50176E+05 | 2.42577E+07 | −2.69602E+00 |
| 9 | −5.0095 | −4.66294E+00 | −4.60403E+03 | −2.17188E+03 | −4.16188E+05 | −8.06771E+06 | 3.68025E+09 |
| 10 | 5.0001 | 8.15730E−01 | −1.22371E+03 | −2.44232E+03 | 1.43095E+05 | 1.36546E+07 | 3.01345E+08 |

FIG. 166 shows spherical aberrations. The horizontal axis of FIG. 166 represents a position at which a ray that travels parallel to the optical axis and enters the imaging optical system intersects with the optical axis. The vertical axis of FIG. 166 represents distance of the above described ray from the optical axis. The value of distance is normalized by the radius of the aperture. In other words, the value 1 on the vertical axis represents the radius of the aperture. In FIG. 166, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

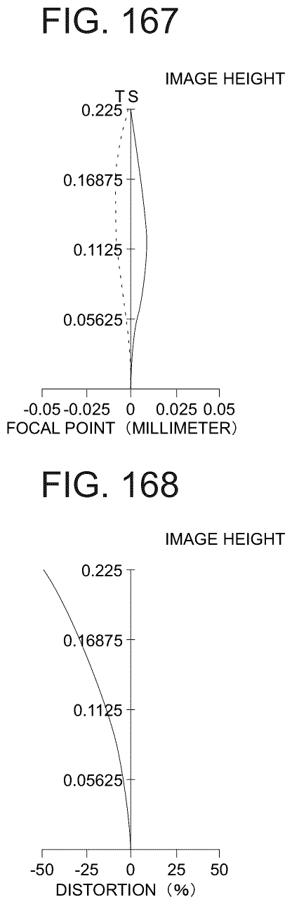

FIG. 167 shows astigmatism of the ray of wavelength of 0.580 micrometers. The horizontal axis of FIG. 167 represents a position in the optical axis direction of the focal point. The vertical axis of FIG. 167 represents image height. The solid line in FIG. 167 represents the graph of the sagittal plane, and the broken line in FIG. 167 represents the graph of the tangential plane.

FIG. 168 shows distortion of the ray of wavelength of 0.580 micrometers. The horizontal axis of FIG. 168 represents distortion. The unit is percent. The vertical axis of FIG. 168 represents image height.

### Example 47

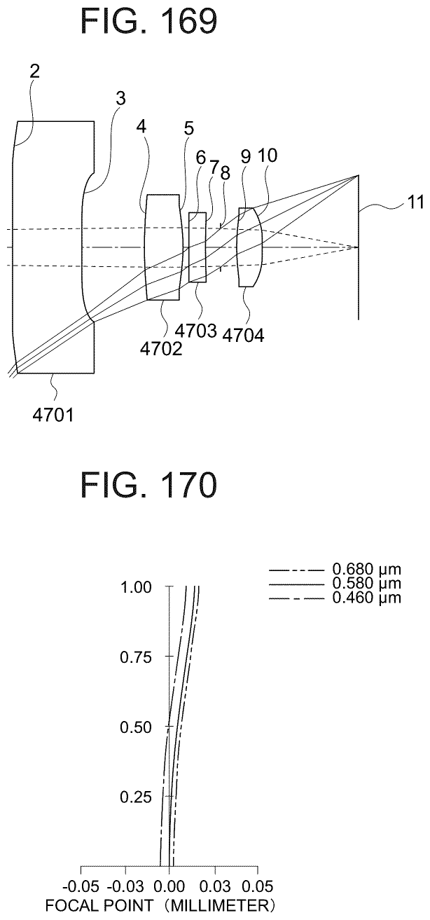

FIG. 169 shows a layout of an imaging optical system of Example 47. The imaging optical system includes four lenses arranged from the object side to the image side. The first lens 4701 is an aspheric lens in which radius of curvature of each of both surfaces is infinity in the paraxial region and which has a power in the peripheral area. Each of the second lens 4702 and the fourth lens 4704 is a biconvex lens. The third lens 4703 is a biconcave lens. The aperture stop 8 is located between the third lens 4703 and the fourth lens 4704.

Table 92 shows positions of the optical elements and properties and values of focal length of the lenses of the imaging optical system of Example 47. The focal length f of the whole imaging optical system is given by f=0.323688. The F-number Fno is given by Fno=3.04922. HFOV representing a half value of angle of view is given by HFOV=50 (degrees). In Table 92, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 92

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.205 | Plastic | 1.5311 | 55.634 | Infinity |
| 3 | | Infinity | 0.188 | | | | |
| 4 | Lens 2 | 9.760 | 0.114 | Plastic | 1.5094 | 56.477 | 1.276 |
| 5 | | −0.695 | 0.019 | | | | |
| 6 | Lens 3 | −23.16193 | 0.049 | Plastic | 1.6349 | 23.945 | −35.685 |
| 7 | | 1173.88261 | 0.044 | | | | |
| 8 | Ape. Stop | | 0.049 | | | | |
| 9 | Lens 4 | 0.476 | 0.076 | Plastic | 1.5311 | 55.634 | 0.371 |
| 10 | | −0.318 | 0.288 | | | | |
| 11 | Image | Plano | | | | | |

Table 93 shows conic constants and aspheric coefficients of each surface of each lens of Example 47.

TABLE 93

| Surface | K | A4 | A6 | A8 | A10 | A12 | A14 |
|---|---|---|---|---|---|---|---|
| 2 | 0.0000 | −1.80474E+00 | 3.25319E+01 | 7.33402E+01 | −1.86432E+03 | 2.91896E+03 | 1.02665E+04 |
| 3 | 0.0000 | 6.31312E+00 | 8.14103E+01 | 6.48192E+02 | 2.36464E+04 | 9.97100E+04 | 1.77965E+06 |
| 4 | −1.8091 | 7.70748E+00 | 9.70994E+01 | 1.30019E+02 | −7.75128E+03 | 4.25823E+05 | −2.65562E+07 |
| 5 | 0.1819 | −1.22973E+00 | 2.75316E+02 | 8.66172E+02 | 8.31942E+04 | 5.37896E+06 | 7.71158E+07 |
| 7 | 4.9999 | −3.75163E−01 | 5.09790E+02 | 6.06551E+03 | −1.66298E+05 | −3.68203E+07 | −7.62449E+08 |
| 8 | −5.0000 | 2.30010E+01 | −8.09448E+02 | −2.63151E+04 | −1.08994E+06 | 4.81360E+07 | 7.75995E+09 |
| 9 | 0.0397 | −3.08333E+01 | −3.95677E+02 | −3.09365E+03 | −7.89293E+05 | −1.91936E+07 | 1.02652E+10 |
| 10 | 0.9436 | −1.11458E+00 | −1.68806E+03 | −6.05695E+03 | 9.72509E+04 | 2.37887E+07 | 9.47976E+08 |

FIG. 170 shows spherical aberrations. The horizontal axis of FIG. 170 represents a position at which a ray that travels parallel to the optical axis and enters the imaging optical system intersects with the optical axis. The vertical axis of FIG. 170 represents distance of the above-described ray from the optical axis. The value of distance is normalized by the radius of the aperture. In other words, the value 1 on the vertical axis represents the radius of the aperture. In FIG. 170, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

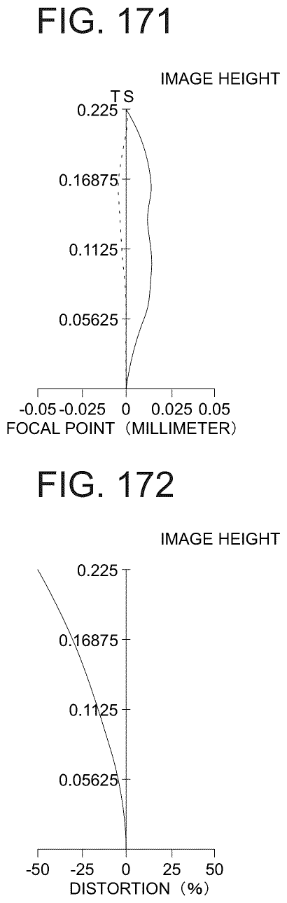

FIG. 171 shows astigmatism of the ray of wavelength of 0.580 micrometers. The horizontal axis of FIG. 171 represents a position in the optical axis direction of the focal point. The vertical axis of FIG. 171 represents image height. The solid line in FIG. 171 represents the graph of the sagittal plane, and the broken line in FIG. 171 represents the graph of the tangential plane.

FIG. 172 shows distortion of the ray of wavelength of 0.580 micrometers. The horizontal axis of FIG. 172 represents distortion. The unit is percent. The vertical axis of FIG. 172 represents image height.

### Example 48

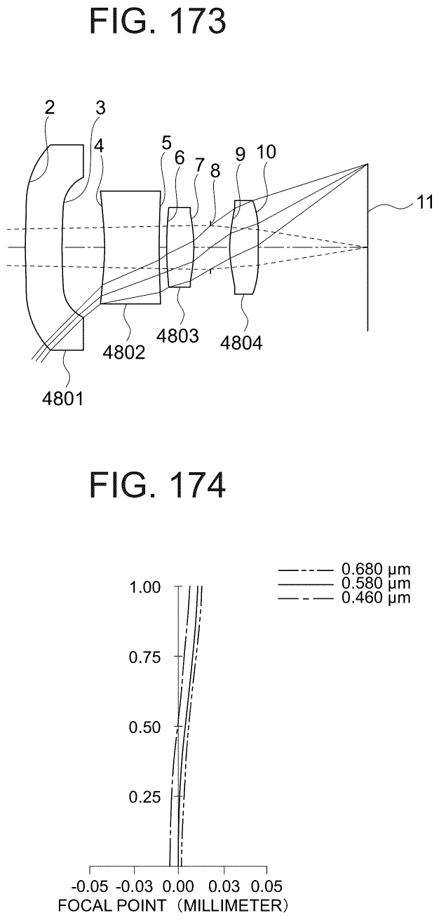

FIG. 173 shows a layout of an imaging optical system of Example 48. The imaging optical system includes four lenses arranged from the object side to the image side. The first lens 4801 is an aspheric lens in which radius of curvature of each of both surfaces is infinity in the paraxial region and which has a power in the peripheral area. The second lens 4802 is a biconcave lens. Each of the third lens 4803 and the fourth lens 4804 is a biconvex lens. The aperture stop 8 is located between the third lens 4803 and the fourth lens 4804.

Table 94 shows positions of the optical elements and properties and values of focal length of the lenses of the imaging optical system of Example 48. The focal length f of the whole imaging optical system is given by f=0.30686. The F-number Fno is given by Fno=3.02857. HFOV representing a half value of angle of view is given by HFOV=50 (degrees). In Table 94, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 94

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.094 | Plastic | 1.5311 | 55.634 | Infinity |
| 3 | | Infinity | 0.111 | | | | |
| 4 | Lens 2 | −1.728 | 0.142 | Plastic | 1.6349 | 23.945 | −2.712 |
| 5 | | 1192.280 | 0.020 | | | | |
| 6 | Lens 3 | 439.94183 | 0.069 | Plastic | 1.5094 | 56.477 | 0.844 |
| 7 | | −0.43101 | 0.042 | | | | |
| 8 | Ape. Stop | | 0.048 | | | | |
| 9 | Lens 4 | 0.289 | 0.076 | Plastic | 1.5311 | 55.634 | 0.406 |
| 10 | | −0.774 | 0.284 | | | | |
| 11 | Image | Plano | | | | | |

Table 95 shows conic constants and aspheric coefficients of each surface of each lens of Example 48.

TABLE 95

| Surface | K | A4 | A6 | A8 | A10 | A12 | A14 |
|---|---|---|---|---|---|---|---|
| 2 | 0.0000 | 7.98169E+00 | 9.10867E+01 | 1.31865E+03 | −2.81753E+04 | 4.14160E+04 | 2.27433E+05 |
| 3 | 0.0000 | 2.35790E+01 | 2.86006E+02 | 5.01790E+03 | 2.10209E+05 | 3.15581E+05 | 3.89829E+06 |
| 4 | 1.0750 | 1.10756E+00 | −3.04222E+02 | −1.81609E+03 | −7.25120E+04 | −2.65626E+06 | −9.31352E+07 |
| 5 | −4.9348 | 1.01724E+00 | 3.10571E+02 | −2.33262E+03 | −3.56825E+04 | 1.96665E+06 | 5.11331E+07 |
| 7 | 5.0007 | 1.53749E+01 | 1.29679E+03 | 7.26597E+03 | 1.06427E+05 | −9.67790E+06 | −7.54369E+08 |
| 8 | −4.9984 | 3.24789E−01 | −1.14627E+02 | −1.15040E+04 | 3.40124E+04 | 5.25794E+07 | 5.19236E+09 |
| 9 | −5.0074 | −8.77566E+00 | −1.18225E+02 | 7.67235E+03 | 8.25689E+04 | 3.34265E+06 | 2.35343E+09 |
| 10 | 5.0004 | −2.72667E+00 | −1.00307E+03 | 1.19539E+02 | 3.24766E+05 | 2.66186E+07 | 1.40737E+09 |

FIG. 174 shows spherical aberrations. The horizontal axis of FIG. 174 represents a position at which a ray that travels parallel to the optical axis and enters the imaging optical system intersects with the optical axis. The vertical axis of FIG. 174 represents distance of the above-described ray from the optical axis. The value of distance is normalized by the radius of the aperture. In other words, the value 1 on the vertical axis represents the radius of the aperture. In FIG. 174, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

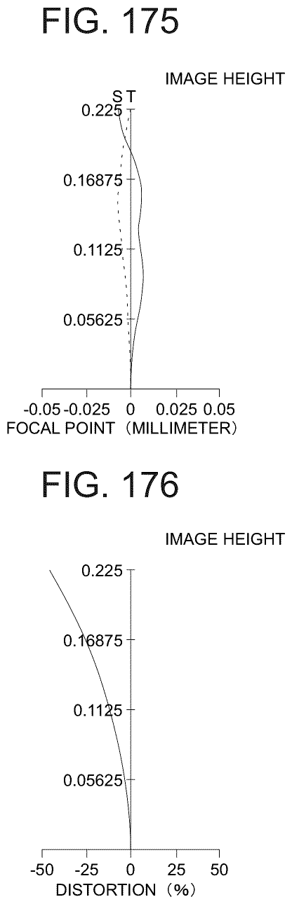

FIG. 175 shows astigmatism of the ray of wavelength of 0.580 micrometers. The horizontal axis of FIG. 175 represents a position in the optical axis direction of the focal point. The vertical axis of FIG. 175 represents image height. The solid line in FIG. 175 represents the graph of the sagittal plane, and the broken line in FIG. 175 represents the graph of the tangential plane.

FIG. 176 shows distortion of the ray of wavelength of 0.580 micrometers. The horizontal axis of FIG. 176 represents distortion. The unit is percent. The vertical axis of FIG. 176 represents image height.

### Example 49

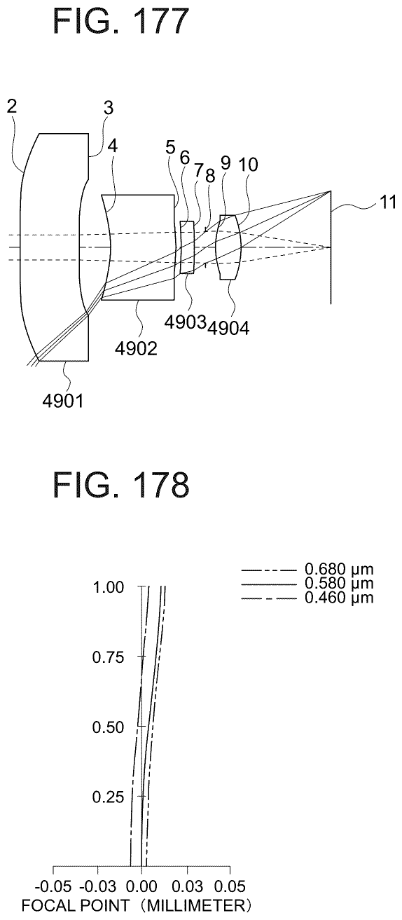

FIG. 177 shows a layout of an imaging optical system of Example 49. The imaging optical system includes four lenses arranged from the object side to the image side. The first lens 4901 is an aspheric lens in which radius of curvature of each of both surfaces is infinity in the paraxial region and which has a power in the peripheral area. The second lens 4902 is a negative meniscus lens which is convex toward the image. The third lens 4903 is a biconcave lens. The fourth lens 4904 is a biconvex lens. The aperture stop 8 is located between the third lens 4903 and the fourth lens 4904.

Table 96 shows positions of the optical elements and properties and values of focal length of the lenses of the imaging optical system of Example 49. The focal length f of the whole imaging optical system is given by f=0.293557. The F-number Fno is given by Fno=2.96821. HFOV representing a half value of angle of view is given by HFOV=50 (degrees). In Table 96, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 96

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.100 | | | | |
| 2 | Lens 1 | Infinity | 0.224 | Plastic | 1.6349 | 23.945 | Infinity |
| 3 | | Infinity | 0.119 | | | | |
| 4 | Lens 2 | −0.644 | 0.245 | Plastic | 1.5094 | 56.477 | −6.301 |
| 5 | | −0.908 | 0.019 | | | | |
| 6 | Lens 3 | −4.23162 | 0.048 | Plastic | 1.5311 | 55.634 | −7.855 |
| 7 | | 335.35163 | 0.044 | | | | |
| 8 | Ape. Stop | | 0.039 | | | | |
| 9 | Lens 4 | 0.318 | 0.096 | Plastic | 1.5311 | 55.634 | 0.317 |
| 10 | | −0.322 | 0.331 | | | | |
| 11 | Image | Plano | | | | | |

Table 97 shows conic constants and aspheric coefficients of each surface of each lens of Example 49.

TABLE 97

| Surface | K | A4 | A6 | A8 | A10 | A12 | A14 |
|---|---|---|---|---|---|---|---|
| 2 | 0.0000 | 3.71539E+00 | −1.60509E+01 | 5.28582E+01 | −9.33741E+01 | 1.26323E+02 | 1.16021E+00 |
| 3 | 0.0000 | 8.60775E+00 | −8.94806E+00 | 1.43609E+02 | −1.91485E+03 | 1.45999E+04 | 2.28060E+05 |
| 4 | 5.0069 | −1.36026E+00 | 7.02802E+00 | −7.57304E+01 | 4.64169E+02 | 7.47122E+04 | 3.55120E+06 |
| 5 | −5.0006 | 4.19697E−02 | 1.62647E+02 | 1.72171E+02 | 3.73005E+04 | 4.11963E+06 | 1.16411E+08 |
| 7 | −5.0001 | −6.44170E−01 | −7.08449E+00 | 5.03910E+02 | 1.21237E+05 | −1.77647E+07 | −1.32940E+09 |
| 8 | −5.0000 | 1.45532E+00 | −5.67715E+02 | −8.51969E+03 | −4.54744E+05 | −5.25415E+06 | 4.44813E+09 |
| 9 | −5.0082 | −4.03582E+00 | 1.28870E+02 | 5.25407E+02 | −3.38559E+04 | 2.22442E+05 | 9.15460E+08 |
| 10 | −1.3125 | 9.77287E−02 | −3.27726E+02 | −9.68924E+02 | 4.85053E+04 | 7.94343E+06 | 5.70012E+08 |

FIG. 178 shows spherical aberrations. The horizontal axis of FIG. 178 represents a position at which a ray that travels parallel to the optical axis and enters the imaging optical system intersects with the optical axis. The vertical axis of FIG. 178 represents distance of the above-described ray from the optical axis. The value of distance is normalized by the radius of the aperture. In other words, the value 1 on the vertical axis represents the radius of the aperture. In FIG. 178, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

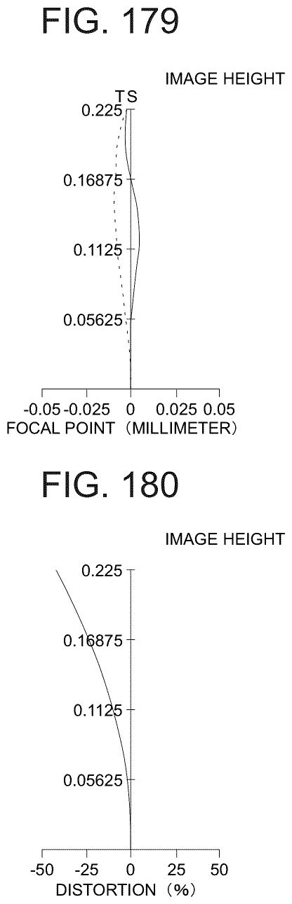

FIG. 179 shows astigmatism of the ray of wavelength of 0.580 micrometers. The horizontal axis of FIG. 179 represents a position in the optical axis direction of the focal point. The vertical axis of FIG. 179 represents image height. The solid line in FIG. 179 represents the graph of the sagittal plane, and the broken line in FIG. 179 represents the graph of the tangential plane.

FIG. 180 shows distortion of the ray of wavelength of 0.580 micrometers. The horizontal axis of FIG. 180 represents distortion. The unit is percent. The vertical axis of FIG. 180 represents image height.

### Example 50

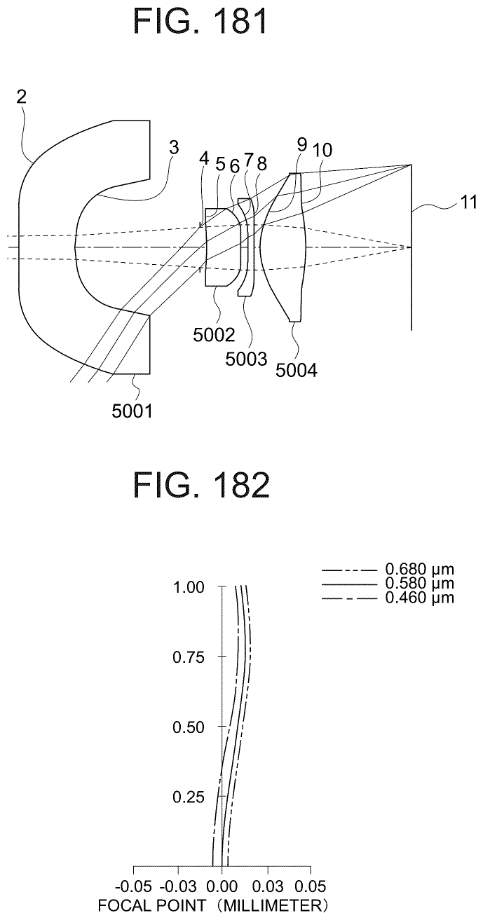

FIG. 181 shows a layout of an imaging optical system of Example 50. The imaging optical system includes four lenses arranged from the object side to the image side. Each of the first lens 5001 and the second lens 5002 is a biconcave lens. The third lens 5003 is an aspheric lens in which radius of curvature of each of both surfaces is infinity in the paraxial region and which has a power in the peripheral area. The fourth lens 5004 is a biconvex lens. The aperture stop 4 is located between the first lens 5001 and the second lens 5002.

Table 98 shows positions of the optical elements and properties and values of focal length of the lenses of the imaging optical system of Example 50. The focal length f of the whole imaging optical system is given by f=0.169704. The F-number Fno is given by Fno=2.8954. HFOV representing a half value of angle of view is given by HFOV=50 (degrees). In Table 98, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 98

| | | | Thickness | | | | |
|---|---|---|---|---|---|---|---|
| | | Radius of | or | | Refractive | Abbe's | Focal |
| Surface | | curvature | distance | Material | index | number | length |
| 0 | Object | Plano | 5.142 | | | | |
| 1 | | Plano | 0.100 | | | | |
| 2 | Lens 1 | −3.08915 | 0.148 | Plastic | 1.5311 | 55.634 | −0.525 |
| 3 | | 0.31240 | 0.331 | | | | |
| 4 | Ape. | | 0.017 | | | | |
| | Stop | | | | | | |
| 5 | Lens 2 | −2779.00197 | 0.091 | Plastic | 1.5094 | 56.477 | −1762.361 |
| 6 | | 1329.70503 | 0.017 | | | | |
| 7 | Lens 3 | Infinity | 0.017 | Plastic | 1.6349 | 23.945 | Infinity |
| 8 | | Infinity | 0.016 | | | | |
| 9 | Lens 4 | 0.16720 | 0.120 | Plastic | 1.5094 | 56.477 | 0.247 |
| 10 | | −0.38614 | 0.280 | | | | |
| 11 | Image | Plano | | | | | |

Table 99 shows conic constants and aspheric coefficients of each surface of each lens of Example 50.

TABLE 99

| Surface | K | A4 | A6 | A8 | A10 | A12 | A14 |
|---|---|---|---|---|---|---|---|
| 2 | −5.0000 | 2.71517E+01 | −1.19628E+02 | −2.30708E+02 | 5.61871E+03 | 9.84406E+04 | −6.67774E+05 |
| 3 | −5.0383 | 5.37555E+01 | 3.12135E+03 | −3.44746E+04 | −1.07983E+06 | 9.42279E+06 | 2.31437E+09 |
| 4 | 5.0021 | −2.08079E+02 | 2.42179E+04 | −5.90705E+06 | 2.48639E+08 | 7.78616E+10 | −1.31731E+13 |
| 5 | 5.0010 | −4.03297E+02 | −1.33167E+03 | 6.74313E+05 | 2.45236E+07 | −1.27181E+09 | −3.23741E+11 |
| 7 | 0.0000 | −1.69683E+02 | −5.27511E+03 | 4.29142E+05 | 9.25770E+06 | −1.13868E+08 | −1.17225E+09 |
| 8 | 0.0000 | 1.97198E+01 | −3.64164E+03 | −1.62365E+05 | 1.42433E+07 | −2.87042E+07 | −3.02455E+09 |
| 9 | −2.8601 | −2.27303E+00 | 4.58388E+02 | −7.58522E+03 | −1.17821E+04 | −5.47986E+05 | −2.54778E+07 |
| 10 | −0.2477 | 3.88894E+01 | 2.09817E+02 | −1.26410E+04 | 1.09149E+04 | −1.01826E+06 | −1.08576E+07 |

FIG. 182 shows spherical aberrations. The horizontal axis of FIG. 182 represents a position at which a ray that travels parallel to the optical axis and enters the imaging optical system intersects with the optical axis. The vertical axis of FIG. 182 represents distance of the above described ray from the optical axis. The value of distance is normalized by the radius of the aperture. In other words, the value 1 on the vertical axis represents the radius of the aperture. In FIG. 182, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

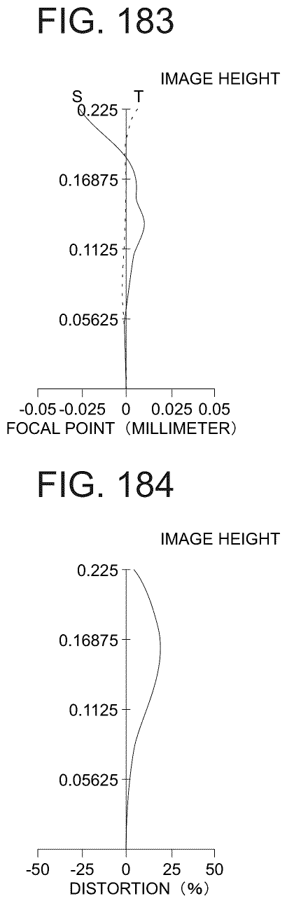

FIG. 183 shows astigmatism of the ray of wavelength of 0.580 micrometers. The horizontal axis of FIG. 183 represents a position in the optical axis direction of the focal point. The vertical axis of FIG. 183 represents image height. The solid line in FIG. 183 represents the graph of the sagittal plane, and the broken line in FIG. 183 represents the graph of the tangential plane.

FIG. 184 shows distortion of the ray of wavelength of 0.580 micrometers. The horizontal axis of FIG. 184 represents distortion. The unit is percent. The vertical axis of FIG. 184 represents image height.

### Example 51

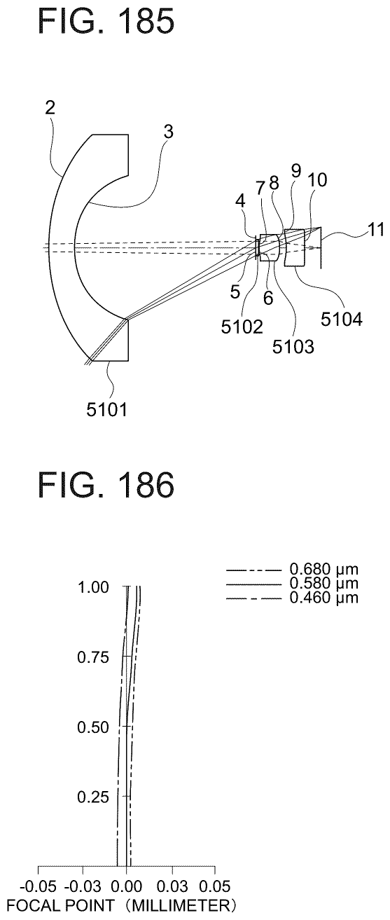

FIG. 185 shows a layout of an imaging optical system of Example 51. The imaging optical system includes four lenses arranged from the object side to the image side. Each of the first lens 5101 and the second lens 5102 is a negative meniscus lens which is convex toward the object. The third lens 5103 is a biconconvex lens. The fourth lens 5104 is an aspheric lens in which radius of curvature of each of both surfaces is infinity in the paraxial region and which has a power in the peripheral area. The aperture stop 4 is located between the first lens 5101 and the second lens 5102.

Table 100 shows positions of the optical elements and properties and values of focal length of the lenses of the imaging optical system of Example 51. The focal length f of the whole imaging optical system is given by f=0.260851. The F-number Fno is given by Fno=2.90276. HFOV representing a half value of angle of view is given by HFOV=50 (degrees). In Table 100, each of the four lenses is represented respectively by lens 1 to lens 4 from the object side.

In the present example, the object distance from the object to the first lens is 5.392(=5.142+0.250) millimeters. Surface 1 does not correspond to a physical object.

TABLE 100

| | | Radius of | Thickness | | Refractive | Abbe's | Focal |
|---|---|---|---|---|---|---|---|
| Surface | | curvature | or distance | Material | index | number | length |
| 0 | Object | Plano | 5.142 | | | | |
| 1 | | Plano | 0.250 | | | | |
| 2 | Lens 1 | 2.07315 | 0.268 | Plastic | 1.5311 | 55.634 | −3.145 |
| 3 | | 0.88436 | 1.905 | | | | |
| 4 | Ape. Stop | | 0.000 | | | | |
| 5 | Lens 2 | 9.46604 | 0.019 | Plastic | 1.5094 | 56.477 | −413.566 |
| 6 | | 9.05348 | 0.004 | | | | |
| 7 | Lens 3 | 0.41607 | 0.215 | Plastic | 1.5311 | 55.634 | 0.383 |
| 8 | | −0.32803 | 0.065 | | | | |
| 9 | Lens 4 | Infinity | 0.194 | Plastic | 1.6349 | 23.945 | Infinity |
| 10 | | Infinity | 0.173 | | | | |
| 11 | Image | Plano | | | | | |

Table 101 shows conic constants and aspheric coefficients of each surface of each lens of Example 51.

TABLE 101

| Surface | K | A4 | A6 | A8 | A10 | A12 | A14 |
|---|---|---|---|---|---|---|---|
| 2 | 0.7657 | −3.16151E−03 | 2.37389E−02 | −1.06524E−03 | 1.20101E−03 | −3.64019E−04 | −1.19672E−03 |
| 3 | 0.3382 | 1.57763E−01 | −7.08610E−02 | −3.59613E−01 | 1.10452E−01 | −1.32440E−01 | −6.64135E−02 |
| 4 | 5.0056 | 1.69265E+00 | 5.14075E+00 | −3.33941E+04 | 3.65689E+04 | −4.01706E+06 | −1.33477E+10 |
| 5 | −5.0089 | 1.68628E+00 | 7.58398E+02 | 1.16996E+05 | 1.08903E+06 | 1.64776E+08 | 2.33193E+10 |
| 7 | −4.5402 | −2.30389E+00 | −3.75692E+01 | 1.75293E+05 | −2.59808E+05 | 1.37470E+08 | 4.12661E+10 |
| 8 | 0.6721 | −3.64326E+00 | −1.97119E+02 | −3.23948E+03 | 4.88294E+04 | 3.81728E+06 | 1.69002E+08 |
| 9 | 0.0000 | −1.67262E+01 | −1.02347E+02 | −5.17898E+03 | −4.67008E+05 | 1.68680E+04 | −4.97470E+07 |
| 10 | 0.0000 | 5.67763E−01 | 3.16041E+00 | −4.23319E+03 | −4.58909E+04 | 6.17503E+04 | 6.31839E+06 |

FIG. 186 shows spherical aberrations. The horizontal axis of FIG. 186 represents a position at which a ray that travels parallel to the optical axis and enters the imaging optical system intersects with the optical axis. The vertical axis of FIG. 186 represents distance of the above-described ray from the optical axis. The value of distance is normalized by the radius of the aperture. In other words, the value 1 on the vertical axis represents the radius of the aperture. In FIG. 186, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

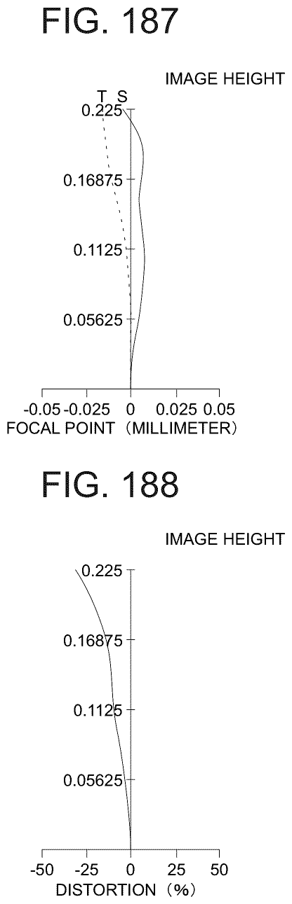

FIG. 187 shows astigmatism of the ray of wavelength of 0.580 micrometers. The horizontal axis of FIG. 187 represents a position in the optical axis direction of the focal point. The vertical axis of FIG. 187 represents image height. The solid line in FIG. 187 represents the graph of the sagittal plane, and the broken line in FIG. 187 represents the graph of the tangential plane.

FIG. 188 shows distortion of the ray of wavelength of 0.580 micrometers. The horizontal axis of FIG. 188 represents distortion. The unit is percent. The vertical axis of FIG. 188 represents image height.

### Example 52

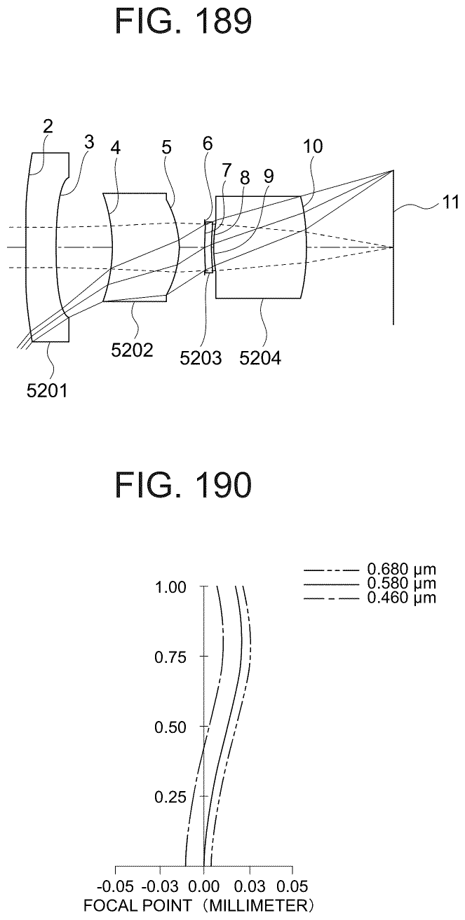

FIG. 189 shows a layout of an imaging optical system of Example 52. The imaging optical system includes four lenses arranged from the object side to the image side. The first lens 5201 is an aspheric lens in which radius of curvature of each of both surfaces is infinity in the paraxial region and which has a power in the peripheral area. The second lens 5202 is a positive meniscus lens which is convex toward the image. The third lens 5203 is a negative meniscus lens which is convex toward the object. The fourth lens 5204 is a biconvex lens. The aperture stop 6 is located between the second lens 5202 and the third lens 5203.

Table 102 shows positions of the optical elements and properties and values of focal length of the lenses of the imaging optical system of Example 52. The focal length f of the whole imaging optical system is given by f=0.269372. The F-number Fno is given by Fno=3.05596. HFOV representing a half value of angle of view is given by HFOV=50 (degrees). In Table 102, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 102

| | | Radius | Thickness | | Refractive | Abbe's | Focal |
|---|---|---|---|---|---|---|---|
| Surface | | of curvature | or distance | Material | index | number | length |
| 0 | Object | Plano | 5.142 | | | | |
| 1 | | Plano | 0.100 | | | | |
| 2 | Lens 1 | Infinity | 0.081 | Plastic | 1.5311 | 55.634 | Infinity |
| 3 | | Infinity | 0.152 | | | | |
| 4 | Lens 2 | −0.47083 | 0.181 | Plastic | 1.5094 | 56.477 | 0.906 |
| 5 | | −0.26358 | 0.071 | | | | |
| 6 | Ape. | | 0.000 | | | | |
| | Stop | | | | | | |
| 7 | Lens 3 | 0.68707 | 0.019 | Plastic | 1.5094 | 56.477 | −2.594 |
| 8 | | 0.45440 | 0.005 | | | | |
| 9 | Lens 4 | 0.35356 | 0.251 | Plastic | 1.6349 | 23.945 | 0.418 |
| 8 6 10 | | −0.77762 | 0.240 | | | | |
| 11 | Image | Plano | | | | | |

Table 103 shows conic constants and aspheric coefficients of each surface of each lens of Example 52.

TABLE 103

| Surface | K | A4 | A6 | A8 | A10 | A12 | A14 |
|---|---|---|---|---|---|---|---|
| 2 | 0.0000 | 3.76486E+00 | 1.48999E+01 | 9.27932E+01 | 3.15739E+01 | −3.09506E+04 | −6.37748E+05 |
| 3 | 0.0000 | 1.98553E+01 | −1.04199E+02 | 2.21218E+03 | 7.07435E+04 | 1.49804E+06 | 3.08134E+07 |
| 4 | −0.4119 | 1.98258E+00 | −5.54843E+01 | −9.73782E+03 | −5.27576E+03 | −1.14046E+05 | −4.00031E+06 |
| 5 | 0.0445 | −2.40498E−02 | 3.92580E+01 | −2.55840E+03 | −1.40233E+04 | −6.36194E+05 | −4.53145E+07 |
| 7 | 4.9881 | −4.67789E+01 | 2.90154E+02 | 5.53956E+04 | 5.50355E+07 | −1.39739E+09 | −3.38672E+12 |
| 8 | −5.0005 | −1.56168E+01 | −1.03229E+04 | −1.11416E+06 | −1.75211E+07 | 2.56851E+09 | −8.09387E+11 |
| 9 | −5.0010 | −2.52552E+01 | −9.61189E+02 | −7.59324E+05 | −1.28484E+08 | −8.58888E+09 | 3.68022E+12 |
| 10 | 4.3134 | −1.63171E−01 | −4.82213E+02 | 3.45652E+03 | 5.19939E+05 | 6.07228E+06 | −1.05828E+09 |

FIG. 190 shows spherical aberrations. The horizontal axis of FIG. 190 represents a position at which a ray that travels parallel to the optical axis and enters the imaging optical system intersects with the optical axis. The vertical axis of FIG. 190 represents distance of the above described ray from the optical axis. The value of distance is normalized by the radius of the aperture. In other words, the value 1 on the vertical axis represents the radius of the aperture. In FIG. 190, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

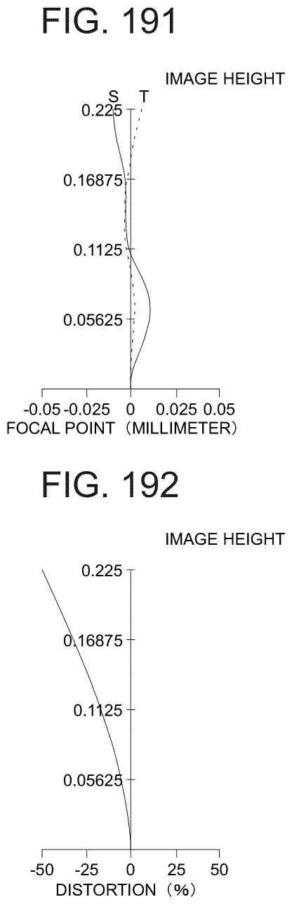

FIG. 191 shows astigmatism of the ray of wavelength of 0.580 micrometers. The horizontal axis of FIG. 191 represents a position in the optical axis direction of the focal point. The vertical axis of FIG. 191 represents image height. The solid line in FIG. 191 represents the graph of the sagittal plane, and the broken line in FIG. 191 represents the graph of the tangential plane.

FIG. 192 shows distortion of the ray of wavelength of 0.580 micrometers. The horizontal axis of FIG. 192 represents distortion. The unit is percent. The vertical axis of FIG. 192 represents image height.

### Example 53

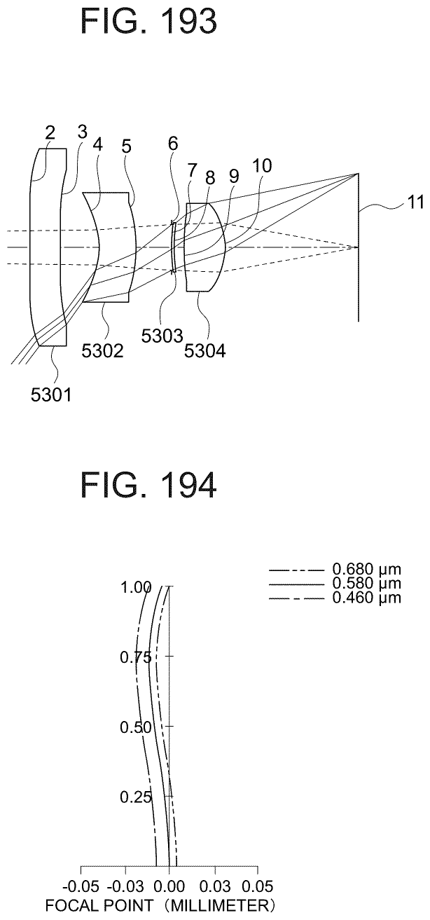

FIG. 193 shows a layout of an imaging optical system of Example 53. The imaging optical system includes four lenses arranged from the object side to the image side. The first lens 5301 is an aspheric lens in which radius of curvature of each of both surfaces is infinity in the paraxial region and which has a power in the peripheral area. The second lens 5302 is a negative meniscus lens which is convex toward the image. The third lens 5303 is a negative meniscus lens which is convex toward the object. The fourth lens 5304 is a biconvex lens. The aperture stop 6 is located between the second lens 5302 and the third lens 5303.

Table 104 shows positions of the optical elements and properties and values of focal length of the lenses of the imaging optical system of Example 53. The focal length f of the whole imaging optical system is given by f=0.31125. The F-number Fno is given by Fno=2.86326. HFOV representing a half value of angle of view is given by HFOV=50 (degrees). In Table 104, each of the four lenses is represented respectively by lens 1 to lens 4 from the object side.

In the present example, the object distance from the object to the first lens is 5.242(=5.142+0.100) millimeters. Surface 1 does not correspond to a physical object.

TABLE 104

| | | Radius | Thickness | | Refractive | Abbe's | Focal |
|---|---|---|---|---|---|---|---|
| Surface | | of curvature | or distance | Material | index | number | length |
| 0 | Object | Plano | 5.142 | | | | |
| 1 | | Plano | 0.100 | | | | |
| 2 | Lens 1 | Infinity | 0.092 | Plastic | 1.6349 | 23.945 | Infinity |
| 3 | | Infinity | 0.116 | | | | |
| 4 | Lens 2 | −0.26082 | 0.109 | Plastic | 1.5311 | 55.634 | −1.298 |
| 5 | | −0.48011 | 0.107 | | | | |
| 6 | Ape. Stop | | 0.000 | | | | |
| 7 | Lens 3 | 0.64792 | 0.008 | Plastic | 1.5094 | 56.477 | −37.088 |
| 8 | | 0.62397 | 0.030 | | | | |
| 9 | Lens 4 | 0.93657 | 0.121 | Plastic | 1.5311 | 55.634 | 0.325 |
| 8 6 10 | | −0.20242 | 0.399 | | | | |
| 11 | Image | Plano | | | | | |

Table 105 shows conic constants and aspheric coefficients of each surface of each lens of Example 53.

TABLE 105

| Surface | K | A4 | A6 | A8 | A10 | A12 | A14 |
|---|---|---|---|---|---|---|---|
| 2 | 0.0000 | 3.84241E+00 | 9.37913E−02 | 9.07651E+00 | −3.03681E+02 | −8.35796E+02 | 1.18158E+04 |
| 3 | 0.0000 | 7.54509E+00 | −1.26398E+01 | −4.08922E+01 | −5.54014E+02 | −1.40216E+04 | −6.35220E+05 |
| 4 | −0.2016 | 2.40334E+00 | 1.57771E+02 | −1.52548E+02 | −3.16534E+02 | 3.58359E+05 | 3.13751E+07 |
| 5 | 1.1242 | −1.74664E+00 | −1.28485E+01 | 2.82840E+03 | 1.13498E+05 | 1.45689E+06 | 7.41161E+06 |
| 7 | −3.0306 | −1.88165E+00 | −2.68142E+03 | −5.74868E+04 | −2.01215E+06 | 3.15169E+07 | 3.28806E+09 |
| 8 | 5.0041 | 9.26295E+00 | 1.91666E+03 | 1.61764E+04 | −3.22582E+06 | −7.61304E+08 | −1.10465E+11 |
| 9 | 0.7856 | 1.41717E−01 | 2.25394E+01 | 2.24121E+03 | 2.59289E+05 | 2.04616E+07 | 1.61536E+09 |
| 10 | 0.0665 | −6.55758E−01 | −1.12232E+02 | −2.49271E+03 | −7.31805E+04 | −8.52609E+05 | 4.79687E+07 |

FIG. 194 shows spherical aberrations. The horizontal axis of FIG. 194 represents a position at which a ray that travels parallel to the optical axis and enters the imaging optical system intersects with the optical axis. The vertical axis of FIG. 194 represents distance of the above-described ray from the optical axis. The value of distance is normalized by the radius of the aperture. In other words, the value 1 on the vertical axis represents the radius of the aperture. In FIG. 194, the solid line represents the graph of the ray of wavelength of 0.580 micrometers, the chain line represents the graph of the ray of wavelength of 0.460 micrometers and the two-dot chain line represents the graph of the ray of wavelength of 0.680 micrometers.

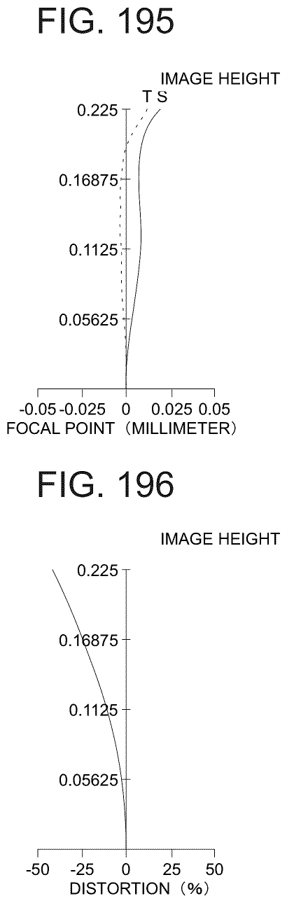

FIG. 195 shows astigmatism of the ray of wavelength of 0.580 micrometers. The horizontal axis of FIG. 195 represents a position in the optical axis direction of the focal point. The vertical axis of FIG. 195 represents image height. The solid line in FIG. 195 represents the graph of the sagittal plane, and the broken line in FIG. 195 represents the graph of the tangential plane.

FIG. 196 shows distortion of the ray of wavelength of 0.580 micrometers. The horizontal axis of FIG. 196 represents distortion. The unit is percent. The vertical axis of FIG. 196 represents image height.

### Features of Examples 31-53

Tables 106A-106F show features of Examples 31-53. In the tables, “n”, “NAT”, “f” and “HFOV” respectively represent the number of the lenses, the number of an aspheric lens or aspheric lenses in which radius of curvature of each of both surfaces is infinity in the paraxial region and which has a power in the peripheral area, a focal length of the whole optical system and an angle of view (a value of half angle). In the column of “Location of aperture stop” in the tables, “L2-L3”, for example, indicates that the aperture stop is located between the second lens and the third lens. In the column of “NAT” in the tables, “1 (L1)”, for example, indicates that a single aspheric lens in which radius of curvature of each of both surfaces is infinity in the paraxial region and which has a power in the peripheral area is provided as the first lens. “fi” represents a focal length of the i-th lens from the object side (the i^{th} lens) where “i” represents an integer from one to “n”. “Distortion 90% of image height” represents distortion at the height of 90% of the maximum image height. “Term” represents a value of

$$( {\sum }_{i = 1}^{i = n} \vert \frac{1}{{f}_{i}} \vert ) \cdot \frac{f}{n} .$$

TABLE 106A

| | | Location of | | | Image | HFOV | Distortion 90% |
|---|---|---|---|---|---|---|---|
| Example | n | aperture stop | NAT | n-NAT | height | (degree) | of image height (%) |
| 31 | 3 | L2-L3 | 1, (L1) | 2 | 0.225 | 50 | −27.41 |
| 32 | 3 | L2-L3 | 1, (L1) | 2 | 0.225 | 50 | −46.19 |
| 33 | 3 | L1-L2 | 1, (L3) | 2 | 1.04 | 65 | −37.5 |
| 34 | 4 | L1-L2 | 1, (L3) | 3 | 0.225 | 50 | −23.81 |
| 35 | 4 | L1-L2 | 1, (L3) | 3 | 0.225 | 50 | −30.32 |
| 36 | 4 | L1-L2 | 1, (L4) | 3 | 0.225 | 50 | −30.64 |
| 37 | 4 | L1-L2 | 1, (L4) | 3 | 0.225 | 50 | −31.40 |
| 38 | 4 | L2-L3 | 1, (L1) | 3 | 0.225 | 50 | −25.85 |
| 39 | 4 | L2-L3 | 1, (L1) | 3 | 0.225 | 50 | −32.84 |
| 40 | 4 | L2-L3 | 1, (L1) | 3 | 0.225 | 50 | −28.19 |

TABLE 106B

| Ex- | | | | | | |
|---|---|---|---|---|---|---|
| ample | f | Term | f1 | f2 | f3 | f4 |
| 31 | 0.2812 | 0.4283 | ∞ | 0.643 | 0.332 | |
| 32 | 0.3750 | 0.3579 | ∞ | −5.314 | 0.374 | |
| 33 | 0.87 | 0.652 | −1.58 | 0.755 | ∞ | |
| 34 | 0.2595 | 0.2971 | −0.853 | 0.327 | ∞ | 2.856 |
| 35 | 0.2828 | 0.4388 | −0.544 | 0.271 | ∞ | −1.469 |
| 36 | 0.2877 | 0.2766 | −2.018 | 0.576 | 0.619 | ∞ |
| 37 | 0.2845 | 0.4047 | −0.877 | 0.251 | −1.770 | ∞ |
| 38 | 0.2729 | 0.2736 | ∞ | 1.238 | 0.410 | 1.313 |
| 39 | 0.2694 | 0.4918 | ∞ | 1.020 | 0.275 | −0.372 |
| 40 | 0.2770 | 0.2843 | ∞ | −1.719 | 0.403 | 0.961 |

TABLE 106C

| Ex- | | Location of | | n- | Image | HFOV | Distortion 90% of |
|---|---|---|---|---|---|---|---|
| ample | n | aperture stop | NAT | NAT | height | (degree) | image height (%) |
| 41 | 4 | L2-L3 | 1, (L1) | 3 | 0.225 | 50 | −37.79 |
| 42 | 4 | L2-L3 | 1, (L4) | 3 | 0.225 | 50 | −17.39 |
| 43 | 4 | L2-L3 | 1, (L4) | 3 | 0.225 | 50 | 6.50 |
| 44 | 4 | L3-L4 | 1, (L2) | 3 | 0.225 | 50 | −17.31 |
| 45 | 4 | L3-L4 | 1, (L2) | 3 | 0.225 | 50 | −40.22 |
| 46 | 4 | L3-L4 | 1, (L1) | 3 | 0.225 | 50 | −41.39 |
| 47 | 4 | L3-L4 | 1, (L1) | 3 | 0.225 | 50 | −41.61 |
| 48 | 4 | L3-L4 | 1, (L1) | 3 | 0.225 | 50 | −37.17 |
| 49 | 4 | L3-L4 | 1, (L1) | 3 | 0.225 | 50 | −34.47 |
| 50 | | L1-L2 | 1, (L3) | 3 | 0.225 | 50 | 12.56 |

TABLE 106D

| Ex- | | | | | | |
|---|---|---|---|---|---|---|
| ample | f | Term | f1 | f2 | f3 | f4 |
| 41 | 0.3052 | 0.5127 | ∞ | −0.470 | 0.246 | −1.891 |
| 42 | 0.2442 | 0.5301 | −0.295 | 0.363 | 0.394 | ∞ |
| 43 | 0.1811 | 0.2596 | −0.477 | −5.494 | 0.290 | ∞ |
| 44 | 0.2169 | 0.3210 | −0.437 | ∞ | 0.398 | 0.896 |
| 45 | 0.3107 | 0.2932 | −2.186 | ∞ | 121.800 | 0.302 |
| 46 | 0.3167 | 0.2750 | ∞ | 4.989 | 1.200 | 0.410 |
| 47 | 0.3237 | 0.2839 | ∞ | 1.276 | −35.685 | 0.371 |
| 48 | 0.3069 | 0.3083 | ∞ | −2.712 | 0.844 | 0.406 |
| 49 | 0.2936 | 0.2525 | ∞ | −6.301 | −7.855 | 0.317 |
| 50 | 0.1697 | 0.2528 | −0.525 | −1762.361 | ∞ | 0.247 |

TABLE 106E

| Ex- | | Location of | | n- | Image | HFOV | Distortion 90% of |
|---|---|---|---|---|---|---|---|
| ample | n | aperture stop | NAT | NAT | height | (degree) | image height (%) |
| 51 | 4 | L1-L2 | 1, (L4) | 3 | 0.225 | 50 | −22.37 |
| 52 | 4 | L2-L3 | 1, (L1) | 3 | 0.225 | 50 | −43.40 |
| 53 | 4 | L2-L3 | 1, (L1) | 3 | 0.225 | 50 | −34.42 |

TABLE 106F

| Ex- | | | | | | |
|---|---|---|---|---|---|---|
| ample | f | Term | f1 | f2 | f3 | f4 |
| 51 | 0.2609 | 0.1910 | −3.145 | −413.566 | 0.383 | ∞ |
| 52 | 0.2694 | 0.2614 | ∞ | 0.906 | −2.594 | 0.418 |
| 53 | 0.3113 | 0.3016 | ∞ | −1.298 | −37.088 | 0.325 |

Table 107 shows a normalized value (φ·f) of power φ in the peripheral area of the aspheric lens in which radius of curvature of each of both surfaces is infinity in the paraxial region and which has a power in the peripheral area of each of Examples 31 to 53. The normalized value (φ·f) is obtained by dividing the power φ by the reciprocal of the focal length of the whole system (1/f). In the row of Example 31 in Table 107, for example, “L1” represents the first lens that is an aspheric lens in which radius of curvature of each of both surfaces is infinity in the paraxial region and which has a power of the third-order aberration region in the peripheral area.

TABLE 107

| Example | | |
|---|---|---|
| 31 | −0.573 | L1 |
| 32 | −0.481 | L1 |
| 33 | −1.079 | L3 |
| 34 | 0.469 | L3 |
| 35 | −1.091 | L3 |
| 36 | −3.550 | L4 |
| 37 | −3.259 | L4 |
| 38 | −2.141 | L1 |
| 39 | −1.918 | L1 |
| 40 | −0.422 | L1 |
| 41 | −1.764 | L1 |
| 42 | −0.008 | L4 |
| 43 | −1.858 | L4 |
| 44 | −2.529 | L2 |
| 45 | −2.152 | L2 |
| 46 | −2.331 | L1 |
| 47 | −1.713 | L1 |
| 48 | −0.362 | L1 |
| 49 | −0.143 | L1 |
| 50 | −5.292 | L3 |
| 51 | −2.251 | L4 |
| 52 | −0.549 | L1 |
| 53 | −0.181 | L1 |

According to Tables 106A to 106F, Examples 31 to 53 have the following features.

The number of the lenses is three or four. The aperture stop is located closer to the image than the lens closest to the object and closer to the object than the lens closest to the image. The optical system is provided with a single aspheric lens in which radius of curvature of each of both surfaces is infinity in the paraxial region and which has a power of the third order aberration region in the peripheral area and the aspheric lens is located at a position not adjacent to the aperture stop. The lens closest to the object is a negative lens or the aspheric lens in which radius of curvature of each of both surfaces is infinity in the paraxial region and which has a power of the third-order aberration region in the peripheral area and at least one lens that is closer to the image than the aperture stop is a positive lens. When a focal length of each lens is represented by fi, a focal length of the whole optical system is represented by f and the number of the lenses is represented by n, the following inequality is satisfied.

$$0.18 < ( {\sum }_{i = 1}^{i = n} \vert \frac{1}{{f}_{i}} \vert ) \cdot \frac{f}{n} < 0.9$$

An angle the principal ray of a beam (a bundle of rays) that enters the optical system and reaches the maximum image height forms with the optical axis is represented by HFOV, the following inequality is satisfied.

$$40 ° < HFOV < 80 °$$

According to the drawings, each of which shows a layout and paths of rays of each of the optical systems of Examples 31 to 53, a beam that enters the optical system and reaches the maximum image height and a beam which enters the optical system and the principal ray of which is parallel to the optical axis do not intersect with each other in the first lens.

In Examples 31 to 49, the lens that is adjacent to the aperture stop and located closer to the image than the aperture stop is a positive lens.

There is a need for a compact wide-angle imaging optical system with sufficiently small aberrations, the optical system including an aspheric lens in which radius of curvature of each of both surfaces is infinity in the paraxial region.

In an imaging optical system of some examples, the number of lenses is four, an aperture stop is located closer to the image than the lens closest to the object and closer to the object than the lens closest to the image, a single aspheric lens in which radius of curvature of each of both surfaces is infinity in the paraxial region and which has a power of the third-order aberration region in the peripheral area is provided at a position that is not adjacent to the aperture stop, the lens closest to the object is a negative lens or the aspheric lens in which radius of curvature of each of both surfaces is infinity in the paraxial region and which has a power of the third-order aberration region in the peripheral area, at least one positive lens is located closer to the image than the aperture stop, the relationship

$$0.18 < ( {\sum }_{i = 1}^{i = n} \vert \frac{1}{{f}_{i}} \vert ) \cdot \frac{f}{n} < 0.9$$

is satisfied where i represents a natural number, fi represents focal length of the i-th lens from the object side, f represents focal length of the whole system and n represents the number of the lenses, a bundle of rays that enters the imaging optical system and reaches the maximum image height and a bundle of rays that enters the imaging optical system and has the principal ray parallel to the optical axis do not intersect with each other within the lens closest to the object, and the relationship

$$40 ° < HFOV < 80 °$$

is satisfied where HFOV represents angle that the principal ray of bundle of rays that enters the imaging optical system and reaches the maximum image height forms with the optical axis.

In an imaging optical system of some examples, the lens that is adjacent to the aperture stop and located closer to the image than the aperture stop is a positive lens.

In an imaging optical system of some examples, the number of lenses is three, each of the tree lenses is referred to as a first lens, a second lens and a third lens from the object side, the aperture stop is located between the second lens and the third lens, a single aspheric lens in which radius of curvature of each of both surfaces is infinity in the paraxial region and which has a power of the third-order aberration region in the peripheral area is provided at a position that is not adjacent to the aperture stop, the first lens is the aspheric lens in which radius of curvature of each of both surfaces is infinity in the paraxial region and which has a power of the third-order aberration region in the peripheral area, the third lens is a positive lens, the relationship

$$0.18 < ( {\sum }_{i = 1}^{i = n} \vert \frac{1}{{f}_{i}} \vert ) \cdot \frac{f}{n} < 0.9$$

is satisfied where i represents a natural number, fi represents focal length of the i-th lens from the object side, f represents focal length of the whole system and n represents the number of the lenses, a bundle of rays that enters the imaging optical system and reaches the maximum image height and a bundle of rays that enters the imaging optical system and has the principal ray parallel to the optical axis do not intersect with each other within the first lens, and the relationship

$$40 ° < HFOV < 80 °$$

is satisfied where HFOV represents angle that the principal ray of bundle of rays that enters the imaging optical system and reaches the maximum image height forms with the optical axis.

In an imaging optical system of some examples, the number of lenses is three to seven, an aperture stop is located within the imaging optical system, one to four lenses each of which is an aspheric lens in which radius of curvature of each of both surfaces is infinity in the paraxial region and which has a power of the third-order aberration region in the peripheral area are provided, the first lens from the object side is a negative lens or an aspheric lens in which radius of curvature of each of both surfaces is infinity in the paraxial region and which has a negative power of the third-order aberration region in the peripheral area, the lens adjacent to the aperture stop on the image side is a positive lens, the relationship

$$0.18 < ( {\sum }_{i = 1}^{i = n} \vert \frac{1}{{f}_{i}} \vert ) \cdot \frac{f}{n} < 0.9$$

is satisfied where i represents a natural number, fi represents focal length of the i-th lens from the object side, f represents focal length of the whole system and n represents the number of the lenses, a bundle of rays that enters the imaging optical system and reaches the maximum value of image height and a bundle of rays that enters the imaging optical system and has the principal ray parallel to the optical axis do not intersect with each other within the first lens from the object side, and the relationship

$$40 ° < HFOV < 80 °$$

is satisfied where HFOV represents angle that the principal ray of bundle of rays that enters the imaging optical system and reaches the maximum value of image height forms with the optical axis.

Thus, a compact wide-angle imaging optical system with sufficiently small aberrations, the optical system including an aspheric lens in which radius of curvature of each of both surfaces is infinity in the paraxial region can be realized.

In an imaging optical system of some examples, the number of lenses is four to seven, the aperture stop is located between the second lens and the fourth lens from the object side, at least one aspheric lens in which radius of curvature of each of both surfaces is infinity in the paraxial region and which has a power of the third-order aberration region in the peripheral area is provided respectively on the object side and on the image side of the aperture stop, each of the first lens and/or the second lens from the object side and the lens closest to the image is an aspheric lens in which radius of curvature of each of both surfaces is infinity in the paraxial region and which has a power of the third-order aberration region in the peripheral area, the relationship

$$0.18 < ( {\sum }_{i = 1}^{i = n} \vert \frac{1}{{f}_{i}} \vert ) \cdot \frac{f}{n} < 0.82$$

is satisfied, and the bundle of rays that enters the imaging optical system and reaches the maximum value of image height and the bundle of rays that enters the imaging optical system and has the principal ray parallel to the optical axis do not intersect with each other within the lens closest to the image.

The imaging optical system is configured such that the bundle of rays that enters the imaging optical system and reaches the maximum value of image height and the bundle of rays that enters the imaging optical system and has the principal ray parallel to the optical axis do not intersect with each other within the first lens from the object side and within the lens closest to the image. When an aspheric lens in which radius of curvature of each of both surfaces is infinity in the paraxial region and which has a power of the third-order aberration region in the peripheral area is used as each of the first lens and/or the second lens from the object side and the lens closest to the image in the layout described above, a compact wide-angle imaging optical system with sufficiently small aberrations can be realized. Further, in particular, off-axis aberrations can be effectively reduced by locating at least one aspheric lens in which radius of curvature of each of both surfaces is infinity in the paraxial region and which has a power of the third order aberration region in the peripheral area respectively on the object side and on the image side of the aperture stop.

In an imaging optical system of some examples, the number of lenses is four, the aperture stop is located between the second lens and the third lens from the object side, and each of the first lens and the fourth lens from the object side is an aspheric lens in which radius of curvature of each of both surfaces is infinity in the paraxial region and which has a power of the third-order aberration region in the peripheral area.

In the imaging optical system, the number of lenses is four, and the number of lenses each of which is an aspheric lens in which radius of curvature of each of both surfaces is infinity in the paraxial region and which has a power of the third-order aberration region in the peripheral area is two.

In an imaging optical system of some examples, the number of lenses is five, the aperture stop is located between the second lens and the fourth lens from the object side, each of the first lens or the second lens from the object side and the fifth lens from the object side is an aspheric lens in which radius of curvature of each of both surfaces is infinity in the paraxial region and which has a power of the third-order aberration region in the peripheral area, and the relationship

$$0.18 < ( {\sum }_{i = 1}^{i = n} \vert \frac{1}{{f}_{i}} \vert ) \cdot \frac{f}{n} < 0.65$$

is satisfied.

In the imaging optical system, the number of lenses is five, and the number of lenses each of which is an aspheric lens in which radius of curvature of each of both surfaces is infinity in the paraxial region and which has a power of the third-order aberration region in the peripheral area is two.

In an imaging optical system of some examples, the number of lenses is five, the aperture stop is located between the second lens and the third lens from the object side, each of the first lens, the second lens and the fifth lens from the object side or each of the second lens, the fourth lens and the fifth from the object is an aspheric lens in which radius of curvature of each of both surfaces is infinity in the paraxial region and which has a power of the third-order aberration region in the peripheral area, and the relationship

$$0.25 < ( {\sum }_{i = 1}^{i = n} \vert \frac{1}{{f}_{i}} \vert ) \cdot \frac{f}{n} < 0.82$$

is satisfied.

In the imaging optical system, the number of lenses is five, and the number of lenses each of which is an aspheric lens in which radius of curvature of each of both surfaces is infinity in the paraxial region and which has a power of the third-order aberration region in the peripheral area is three.

In an imaging optical system of some examples, the number of lenses is six, the aperture stop is located between the second lens and the fourth lens from the object side, each of the first lens or the second lens from the object side and the sixth lens from the object side is an aspheric lens in which radius of curvature of each of both surfaces is infinity in the paraxial region and which has a power of the third-order aberration region in the peripheral area, and the relationship

$$0.18 < ( {\sum }_{i = 1}^{i = n} \vert \frac{1}{{f}_{i}} \vert ) \cdot \frac{f}{n} < 0.6$$

is satisfied.

In the imaging optical system, the number of lenses is six, and the number of lenses each of which is an aspheric lens in which radius of curvature of each of both surfaces is infinity in the paraxial region and which has a power of the third-order aberration region in the peripheral area is two.

In an imaging optical system of some examples, the number of lenses is six, the aperture stop is located between the second lens and the third lens from the object side, and each of the second lens, the fourth lens, the fifth lens and the sixth lens from the object side is an aspheric lens in which radius of curvature of each of both surfaces is infinity in the paraxial region and which has a power of the third-order aberration region in the peripheral area.

In the imaging optical system, the number of lenses is six, and the number of lenses each of which is an aspheric lens in which radius of curvature of each of both surfaces is infinity in the paraxial region and which has a power of the third-order aberration region in the peripheral area is four.

In an imaging optical system of some examples, the number of lenses is seven, the aperture stop is located between the second lens and the third lens from the object side, and each of the second lens, the fifth lens and the seventh lens from the object side is an aspheric lens in which radius of curvature of each of both surfaces is infinity in the paraxial region and which has a power of the third order aberration region in the peripheral area.

In the imaging optical system, the number of lenses is seven, and the number of lenses each of which is an aspheric lens in which radius of curvature of each of both surfaces is infinity in the paraxial region and which has a power of the third-order aberration region in the peripheral is three.

In an imaging optical system of some examples, the number of lenses is three to five, and any one of the lenses is an aspheric lens in which radius of curvature of each of both surfaces is infinity in the paraxial region and which has a power of the third-order aberration region in the peripheral area.

In the imaging optical system, the number of lenses is three to five, and one aspheric lens in which radius of curvature of each of both surfaces is infinity in the paraxial region and which has a power of the third order aberration region in the peripheral area is provided.

In an imaging optical system of some examples, the first lens from the object side is an aspheric lens in which radius of curvature of each of both surfaces is infinity in the paraxial region and which has a power of the third-order aberration region in the peripheral area.

Thus, a compact wide-angle imaging optical system with sufficiently small aberrations can be realized by locating an aspheric lens in which radius of curvature of each of both surfaces is infinity in the paraxial region and which has a power of the third-order aberration region in the peripheral area in a position where the off-axis bundle of rays and the axial bundle of rays do not intersect with each other instead of a lens that has a great power in the paraxial region.

In an imaging optical system of some examples, the lens closest to the image is an aspheric lens in which radius of curvature of each of both surfaces is infinity in the paraxial region and which has a power of the third-order aberration region in the peripheral area, and the bundle of rays that enters the imaging optical system and reaches the maximum value of image height and the bundle of rays that enters the imaging optical system and has the principal ray parallel to the optical axis do not intersect with each other within the lens closest to the image.

Thus, a compact wide-angle imaging optical system with sufficiently small aberrations can be realized by locating an aspheric lens in which radius of curvature of each of both surfaces is infinity in the paraxial region and which has a power of the third-order aberration region in the peripheral area in a position where the off-axis bundle of rays and the axial bundle of rays do not intersect with each other instead of a lens that has a great power in the paraxial region.

In an imaging optical system of some examples, the number of lenses is three, and any one of the lenses is an aspheric lens in which radius of curvature of each of both surfaces is infinity in the paraxial region and which has a negative power of the third-order aberration region in the peripheral area.

In an imaging optical system of some examples, the number of lenses is five, each of the first lens, the second lens and the fifth lens from the object side is an aspheric lens in which radius of curvature of each of both surfaces is infinity in the paraxial region and which has a power of the third order aberration region in the peripheral area, and the second lens is an aspheric lens in which radius of curvature of each of both surfaces is infinity in the paraxial region and which has a positive power of the third-order aberration region in the peripheral area.

What is claimed is:

1. An imaging optical system wherein a number of lenses is four, an aperture stop is located closer to an image than a lens closest to an object and closer to the object than the lens closest to the image, a single aspheric lens in which radius of curvature of each of both surfaces is infinity in a paraxial region and which has a power of the third-order aberration region in a peripheral area is provided at a position that is not adjacent to the aperture stop, the lens closest to the object is a negative lens or the aspheric lens in which radius of curvature of each of both surfaces is infinity in the paraxial region and which has a power of the third-order aberration region in the peripheral area, at least one positive lens is located closer to the image than the aperture stop, the relationship
$$0.18 < ( {\sum }_{i = 1}^{i = n} \vert \frac{1}{{f}_{i}} \vert ) \cdot \frac{f}{n} < 0.9$$
is satisfied where i represents a natural number, fi represents focal length of the i-th lens from the object side, f represents focal length of the whole system and n represents the number of the lenses, a bundle of rays that enters the imaging optical system and reaches the maximum image height and a bundle of rays that enters the imaging optical system and has the principal ray parallel to the optical axis do not intersect with each other within the lens closest to the object, and the relationship
$$40 ° < HFOV < 80 °$$
is satisfied where HFOV represents angle that the principal ray of bundle of rays that enters the imaging optical system and reaches the maximum image height forms with the optical axis.

2. The imaging optical system according to claim 1 wherein the lens that is adjacent to the aperture stop and located closer to the image than the aperture stop is a positive lens.

3. An imaging optical system wherein a number of lenses is three, each of the three lenses is referred to as a first lens, a second lens and a third lens from an object side, an aperture stop is located between the second lens and the third lens, a single aspheric lens in which radius of curvature of each of both surfaces is infinity in a paraxial region and which has a power of a third-order aberration region in a peripheral area is provided at a position that is not adjacent to the aperture stop, the first lens is the aspheric lens in which radius of curvature of each of both surfaces is infinity in the paraxial region and which has a power of the third-order aberration region in the peripheral area, the third lens is a positive lens, the relationship
$$0.18 < ( {\sum }_{i = 1}^{i = n} \vert \frac{1}{{f}_{i}} \vert ) \cdot \frac{f}{n} < 0.9$$
is satisfied where i represents a natural number, fi represents focal length of the i-th lens from the object side, f represents focal length of a whole system and n represents the number of the lenses, a bundle of rays that enters the imaging optical system and reaches a maximum image height and a bundle of rays that enters the imaging optical system and has a principal ray parallel to the optical axis do not intersect with each other within the first lens, and the relationship
$$40 ° < HFOV < 80 °$$
is satisfied where HFOV represents angle that the principal ray of bundle of rays that enters the imaging optical system and reaches the maximum image height forms with the optical axis.
